(19) United States
(12) Patent Application Publication
(10) Pub. No.: US 2005/0210267 A1
(43) Pub. Date: Sep. 22, 2005

(54) User authentication method and system, information terminal device and service providing server, subject identification method and system, correspondence confirmation method and system, object confirmation method and system, and program products for them

(76) Inventors: Jun Sugano, Tokyo (JP); Tsutomu Fujita, Chiba (JP); Masatomo Kanegae, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 10/803,862

(22) Filed: Mar. 18, 2004

(51) Int. Cl. H04K 1/00

(52) U.S. Cl. 713/186

(57) ABSTRACT

An object of the present invention is to provide a user authentication method and system, an information terminal device and a service providing server, a subject identification method and system, a correspondence confirmation method and system, an object confirmation method and system, which are capable of assuring authentication and/or confirmation of a person, an animal and a plant, or an object and improving precision thereof, and program products for them. In order to perform user authentication when a user of an information terminal device 30 such as a cellular phone or the like receives a service from a service providing server 20 via a network, iris authentication is performed, and a password is automatically updated every time a service is provided to generate a new password to be used when a next service is provided, and the new password is stored in both the information terminal device 30 and the service providing server 20.

### BACKGROUND OF THE INVENTION

1. Field of the Invention

The present invention relates to a user authentication method and system, an information terminal device, and a service providing server for authenticating an identity of a user of an information terminal device when the user receives a service from the service providing server via a network, a subject identification method and system for identifying a subject using an imaging means constituted by including a standard lens and a close-up lens having a focal length shorter than a focal length of the standard lens, a correspondence confirmation method and system for confirming whether or not a person or animal is in correct correspondence with an object prepared individually for the person or animal, an object confirmation method and system for confirming whether or not an object prepared individually for a person or animal is genuine or for confirming which person or animal the object is prepared for, an object confirmation method and system for confirming whether or not two types of objects prepared individually for each person or animal are objects prepared for the same person or animal, a subject identification method and system for identifying a subject using an imaging device, a user authentication method and system and an information terminal device for authenticating an identity of a user of one information terminal device when the user communicates via a network with a user of another information terminal device, and program products for them, and the present invention can be used for identity authentication using an iris or a fingerprint for example.

2. Description of the Related Art

In recent years, the Internet and cellular phones have grown in popularity, and electronic commerce such as so-called mobile banking or mobile trading using an information terminal device such as a cellular phone or the like is actively performed. In such electronic commerce, various information are transmitted and received between information terminal devices and service providing servers, and during such transmission and reception, assurance of security has great importance. Specifically, there rises a need to prevent so called “impersonating” by a third person to impersonate a registered user to use equipment or to access a network. As such a security technique, a user authentication technique using a password is commonly used.

Further, in a case of such electronic commerce as described above, it is necessary to authenticate a user of an information terminal device, who is accessing a service providing server via a network, as the “identical person” with no mistake. An example of a similar scene is identity confirmation or the like at an entrance/exit such as a door. For such identity confirmation at an entrance/exit, a password is often used, similarly to the case of the above-mentioned electronic commerce.

Furthermore, an example of a scene which requires the identity confirmation is that an identity of a patient who is a subject of operation or treatment is confirmed before the operation or treatment is performed in a hospital, to thereby prevent a malpractice. Further, in relation to not only a person but also an animal, when a dog, horse, or the like is traded for example, there rises a need to confirm whether its pedigree certificate is genuine or not. Moreover, for example, various types such as an identification, a driver's license, a passport, a membership card, a deposit book of a bank, a postcard for claiming a ballot paper for an election, and the like are used for confirming the identity of a person.

However, regarding assurance of security for the electric commerce as described above, a simple user authentication technique using a password as conventional ones has a possibility that a password may be stolen by a hacker or a malicious third person, thereby causing a problem that an unauthorized access is difficult to be prevented.

Further, for the identity confirmation using a password at an entrance/exit such as a door, the password may be glanced furtively by a third person, thereby causing a problem that an unauthorized trespassing is difficult to be prevented.

Besides the authentication technique using a password, authentication techniques using an iris or a fingerprint that is a personal biometric characteristic (biometrics) are gaining attention, but they have a possibility to accept a different person besides an identical person, so that it is desired to improve authentication accuracy to decrease an acceptance rate of a different person.

Furthermore, when operation or treatment is performed in a hospital, a doctor in charge of operation or treatment and a nurse supporting the doctor refer to a medical record, which is created in most cases by a different doctor in charge of diagnosis, in order to perform work such as operation, provision of medication, or the like. However, there are many patients in a hospital and the correspondence between a patient and a medical record placed beside the patient may be wrong, which causes malpractice due to misidentification of a patient. Therefore, it is desired to prevent such a malpractice from occurring.

Further, a pedigree certificate that is presented when trading an animal such as a dog, a horse, or the like may be simply mixed-up with others by traders during a procedure, or a fraud such as counterfeiting or replacing with other pedigree certificate may take place, so that the correspondence between an animal and a pedigree certificate thereof may be incorrect, and thus it is desired to prevent such a mix-up and fraud.

Furthermore, regarding identity confirmation by presenting an identification or the like, since such an identification or the like may be counterfeited, it is desired to be capable of issuing an identification or the like that is difficult to be counterfeited, or to be capable of quickly confirming whether or not it is a genuine identification or the like when it is presented.

An object of the present invention is to provide a user authentication method and system, an information terminal device and a service providing server, a subject identification method and system, a correspondence confirmation method and system, an object confirmation method and system, which can assure authentication or confirmation of a person, an animal, a plant, or an object and improve precision thereof, and program products for them.

### SUMMARY OF THE INVENTION

According to the present invention, a user authentication method for performing authentication of an identity of a user of an information terminal device when the user receives a service from a service providing server via a network is characterized in that it includes the steps of: capturing an iris image of the user himself/herself in advance and storing and registering the iris image as registration iris image data in at least one of the information terminal device and the service providing server; transmitting a current password defined individually for the user from the information terminal device to the service providing server, capturing a current iris image of the user by an imaging means provided in the information terminal device, and generating current iris image data in the information terminal device when the user receives a service from the service providing server by the information terminal device; comparing thereafter by the service providing server the current password transmitted from the information terminal device with a password stored in the service providing server, and comparing the current iris image data with the registration iris image data by at least one of the information terminal device and the service providing server to thereby authenticate the identity of the user based on comparison results thereof; and updating automatically thereafter by one of the information terminal device and the service providing server the password to generate a new password to be used when a next service is provided, transmitting the new password to the other of the information terminal device and the service providing server, and storing the same new password in both the information terminal device and the service providing server.

Here, examples of the information terminal device include both of a portable information terminal device and a stationary information terminal device, and include various information equipment suitable for receiving a service from the service providing server, such as a cellular phone (including a personal handy-phone system (PHS)), a personal digital assistant (PDA), a personal computer, an information equipment combining them, and the like.

Further, examples of the “network” connecting the information terminal device and the service providing server include various types of networks such as a local area network (LAN), a metropolitan area network (MAN), a wide area network (WAN), the Internet, an intranet, an extranet, a combination thereof, or the like, regardless of whether it is a wired type or a wireless type and whether it is a mixture of the wired type and the wireless type. Basically, it may be any network which is capable of transmitting information between plural points (regardless of a length of distance) with a certain level of speed.

Furthermore, the services provided by the service providing server include, for example, a balance inquiry or a transfer of deposit by a bank, a credit card company, or the like, provision of stock quotation or exchange of stocks by a securities company or the like, trading of commercial products such as compact disks (CDs), books, games, and the like by a shop server or the like on a network, booking of airline tickets, various events, or the like by an airline company, an agency, or the like.

The imaging means (including one provided in the information terminal device, one provided in the service providing server, and one besides them) for capturing in advance an iris image of the user himself/herself to be registered and stored as registration iris image data may be the same as/different from the imaging means (one provided in the information terminal device) for capturing a current iris image of the user when the user receives a service from the service providing server. However, from viewpoints of simplification of the system and improvement of authentication accuracy, they are preferred to be the same, in other words, both the registration iris image data and the current iris image data are preferred to be obtained by the imaging means provided in the information terminal device.

Further, after the identity is confirmed by the user authentication, the automatic update of a password may be performed any time before/during/after a service is provided.

According to the present invention as described above, since the automatic update of a password and the iris authentication are combined, the user authentication can be securely performed. Specifically, accessing by a different person to the service providing server using a different information terminal device can be prevented from occurring by the automatic update of a password, so that authentication of a registered terminal (terminal authentication) becomes possible. On the other hand, accessing by a different person to the service providing server using the information terminal device for the user himself/herself can be prevented from occurring by the iris authentication, so that the authentication of a registered user (identity authentication) becomes possible. Thus, the above-described object is accomplished.

Further, as a system for realizing the user authentication method according to the above-described present invention, a user authentication system according to the present invention is provided as described below.

Specifically, according to the present invention, a user authentication system for performing authentication of an identity of a user of an information terminal device between the information terminal device and a service providing server connected via a network when the user receives a service from the service providing server is characterized in that the service providing server includes: a password updating means for performing automatic update of a password every time a service is provided to the user to thereby generate a new password to be used when a next service is provided; a server-side password storing means for storing the new password generated by the automatic update performed by the password updating means; a new password transmitting means for transmitting the new password generated by the automatic update performed by the password updating means to the information terminal device; a current password receiving means for receiving a current password transmitted from the information terminal device; a password comparing means for comparing the current password received by the current password receiving means with a password before the automatic update stored in the server-side password storing means; a registration iris image data storing means for storing and registering an iris image of the user himself/herself which is captured in advance as registration iris image data; a current iris image data receiving means for receiving current iris image data transmitted from the information terminal device; and an iris image data comparing means for comparing the current iris image data received by the current iris image data receiving means with the registration iris image data stored in the registration iris image data storing means, and that the information terminal device includes: a current password transmitting means for transmitting the current password to the service providing server; a new password receiving means for receiving the new password transmitted from the service providing server; a terminal-side password storing means for storing the new password received by the new password receiving means; an imaging means for capturing a current iris image of the user; and a current iris image data transmitting means for transmitting the current iris image data obtained by capturing by the imaging means to the service providing server.

Here, the imaging means is constituted by including an imaging lens, and the imaging lens may be a single focal lens or a bifocal lens constituted by a standard lens and a close-up lens having a different focal length from each other. This point is the same for the following user authentication systems.

Further, whether the generation of a new password by the password updating means is regular or irregular is not taken into account. For example, it may be random extraction of a new password from a group of passwords prepared in advance, orderly adoption of a new password from regular or irregular password lines prepared in advance, random generation of a new password, or the like. This point is the same for the following user authentication systems.

According to the present invention as described above, the automatic update of a password is performed by the password updating means provided in the service providing server, and the iris authentication is performed by the iris image data comparing means provided in the service providing server, so that the identical operation and effect achieved by the above-described user authentication system of the present invention can be achieved. Therefore, the user authentication can be securely performed, and thus the above-described object is accomplished.

Further, according to the present invention, a user authentication system for performing authentication of an identity of a user of an information terminal device between the information terminal device and a service providing server connected via a network when the user receives a service from the service providing server is characterized in that the service providing server includes: a new password receiving means for receiving a new password transmitted from the information terminal device; a server-side password storing means for storing the new password received by the new password receiving means; a current password receiving means for receiving a current password transmitted from the information terminal device; a password comparing means for comparing the current password received by the current password receiving means with a password before automatic update stored in the server-side password storing means; a registration iris image data storing means for storing and registering an iris image of the user himself/herself which is captured in advance as registration iris image data; a current iris image data receiving means for receiving current iris image data transmitted from the information terminal device; and an iris image data comparing means for comparing the current iris image data received by the current iris image data receiving means with the registration iris image data stored in the registration iris image data storing means, and that the information terminal device includes: a current password transmitting means for transmitting the current password to the service providing server; a password updating means for performing automatic update of a password every time the user receives a service to thereby generate a new password to be used when the user receives a next service; a terminal-side password storing means for storing the new password generated by the automatic update performed by the password updating means; a new password transmitting means for transmitting the new password generated by the automatic update performed by the password updating means to the service providing server; an imaging means for capturing a current iris image of the user; and a current iris image data transmitting means for transmitting the current iris image data obtained by capturing by the imaging means to the service providing server.

According to the present invention as described above, the automatic update of a password is performed by the password updating means provided in the information terminal device, and the iris authentication is performed by the iris image data comparing means provided in the service providing server, so that the identical operation and effect achieved by the above-described user authentication system of the present invention can be achieved. Therefore, the user authentication can be securely performed, and thus the above-described object is accomplished.

Further, according to the present invention, a user authentication system for performing authentication of an identity of a user of an information terminal device between the information terminal device and a service providing server connected via a network when the user receives a service from the service providing server is characterized in that the service providing server includes: a password updating means for performing automatic update of a password every time a service is provided to the user to thereby generate a new password to be used when a next service is provided; a server-side password storing means for storing the new password generated by the automatic update performed by the password updating means; a new password transmitting means for transmitting the new password generated by the automatic update performed by the password updating means to the information terminal device; a current password receiving means for receiving a current password transmitted from the information terminal device; and a password comparing means for comparing the current password received by the current password receiving means with a password before the automatic update stored in the server-side password storing means, and that the information terminal device includes: a current password transmitting means for transmitting the current password to the service providing server; a new password receiving means for receiving the new password transmitted from the service providing server; a terminal-side password storing means for storing the new password received by the new password receiving means; a registration iris image data storing means for storing and registering an iris image of the user himself/herself which is captured in advance as registration iris image data; an imaging means for capturing a current iris image of the user; and an iris image data comparing means for comparing current iris image data obtained by capturing by the imaging means with the registration iris image data stored in the registration iris image data storing means.

Here, the service providing server may be configured to also perform comparison processing of the current iris image data with the registration iris image data by providing the registration iris image data storing means not only in the information terminal device but also in the service providing server, providing the iris image data comparing means, which compares the current iris image data with the registration iris image data, not only in the information terminal device but also in the service providing server, and transmitting the current iris image data from the information terminal device to the service providing server. At this time, the comparison processing in the service providing server may be performed together with the comparison processing in the information terminal device at all times, or may be performed as needed such as when a need of confirmation arises.

According to the present invention as described above, the automatic update of a password is performed by the password updating means provided in the service providing server, and the iris authentication is performed by the iris image data comparing means provided in the information terminal device, so that the identical operation and effect achieved by the above-described user authentication system of the present invention can be achieved. Therefore, the user authentication can be securely performed, and thus the above-described object is accomplished.

Further, according to the present invention, a user authentication system for performing authentication of an identity of a user of an information terminal device between the information terminal device and a service providing server connected via a network when the user receives a service from the service providing server is characterized in that the service providing server includes: a new password receiving means for receiving a new password after automatic update transmitted from the information terminal device; a server-side password storing means for storing the new password received by the new password receiving means; a current password receiving means for receiving a current password transmitted from the information terminal device; and a password comparing means for comparing the current password received by the current password receiving means with a password before the automatic update stored in the server-side password storing means, and that the information terminal device includes: a current password transmitting means for transmitting the current password to the service providing server; a password updating means for performing automatic update of a password every time the user receives a service to thereby generate a new password to be used when the user receives a next service; a terminal-side password storing means for storing the new password generated by the automatic update performed by the password updating means; a new password transmitting means for transmitting the new password generated by the automatic update performed by the password updating means to the service providing server; a registration iris image data storing means for storing and registering an iris image of the user himself/herself which is captured in advance as registration iris image data; an imaging means for capturing a current iris image of the user; and an iris image data comparing means for comparing current iris image data obtained by capturing by the imaging means with the registration iris image data stored in the registration iris image data storing means.

Here, the service providing server may be configured to also perform comparison processing of the current iris image data with the registration iris image data by providing the registration iris image data storing means not only in the information terminal device but also in the service providing server, providing the iris image data comparing means, which compares the current iris image data with the registration iris image data, not only in the information terminal device but also in the service providing server, and transmitting the current iris image data from the information terminal device to the service providing server. At this time, the comparison processing in the service providing server may be performed together with the comparison processing in the information terminal device at all times, or may be performed as needed such as when a need of confirmation arises.

According to the present invention as described above, the automatic update of a password is performed by the password updating means provided in the information terminal device, and the iris authentication is performed by the iris image data comparing means provided in the information terminal device, so that the identical operation and effect achieved by the above-described user authentication system of the present invention can be achieved. Therefore, the user authentication can be securely performed, and thus the above-described object is accomplished.

Further, according to the present invention, an information terminal device connected to a service providing server via a network is characterized in that it includes: a current password transmitting means for transmitting a current password to the service providing server; a password updating means for performing automatic update of a password every time a user receives a service from the service providing server to thereby generate a new password to be used when the user receives a next service; a terminal-side password storing means for storing the new password generated by the automatic update performed by the password updating means; a new password transmitting means for transmitting the new password generated by the automatic update performed by the password updating means to the service providing server; a registration iris image data storing means for storing and registering an iris image of the user himself/herself which is captured in advance as registration iris image data; an imaging means for capturing a current iris image of the user; and an iris image data comparing means for comparing current iris image data obtained by capturing by the imaging means with the registration iris image data stored in the registration iris image data storing means.

Further, according to the present invention, a service providing server connected to an information terminal device via a network is characterized in that it includes: a password updating means for performing automatic update of a password every time a service is provided to a user of the information terminal device to thereby generate a new password to be used when a next service is provided; a server-side password storing means for storing the new password generated by the automatic update performed by the password updating means; a new password transmitting means for transmitting the new password generated by the automatic update performed by the password updating means to the information terminal device; a current password receiving means for receiving a current password transmitted from the information terminal device; a password comparing means for comparing the current password received by the current password receiving means with a password before the automatic update stored in the server-side password storing means; a registration iris image data storing means for storing and registering an iris image of the user himself/herself which is captured in advance as registration iris image data; a current iris image data receiving means for receiving current iris image data obtained by capturing a current iris image of the user by an imaging means provided in the information terminal device; and an iris image data comparing means for comparing the current iris image data received by the current iris image data receiving means with the registration iris image data stored in the registration iris image data storing means.

Further, according to the present invention, a program product for a computer to function as an information terminal device connected to a service providing server via a network is characterized in that it includes: a current password transmitting means for transmitting a current password to the service providing server; a password updating means for performing automatic update of a password every time a user receives a service from the service providing server to thereby generate a new password to be used when the user receives a next service; a terminal-side password storing means for storing the new password generated by the automatic update performed by the password updating means; a new password transmitting means for transmitting the new password generated by the automatic update performed by the password updating means to the service providing server; a registration iris image data storing means for storing and registering an iris image of the user himself/herself which is captured in advance as registration iris image data; an imaging means for capturing a current iris image of the user; and an iris image data comparing means for comparing current iris image data obtained by capturing by the imaging means with the registration iris image data stored in the registration iris image data storing means.

Further, according to the present invention, a program product for a computer to function as a service providing server connected to an information terminal device via a network is characterized in that it includes: a password updating means for performing automatic update of a password every time a service is provided to a user of the information terminal device to thereby generate a new password to be used when a next service is provided; a server-side password storing means for storing the new password generated by the automatic update performed by the password updating means; a new password transmitting means for transmitting the new password generated by the automatic update performed by the password updating means to the information terminal device; a current password receiving means for receiving a current password transmitted from the information terminal device; a password comparing means for comparing the current password received by the current password receiving means with a password before the automatic update stored in the server-side password storing means; a registration iris image data storing means for storing and registering an iris image of the user himself/herself which is captured in advance as registration iris image data; a current iris image data receiving means for receiving current iris image data obtained by capturing a current iris image of the user by an imaging means provided in the information terminal device; and an iris image data comparing means for comparing the current iris image data received by the current iris image data receiving means with the registration iris image data stored in the registration iris image data storing means.

Further, according to the present invention, a subject identification method for identifying a subject using an imaging means constituted by including a standard lens and a close-up lens having a focal length shorter than a focal length of the standard lens is characterized in that it includes the steps of: capturing a standard image of the subject in advance to store the standard image as registration standard image data in a registration standard image data storing means, and capturing a close-up image of the subject in advance to store the close-up image as registration close-up image data in a registration close-up image data storing means; capturing a current standard image of the subject using the standard lens to generate current standard image data, and capturing a current close-up image of the subject using the close-up lens to generate current close-up image data when performing identification of the subject; and comparing thereafter by a close-up image data comparing means the current close-up image data with the registration close-up image data stored in the registration close-up image data storing means to thereby perform identification of the subject.

Here, examples of the subject include a person, an animal, a plant, an object such as a commercial product and a part, and the like.

Further, the close-up lens may be any lens having a relatively shorter focal length than the focal length of the standard lens, and when the subject is captured, the close-up lens may be or need not be in contact with the subject.

Furthermore, the imaging means for capturing in advance the standard image and the close-up image of the subject to be registered and stored as the registration standard image data and the registration close-up image data may be the same as/different from the imaging means for capturing the current standard image and the current close-up image of the subject when identifying the subject. However, from the viewpoints of simplification of the system and improvement of authentication accuracy, they are preferred to be the same.

At least the comparison processing of the current close-up image data with the registration close-up image data should be performed automatically by the close-up image data comparing means, and the comparison processing of the current standard image data with the registration standard image data may be performed automatically by the standard image data comparing means or may be performed by human eyes. Further, the comparison processing of the standard image data should not necessarily be performed at substantially the same time with the comparison processing of the close-up image data, which may be performed as ex-post processing or performed as needed.

According to the present invention as described above, the standard image of a subject is captured using the standard lens and the close-up image of the subject is captured using the close-up lens, so that strict identification by double checking becomes possible, and thus the above-described object is accomplished.

Preferably, the above-described subject identification method further includes the step of comparing by a standard image data comparing means the current standard image data with the registration standard image data stored in the registration standard image data storing means, along with the comparing step by the close-up image data comparing means, to thereby perform identification of the subject.

When the comparison processing is performed by the standard image data comparing means, automation of the identification processing is further advanced, so that strict identification by double checking in an unattended state becomes possible.

Further, as described above, examples of the subject according to the subject identification method of the present invention include a person, an animal, a plant, an object such as a commercial product and a part, and the like, and the subject identification method of the present invention can be suitably applied in the following particular cases.

Specifically, there is a case that, in the above-described subject identification method, the subject is a person or an animal; the standard image is a facial image capturing a substantially entire face of the subject; and the close-up image is an iris image capturing an iris of the subject. Examples of the animal include various animals such as a dog, cat, horse, cow, monkey, or the like.

Specifically, there is a case that, in the above described subject identification method, the subject is a person or an animal; the standard image is a hand/foot image capturing a substantially entire hand or foot of the subject; and the close-up image is a fingerprint image capturing a fingerprint of the subject.

Besides them, there is a case that the subject is a commercial product for example, in which an overall image of the commercial product is captured as the standard image using the standard lens, and a tag (hang tag, shipping tag, or the like) of the commercial product is captured as the close-up image using the close-up lens, and identification of the commercial product is performed on a distribution line.

Further, there is a case that the subject is a part, in which the imaging means is provided as an eye of a robot for assembling parts, an overall image of the part is captured as the standard image using the standard lens, details of the part are captured as the close-up image using the close-up lens, and parts are assembled on an assembly line.

Further, there is a case that the subject is a manufactured product, in which the imaging means is provided as an eye of a robot for inspecting manufactured products, an overall image of the manufactured product is captured as the standard image using the standard lens, details of the manufactured product are captured as the close-up image using the close-up lens, and manufactured products are inspected on an product inspection line.

Further, there is a case that the subject is a moving object, in which the imaging means is provided as an eye of a monitoring device for monitoring a moment of collision of a moving object, an overall image of the moving object at a relatively farther position is captured as the standard image using the standard lens, and an image of a moment of collision of the moving object is captured as the close-up image using the close-up lens.

Preferably, in a case that the facial image is captured using the above-described standard lens and the iris image is captured using the above-described close-up lens, an optical source noise, which is formed by reflecting a light source for illumination used when capturing an image, is combined into the registration close-up image data to be stored in the registration close-up image data storing means; when a current close-up image of the subject is captured using the close-up lens, a same light source as the light source for illumination is used so that an optical source noise is combined into the current close-up image data; and when the comparing step is performed by the close-up image data comparing means, the current close-up image data including the optical source noise is compared with the registration close-up image data including the optical source noise.

When identification is thus performed by capturing an iris image including an optical source noise, it becomes possible to prevent an unauthorized activity of impersonation using a picture, motion picture, or the like from occurring.

Preferably, in a case that the identification is performed by capturing an iris image including an optical source noise as described above, when the current close-up image of the subject is captured using the close-up lens, a shape, pattern, color, or combination thereof of the light source is updated to be changed; and when the comparing step is performed by the close-up image data comparing means, a shape, pattern, color, or combination thereof of the optical source noise of the registration close-up image data used in the comparing step is changed according to the change in a shape, pattern, color, or combination thereof of the light source.

Here, in a case that “a shape, pattern, color, or combination thereof” is changed, a change in only the color is easy to be a target of an unauthorized activity as compared to other cases, so that when the color is changed, it is preferred to be combined with a change of another element, which is a shape or pattern.

When a shape, pattern, color, or combination thereof of the light source is thus updated to be changed, an unauthorized activity of impersonation using a picture, motion picture, or the like can be more securely prevented from occurring.

Preferably, in a case that the shape, pattern, color, or combination thereof of the light source is updated to be changed as described above, the light source is a display portion which performs displaying on a screen; and when the shape, pattern, color, or combination thereof of the light source is updated to be changed, a shape, pattern, color, or combination thereof of a display drawn on the screen of the display portion is changed.

When the display drawn on the screen of the display portion is thus changed, a change in a shape, pattern, color, or combination thereof of the light source can be easily realized, and a variation of the change can be freely set.

Further, as a system for realizing the subject identification method according to the above-described present invention, a subject identification system according to the present invention is provided as described below.

Specifically, according to the present invention, a subject identification system for identifying a subject using an imaging means constituted by including a standard lens and a close-up lens having a focal length shorter than a focal length of the standard lens is characterized in that it includes: a registration standard image data storing means for storing and registering a standard image of the subject captured in advance as registration standard image data; a registration close-up image data storing means for storing and registering a close-up image of the subject captured in advance as registration close-up image data; a current standard image obtaining means for capturing a current standard image of the subject using the standard lens to thereby generate current standard image data; a current close-up image obtaining means for capturing a current close-up image of the subject using the close-up lens to thereby generate current close-up image data; and a close-up image data comparing means for comparing the current close-up image data obtained by the current close-up image obtaining means with the registration close-up image data stored in the registration close-up image data storing means.

According to the present invention as described above, the identical operation and effect achieved by the above-described subject identification method of the present invention can be achieved, so that strict identification by double checking becomes possible, and thus the above-described object is accomplished.

Preferably, the above-described subject identification system further includes a standard image data comparing means for comparing the current standard image data obtained by the current standard image obtaining means with the registration standard image data stored in the registration standard image data storing means.

When a standard image data comparing means is provided as described above, it becomes possible to automatically perform not only the comparison processing of the close-up image data but also the comparison processing of the standard image data, so that automation of the identification processing is further advanced, and strict identification by double checking in an unattended state becomes possible.

Preferably, in the above-described subject identification system, the subject is a person or an animal; the close-up image is an iris image capturing an iris of the subject; a light source for illumination emitting light toward the subject when the current close-up image of the subject is captured using the close-up lens is provided; and the light source is configured to have a shape, pattern, color, or combination thereof which is updated to be changed.

When a shape, pattern, color, or combination thereof of the light source is thus updated to be changed, an unauthorized activity of impersonation using a picture, motion picture, or the like can be more securely prevented from occurring.

Preferably, in the above-described subject identification system, the subject is a person or an animal; the close-up image is an iris image capturing an iris of the subject; a light source for illumination emitting light toward the subject when the current close-up image of the subject is captured using the close-up lens is provided; and the illumination by the light source has a same brightness as a brightness for capturing the close-up image of the subject for obtaining the registration close-up image data to be stored in the registration close-up image data storing means, and the illumination by the light source keeps a constant brightness every time the current close-up image of the subject is captured.

When a brightness of the light source is thus kept constant, it becomes possible to capture an iris image with the size of a pupil being kept constant, so that identification accuracy thereof can be improved.

Further, according to the present invention, a program product for a computer to function as a subject identification system for identifying a subject using an imaging means constituted by including a standard lens and a close-up lens having a focal length shorter than a focal length of the standard lens is characterized in that it includes: a registration standard image data storing means for storing and registering a standard image of the subject captured in advance as registration standard image data; a registration close-up image data storing means for storing and registering a close-up image of the subject captured in advance as registration close-up image data; a current standard image obtaining means for capturing a current standard image of the subject using the standard lens to thereby generate current standard image data; a current close-up image obtaining means for capturing a current close-up image of the subject using the close-up lens to thereby generate current close-up image data; and a close-up image data comparing means for comparing the current close-up image data obtained by the current close-up image obtaining means with the registration close-up image data stored in the registration close-up image data storing means.

Further, according to the present invention, a correspondence confirmation method for confirming whether a correspondence between a person or animal and an object prepared individually for the person or animal is correct or not is characterized in that it includes the steps of: capturing an image of an iris or fingerprint of the person or animal in advance, converting by a converting means image data obtained by capturing into two-dimensional barcode data expressed by a two-dimensional barcode, and attaching a two-dimensional barcode on the object based on the two-dimensional barcode data; capturing an image of an iris or fingerprint of the person or animal at a time of confirmation using an imaging means when confirming the correspondence, converting by a converting means image data at the time of confirmation obtained by capturing into two-dimensional barcode data, and reading using the imaging means two-dimensional barcode data by capturing the two-dimensional barcode attached on the object; and comparing thereafter by a two-dimensional barcode data comparing means the two-dimensional barcode data obtained by converting the image data at the time of confirmation with the two-dimensional barcode data read from the two-dimensional barcode attached on the object to thereby confirm whether the both two-dimensional barcode data coincide with each other or not.

Here, examples of attaching the two-dimensional barcode on an object include printing, sticking, inscribing, burning, and weaving of the two-dimensional barcode on an object as well as tying of a hang tag displaying the two-dimensional barcode on an object by a cord, or the like. This point is the same for the following inventions.

Further, examples of the correspondence include a correspondence between a patient (person) and a medical record (object) of the patient in a hospital, a correspondence between a dog or horse (animal) and a pedigree certificate (object) thereof, a correspondence between a voter (person) and a ballot paper for him/her or a postcard (object) for claiming the ballot paper, a correspondence between an examinee (person) and an examination admission card (object), a correspondence between a presenter (person) of an identification and the identification (object), or the like.

According to the present invention as described above, an image of an iris or fingerprint of a person or animal at the time of confirmation is captured, a two-dimensional barcode attached on an object is captured, and then obtained two-dimensional barcode data are compared, so that a correspondence between a person or animal and an object can be confirmed with high accuracy, and thus the above-described object is accomplished.

Further, as a system for realizing the correspondence confirmation method according to the above-described present invention, a correspondence confirmation system according to the present invention is provided as described below.

Specifically, according to the present invention, a correspondence confirmation system for confirming whether a correspondence between a person or animal and an object prepared individually for the person or animal is correct or not is characterized in that it includes: an imaging means for capturing an image of an iris or fingerprint of the person or animal and capturing a two-dimensional barcode attached on the object when confirming the correspondence; a converting means for converting image data of the iris or fingerprint of the person or animal captured using the imaging means into two-dimensional barcode data; a decoding means for reading two-dimensional barcode data form the two-dimensional barcode captured using the imaging means; and a two-dimensional barcode data comparing means for comparing the two-dimensional barcode data obtained by converting by the converting means with the two-dimensional barcode data read by the decoding means.

Further, the imaging means is constituted by including an imaging lens, and the imaging lens may be a single focal lens or a bifocal lens constituted by a standard lens and a close-up lens having a different focal length from each other.

According to the present invention as described above, the identical operation and effect achieved by the above-described correspondence confirmation method of the present invention can be achieved, so that a correspondence between a person or animal and an object can be confirmed with high accuracy, and thus the above-described object is accomplished.

Further, according to the present invention, a program product for a computer to function as a correspondence confirmation system for confirming whether a correspondence between a person or animal and an object prepared individually for the person or animal is correct or not is characterized in that it includes: an imaging means for capturing an image of an iris or fingerprint of the person or animal and capturing a two-dimensional barcode attached on the object when confirming the correspondence; a converting means for converting image data of the iris or fingerprint of the person or animal captured using the imaging means into two-dimensional barcode data; a decoding means for reading two-dimensional barcode data form the two-dimensional barcode captured using the imaging means; and a two-dimensional barcode data comparing means for comparing the two-dimensional barcode data obtained by converting by the converting means with the two-dimensional barcode data read by the decoding means.

Further, according to the present invention, an object confirmation method for confirming whether or not an object prepared individually for a person or animal is genuine or which person or animal the object is prepared for is characterized in that it includes the steps of: capturing an image of an iris or fingerprint of the person or animal in advance, converting by a converting means image data obtained by capturing into two-dimensional barcode data expressed by a two-dimensional barcode, storing the two-dimensional barcode data in a two-dimensional barcode data storing means, and attaching a two-dimensional barcode on the object based on the two-dimensional barcode data; reading using an imaging means two-dimensional barcode data by capturing the two-dimensional barcode attached on the object when confirming whether or not the object is genuine or which person or animal the object is prepared for; and comparing thereafter by a two-dimensional barcode data comparing means the two-dimensional barcode data read from the two-dimensional barcode attached on the object with the two-dimensional barcode data stored in the two-dimensional barcode data storing means to thereby confirm whether the both two-dimensional barcode data coincide with each other or not.

Here, examples of the target object of the confirmation include an identification, a driver's license, a passport, a membership card, a pass permit, a deposit book or a cash card of a bank, a credit card, a traveler's check, a seal, an identification label, a badge, or the like.

Further, the imaging means for capturing an image of an iris or fingerprint of a person or animal in advance to obtain two-dimensional barcode data to be stored in the two-dimensional barcode data storing means may be the same as/different from the imaging means for capturing a two-dimensional barcode attached on an object when confirming correspondence.

According to the above-described present invention, the two-dimensional barcode attached on an object is captured, and the confirmation is performed based on the two-dimensional barcode data stored in the two-dimensional barcode data storing means in advance, so that whether or not an object is genuine or which person or animal an object is prepared for can be confirmed quickly with high accuracy, and further an unauthorized activity such as counterfeiting of the object can be easily found. Therefore, the above-described object is accomplished.

Further, as a system for realizing the object confirmation method according to the above-described present invention, an object confirmation system according to the present invention is provided as described below.

Specifically, according to the present invention, an object confirmation system for confirming whether or not an object prepared individually for a person or animal is genuine or which person or animal the object is prepared for is characterized in that it includes: a converting means for converting image data of an iris or fingerprint of the person or animal captured in advance into two-dimensional barcode data; a two-dimensional barcode data storing means for storing the two-dimensional barcode data obtained by the converting means; an imaging means for capturing a two-dimensional barcode attached on the object at a time of the confirmation; a decoding means for reading two-dimensional barcode data from the two-dimensional barcode captured using the imaging means; and a two-dimensional barcode data comparing means for comparing the two-dimensional barcode data read by the decoding means with the two-dimensional barcode data stored in the two-dimensional barcode data storing means.

Here, the imaging means is constituted by including an imaging lens, and the imaging lens may be a single focal lens or a bifocal lens constituted by a standard lens and a close-up lens having a different focal length from each other.

According to the present invention as described above, the identical operation and effect achieved by the above-described object confirmation method of the present invention can be achieved, so that whether or not an object is genuine or which person or animal an object is prepared for can be confirmed quickly with high accuracy. Therefore, the above-described object is accomplished.

Further, according to the present invention, a program product for a computer to function as an object confirmation system for confirming whether or not an object prepared individually for a person or animal is genuine or which person or animal the object is prepared for is characterized in that it includes: a converting means for converting image data of an iris or fingerprint of the person or animal captured in advance into two-dimensional barcode data; a two-dimensional barcode data storing means for storing the two-dimensional barcode data obtained by the converting means; an imaging means for capturing a two-dimensional barcode attached on the object at a time of the confirmation; a decoding means for reading two-dimensional barcode data from the two-dimensional barcode captured using the imaging means; and a two-dimensional barcode data comparing means for comparing the two-dimensional barcode data read by the decoding means with the two-dimensional barcode data stored in the two-dimensional barcode data storing means.

Further, according to the present invention, an object confirmation method for confirming whether or not two types of objects prepared individually for a person or animal are objects prepared for the same person or animal is characterized in that it includes the steps of: capturing an image of an iris or fingerprint of the person or animal in advance, converting by a converting means image data obtained by capturing into two-dimensional barcode data expressed by a two-dimensional barcode, and attaching a same two-dimensional barcode on both the two types of objects based on the two-dimensional barcode data; reading using an imaging means respective two-dimensional barcode data by capturing the respective two-dimensional barcodes attached on the two types of objects when confirming whether or not the two types of objects are the objects prepared for the same person or animal; and comparing thereafter by a two-dimensional barcode data comparing means the two-dimensional barcode data read from the respective two-dimensional barcodes attached on the two types of objects with each other to thereby confirm whether the both two-dimensional barcode data coincide with each other or not.

Here, examples of the two types of target objects of the confirmation include a membership card and a membership list, an admission ticket and a participant list, a ballot paper or a postcard for claiming the ballot paper and a voter list, and the like.

According to the present invention as described above, respective two-dimensional barcodes attached on two types of objects are captured, and whether obtained two-dimensional barcode data of the both coincide or not is confirmed, so that whether attribution of the two types of objects coincide or not can be quickly confirmed with high accuracy, and further an unauthorized activity such as counterfeiting of the object can be easily found. Therefore, the above-described object is accomplished.

Further, as a system for realizing the object confirmation method according to the above-described present invention, an object confirmation system according to the present invention is provided as described below.

Specifically, according to the present invention, an object confirmation system for confirming whether or not two types of objects prepared individually for a person or animal are objects prepared for the same person or animal is characterized in that it includes: an imaging means for capturing respective two-dimensional barcodes attached on the two types of objects at a time of the confirmation; a decoding means for reading respective two-dimensional barcode data from the respective two-dimensional barcodes captured using the imaging means; and a two-dimensional barcode data comparing means for comparing the two-dimensional barcode data read by the decoding means with each other.

Here, the imaging means is constituted by including an imaging lens, and the imaging lens may be a single focal lens or a bifocal lens constituted by a standard lens and a close-up lens having a different focal length from each other.

According to the present invention as described above, the identical operation and effect achieved by the above-described object confirmation method of the present invention can be achieved, so that whether attribution of two objects coincide or not can be quickly confirmed with high accuracy. Therefore, the above-described object is accomplished.

Further, according to the present invention, a program product for a computer to function as an object confirmation system for confirming whether or not two types of objects prepared individually for a person or animal are objects prepared for the same person or animal is characterized in that it includes: an imaging means for capturing respective two-dimensional barcodes attached on the two types of objects at a time of the confirmation; a decoding means for reading respective two-dimensional barcode data from the respective two-dimensional barcodes captured using the imaging means; and a two-dimensional barcode data comparing means for comparing the two-dimensional barcode data read by the decoding means with each other.

Further, according to the present invention, a subject identification method for identifying a subject using an imaging means is characterized in that it includes the steps of: capturing an iris image of the subject in advance and storing the iris image as registration iris image data in a registration iris image data storing means, and capturing a fingerprint image of the subject and storing the fingerprint image as registration fingerprint image data in a registration fingerprint image data storing means; capturing a current iris image of the subject using the imaging means to generate current iris image data, and capturing a current fingerprint image of the subject using the imaging means to generate current fingerprint image data when identifying the subject; and comparing thereafter by an iris image data comparing means the current iris image data with the registration iris image data stored in the registration iris image data storing means, and comparing by a fingerprint image data comparing means the current fingerprint image data with the registration fingerprint image data stored in the registration fingerprint image data storing means to thereby identify the subject.

Here, examples of the subject include a person and an animal.

Further, the imaging means for capturing in advance the iris image and the fingerprint image of the subject to be registered and stored as the registration iris image data and the registration fingerprint image data may be the same as/different from the imaging means for capturing the current iris image and the current fingerprint image of the subject when identifying the subject. However, from the viewpoints of simplification of the system and improvement of identification accuracy, they are preferred to be the same.

According to the present invention as described above, the iris authentication and the fingerprint authentication are combined, so that a different person/different animal acceptance rate of accepting a different person/different animal can be decreased to thereby improve identification accuracy. Therefore, the above-described object is accomplished.

Preferably, in the above-described subject identification method, an optical source noise, which is formed by reflecting a light source for illumination used when capturing an image, is combined into the registration iris image data to be stored in the registration iris image data storing means; when a current iris image of the subject is captured using the imaging means, a same light source as the light source for illumination is used so that an optical source noise is combined into the current iris image data; and when the comparing step is performed by the iris image data comparing means, the current iris image data including the optical source noise is compared with the registration iris image data including the optical source noise.

When identification is thus performed by capturing an iris image including an optical source noise, it becomes possible to prevent an unauthorized activity of impersonation using a picture, motion picture, or the like from occurring.

Preferably, in a case that the identification is performed by capturing the iris image including the optical source noise as described above, when the current iris image of the subject is captured using the imaging means, a shape, pattern, color, or combination thereof of the light source is updated to be changed; and when the comparing step is performed by the iris image data comparing means, a shape, pattern, color, or combination thereof of the optical source noise of the registration iris image data used in the comparing step is changed according to the change in a shape, pattern, color, or combination thereof of the light source.

Here, in a case that “a shape, pattern, color, or combination thereof” is changed, a change in only the color is easy to be a target of an unauthorized activity as compared to other cases, so that when the color is changed, it is preferred to be combined with a change of another element, which is a shape or pattern.

When a shape, pattern, color, or combination thereof of the light source is thus updated to be changed, an unauthorized activity of impersonation using a picture, motion picture, or the like can be more securely prevented from occurring.

Preferably, in a case that the shape, pattern, color, or combination thereof of the light source is updated to be changed as described above, the light source is a display portion which performs displaying on a screen; and when the shape, pattern, color, or combination thereof of the light source is updated to be changed, a shape, pattern, color, or combination thereof of a display drawn on the screen of the display portion is changed.

When the display drawn on the screen of the display portion is thus changed, a change in a shape, pattern, color, or combination thereof of the light source can be easily realized, and a variation of the change can be freely set.

Further, as a system for realizing the subject identification method according to the above-described present invention, a subject identification system according to the present invention is provided as described below.

Specifically, according to the present invention, a subject identification system for identifying a subject using an imaging means is characterized in that it includes: a registration iris image data storing means for storing and registering an iris image of the subject captured in advance as registration iris image data; a registration fingerprint image data storing means for storing and registering a fingerprint image of the subject captured in advance as registration fingerprint image data; a current iris image obtaining means for capturing a current iris image of the subject using the imaging means to thereby generate current iris image data; a current fingerprint image obtaining means for capturing a current fingerprint image of the subject using the imaging means to thereby generate current fingerprint image data; an iris image data comparing means for comparing the current iris image data obtained by the current iris image obtaining means with the registration iris image data stored in the registration iris image data storing means; and a fingerprint image data comparing means for comparing the current fingerprint image data obtained by the current fingerprint image obtaining means with the registration fingerprint image data stored in the registration fingerprint image data storing means.

Here, the imaging means is constituted by including an imaging lens, and the imaging lens may be a single focal lens or a bifocal lens constituted by a standard lens and a close-up lens having a different focal length from each other.

According to the present invention as described above, the identical operation and effect achieved by the above-described subject identification method of the present invention can be achieved, so that a different person/different animal acceptance rate of accepting a different person/different animal can be decreased to thereby improve identification accuracy. Therefore, the above-described object is accomplished.

Further, according to the present invention, a program product for a computer to function as a subject identification system for identifying a subject using an imaging means is characterized in that it includes: a registration iris image data storing means for storing and registering an iris image of the subject captured in advance as registration iris image data; a registration fingerprint image data storing means for storing and registering a fingerprint image of the subject captured in advance as registration fingerprint image data; a current iris image obtaining means for capturing a current iris image of the subject using the imaging means to thereby generate current iris image data; a current fingerprint image obtaining means for capturing a current fingerprint image of the subject using the imaging means to thereby generate current fingerprint image data; an iris image data comparing means for comparing the current iris image data obtained by the current iris image obtaining means with the registration iris image data stored in the registration iris image data storing means; and a fingerprint image data comparing means for comparing the current fingerprint image data obtained by the current fingerprint image obtaining means with the registration fingerprint image data stored in the registration fingerprint image data storing means.

Further, according to the present invention, a user authentication method for authenticating an identity of a user of one information terminal device when the user communicates via a network with a user of another information terminal device is characterized in that it includes the steps of: transmitting iris image data and/or fingerprint image data obtained by capturing by the one information terminal device an iris image and/or a fingerprint image of the user himself/herself of the one information terminal device with information which is an object of communication to the another information terminal device; receiving by the another information terminal device the iris image data and/or the fingerprint image data transmitted with the information which is the object of communication from the one information terminal device and storing and registering the iris image data and/or the fingerprint image data as registration iris image data and/or registration fingerprint image data; and comparing the received iris image data and/or the received fingerprint image data with the registration iris image data and/or the registration fingerprint image data to thereby authenticate an identity of the user of the one information terminal device based on a comparison result thereof when the iris image data and/or the fingerprint image data transmitted with the information which is the object of communication from the one information terminal device is received by the another information terminal device at a time a next and subsequent communication is performed.

Here, examples of the information terminal device include both of a portable information terminal device and a stationary information terminal device, and include various information equipment suitable for performing communication, such as a cellular phone (including a PHS), a PDA, a personal computer, an information equipment combining them, and the like.

Further, examples of the “network” connecting the information terminal devices with each other include various types of networks such as a LAN, a MAN, a WAN, the Internet, an intranet, an extranet, a combination thereof, or the like, regardless of whether it is a wired type or a wireless type and whether it is a mixture of the wired type and the wireless type. Basically, it may be any network which is capable of transmitting information between plural points (regardless of a length of distance) with a certain level of speed.

Further, the iris image data and/or fingerprint image data transmitted with the information which is an object of communication (the iris image data and/or fingerprint image data added to the information which is an object of the communication) should not necessarily be transmitted simultaneously with the information which is an object of the communication. The iris image data and/or fingerprint image data may be transmitted before/after the information. Basically, they are satisfactory as long as being companion to the information.

As the information which is an object of communication include, for example, information or the like exchanged by e-mails or by chatting. Further, the communication through the network may be communication performed in real time, communication performed not in real time, communication performed directly between information terminal devices with each other, or communication performed via various servers intervening on the network. For example, it may be a form of communication such that information is retained once in a mail server intervening on the network, such as transmission/reception of e-mails. Alternatively, it may be a form of communication such that information is exchanged in real time using a function of a real time conference room which is set up on a forum, such as messages exchanged by chatting.

According to the present invention as described above, by transmitting/receiving iris image data and/or fingerprint image data with information which is an object of communication, the iris image data and/or fingerprint image data are used as substitutes for a signature (electronic signature) or used in combination with a signature, and authentication of an information sender can be performed based on the iris image data and/or fingerprint image data, so that the identity of the information sender can be confirmed. Therefore, the above-described object is accomplished.

Further, as a system for realizing the user authentication method according to the above-described present invention, a user authentication system according to the present invention is provided as described below.

Specifically, according to the present invention, a user authentication system for authenticating an identity of a user of one information terminal device when the user communicates via a network with a user of another information terminal device is characterized in that the one information terminal device includes: an imaging means for capturing an iris image and/or a fingerprint image of the user; an iris image data and/or fingerprint image data added information creating means for adding the iris image data and/or the fingerprint image data obtained by capturing by the imaging means to information which is an object of communication; and an iris image data and/or fingerprint image data added information transmitting means for transmitting iris image data and/or fingerprint image data added information created by the iris image data and/or fingerprint image data added information creating means to the another information terminal device, and that the another information terminal device includes: an iris image data and/or fingerprint image data added information receiving means for receiving the iris image data and/or fingerprint image data added information transmitted from the one information terminal device; a registration iris image data storing means and/or a registration fingerprint image data storing means for storing and registering as registration iris image data and/or registration fingerprint image data the iris image data and/or the fingerprint image data of the user himself/herself included in the iris image data and/or fingerprint image data added information received by the iris image data and/or fingerprint image data added information receiving means; and an iris image data comparing means and/or a fingerprint image data comparing means for comparing iris image data and/or fingerprint image data included in the iris image data and/or fingerprint image data added information received by the iris image data and/or fingerprint image data added information receiving means with the registration iris image data stored in the registration iris image data storing means and/or the registration fingerprint image data stored in the registration fingerprint image data storing means at a time a next and subsequent communication is performed.

Here, the imaging means is constituted by including an imaging lens, and the imaging lens may be a single focal lens or a bifocal lens constituted by a standard lens and a close-up lens having a different focal length from each other.

According to the present invention as described above, the identical operation and effect achieved by the above-described user authentication method of the present invention can be achieved, so that the identity of an information sender can be confirmed. Therefore, the above-described object is accomplished.

Further, according to the present invention, an information terminal device having a user authentication function for authenticating an identity of a user when the user communicates with another user via a network is characterized in that it includes: an imaging means for capturing an iris image and/or a fingerprint image of the user; an iris image data and/or fingerprint image data added information creating means for adding the iris image data and/or the fingerprint image data obtained by capturing by the imaging means to information which is an object of communication; an iris image data and/or fingerprint image data added information transmitting means for transmitting iris image data and/or fingerprint image data added information created by the iris image data and/or fingerprint image data added information creating means to another information terminal device; an iris image data and/or fingerprint image data added information receiving means for receiving iris image data and/or fingerprint image data added information transmitted from the another information terminal device; a registration iris image data storing means and/or a registration fingerprint image data storing means for storing and registering as registration iris image data and/or registration fingerprint image data iris image data and/or fingerprint image data of a user himself/herself of the another information terminal device included in the iris image data and/or fingerprint image data added information received by the iris image data and/or fingerprint image data added information receiving means; and an iris image data comparing means and/or a fingerprint image data comparing means for comparing iris image data and/or fingerprint image data included in the iris image data and/or fingerprint image data added information received by the iris image data and/or fingerprint image data added information receiving means with the registration iris image data stored in the registration iris image data storing means and/or the registration fingerprint image data stored in the registration fingerprint image data storing means at a time a next and subsequent communication is performed with the another information terminal device.

Further, according to the present invention, a program product for a computer to function as an information terminal device having a user authentication function for authenticating an identity of a user when the user communicates with another user via a network is characterized in that it includes: an imaging means for capturing an iris image and/or a fingerprint image of the user; an iris image data and/or fingerprint image data added information creating means for adding the iris image data and/or the fingerprint image data obtained by capturing by the imaging means to information which is an object of communication; an iris image data and/or fingerprint image data added information transmitting means for transmitting iris image data and/or fingerprint image data added information created by the iris image data and/or fingerprint image data added information creating means to another information terminal device; an iris image data and/or fingerprint image data added information receiving means for receiving iris image data and/or fingerprint image data added information transmitted from the another information terminal device; a registration iris image data storing means and/or a registration fingerprint image data storing means for storing and registering as registration iris image data and/or registration fingerprint image data iris image data and/or fingerprint image data of a user himself/herself of the another information terminal device included in the iris image data and/or fingerprint image data added information received by the iris image data and/or fingerprint image data added information receiving means; and an iris image data comparing means and/or a fingerprint image data comparing means for comparing iris image data and/or fingerprint image data included in the iris image data and/or fingerprint image data added information received by the iris image data and/or fingerprint image data added information receiving means with the registration iris image data stored in the registration iris image data storing means and/or the registration fingerprint image data stored in the registration fingerprint image data storing means at a time a next and subsequent communication is performed with the another information terminal device.

It should be noted that the above-described respective program products or a part thereof of the present invention can be recorded in a recording medium such as a magneto-optical disk (MO), a read-only memory (CD-ROM) using a compact disk (CD), a CD recordable (CD-R), a CD rewritable (CD-RW), a read-only memory (DVD-ROM) using a digital versatile disk (DVD), a random access memory (DVD-RAM) using a DVD, a flexible disk (FD), a magnetic tape, a hard disk, a read-only memory (ROM), a random access memory (RAM), an electrically erasable programmable read-only memory (EEPROM), and the like for storing, distributing, and the like, and also can be transmitted using a transmission medium such as a wired network, which is a LAN, a MAN, a WAN, the Internet, an intranet, an extranet or the like, a wireless communication network, and a combination thereof, or can be transmitted on a carrier wave. Furthermore, the above-described program products may be a part of another program, or may be recorded with different program products on a recording medium.

Further, as the above-described various storing means of the present invention, for example, a hard disk, a ROM, a RAM, an EEPROM, an MO, a CD-ROM, a CD-R, a CD-RW, a DVD-ROM, a DVD-RAM, an FD, a magnetic tape, a combination thereof, or the like can be adopted.

### BRIEF DESCRIPTION OF THE DRAWINGS

FIG. 1 is an overall configuration view of a user authentication system of a first embodiment of the present invention;

FIG. 2 is a detailed configuration view of the user authentication system of the first embodiment;

FIG. 3 is a flowchart describing a procedure of user authentication processing performed using the user authentication system of the first embodiment;

FIG. 4 is a detailed configuration diagram of a user authentication system of a second embodiment of the present invention;

FIG. 5 is a flowchart describing a procedure of user authentication processing performed using the user authentication system of the second embodiment;

FIG. 6 is a detailed configuration view of a user authentication system of a third embodiment of the present invention;

FIG. 7 is a flowchart describing a procedure of user authentication processing performed using the user authentication system of the third embodiment;

FIG. 8 is a detailed configuration view of a user authentication system of a fourth embodiment of the present invention;

FIG. 9 is a flowchart describing a procedure of user authentication processing performed using the user authentication system of the fourth embodiment;

FIG. 10 is a detailed configuration view of a user authentication system of a fifth embodiment of the present invention;

FIG. 11 is a detailed configuration view of a user authentication system of a sixth embodiment of the present invention;

FIG. 12 is an overall configuration view of a subject identification system of a seventh embodiment of the present invention;

FIG. 13 is an enlarged view of a substantial part of the subject identification system of the seventh embodiment;

FIG. 14 is an enlarged view of an iris of a human eye of a subject which is a target of identification by the subject identification system of the seventh embodiment;

FIG. 15 is an overall configuration view of a correspondence confirmation system of an eighth embodiment of the present invention;

FIG. 16 is an explanatory view of a use status of the correspondence confirmation system of the eighth embodiment;

FIG. 17 is a view showing an example of a two-dimensional barcode used when confirming correspondence by the correspondence confirmation system of the eighth embodiment;

FIG. 18 is an overall configuration view of an identification confirmation system which is an object confirmation system of a ninth embodiment of the present invention;

FIG. 19 is an overall configuration view of a membership card confirmation system which is an object confirmation system of a tenth embodiment of the present invention;

FIG. 20 is an overall configuration view of a subject identification system of an eleventh embodiment of the present invention; and

FIG. 21 is an overall configuration view of a user authentication system of a twelfth embodiment of the present invention.

### DETAILED DESCRIPTION OF THE PREFERRED EMBODIMENTS

Hereinafter, respective embodiments of the present invention will be described with reference to the drawings.

### First Embodiment

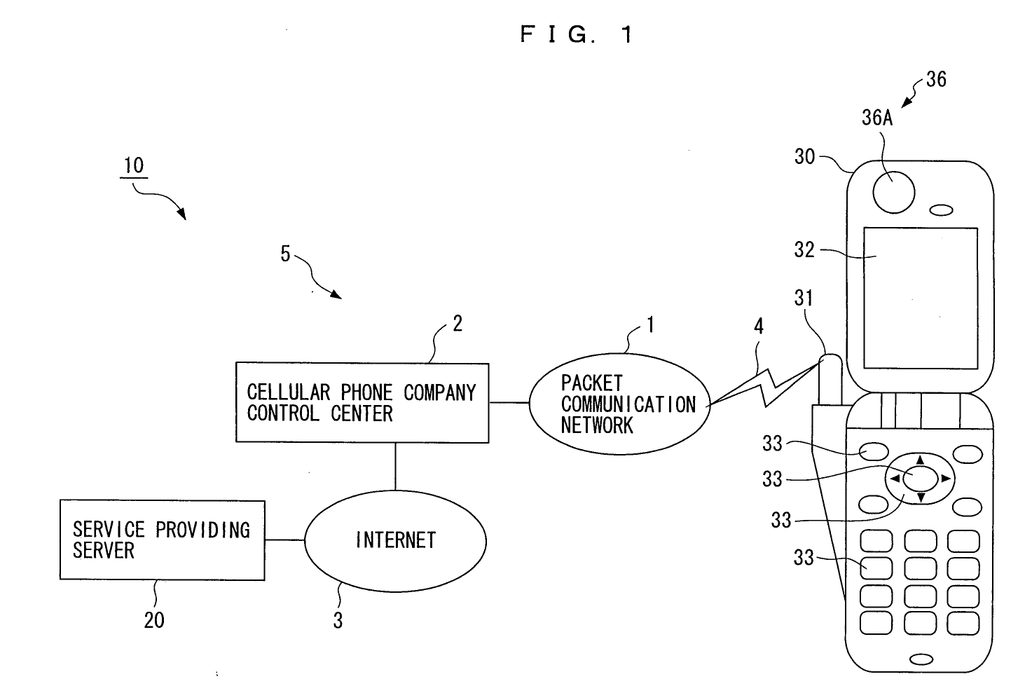

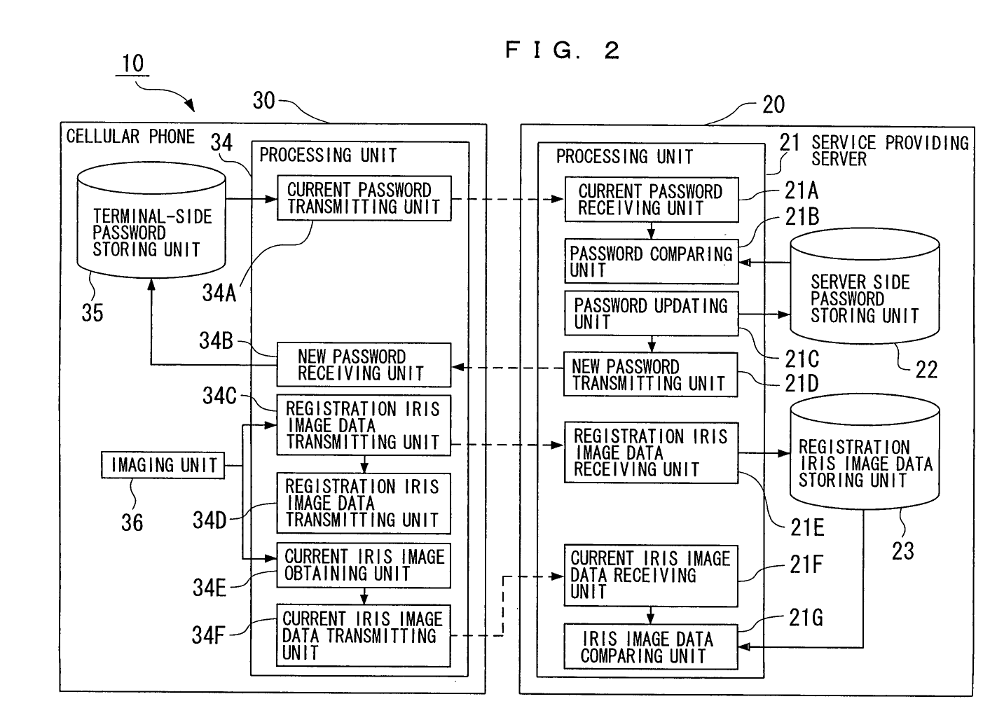

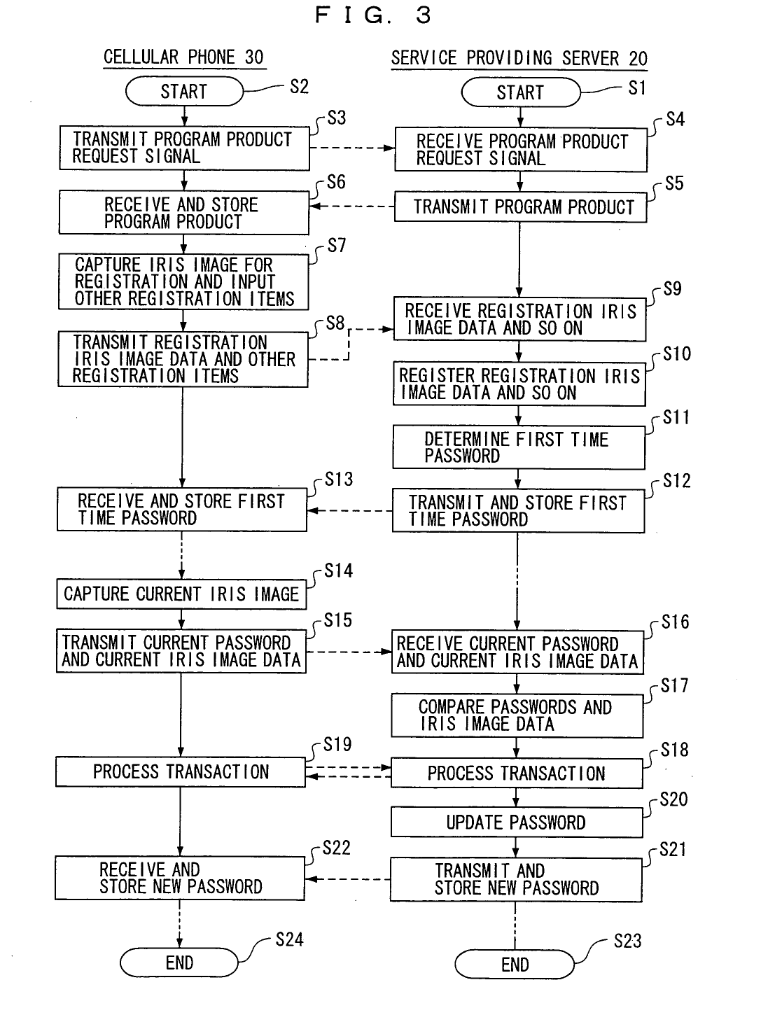

FIG. 1 shows an overall configuration of a user authentication system 10 of a first embodiment of the present invention. FIG. 2 shows a detailed configuration of the user authentication system 10, and FIG. 3 shows a flowchart describing a procedure of user authentication processing which is carried out using the user authentication system 10.

In FIG. 1, the user authentication system 10 is constituted by including a service providing server 20 connected to a control center 2 of a cellular phone company via the Internet 3, and a cellular phone 30 that is a portable information terminal device used for receiving a service.

The cellular phone 30 is connected by a radio wave 4 transmitted from or received by an antenna 31 via a not-shown wireless base station to a packet communication network 1 which is owned and managed by the cellular phone company, and the control center 2 is connected to this packet communication network 1. In FIG. 1, only one cellular phone 30 is shown, but normally a large number of cellular phones 30 constitutes the system 10.

Therefore, the packet communication network 1, the control center 2, the Internet 3, and the radio wave 4 form a network 5 which connects the service providing server 20 and the cellular phone 30. Incidentally, in FIG. 1, the service providing server 20 is connected to the control center 2 via the Internet 3, but it may be connected to the control center 2 via an exclusive line. Further, in the first embodiment, the network 5 is constituted by including the packet communication network 1, but the communication network constituting the network according to the present invention is not limited to the packet communication network.

In FIG. 2, the service providing server 20 is constituted by one or plural computers and has a processing unit 21 which performs various processing regarding provision of a service, a server-side password storing unit 22 which stores passwords on the server-side, and a registration iris image data storing unit 23 which stores and registers iris images of users themselves captured in advance as registration iris image data. The server-side password storing unit 22 stores passwords for respective contracted cellular phones 30. Further, the registration iris image data storing unit 23 stores the registration iris image data for the respective contracted cellular phones 30.

The processing unit 21 has a current password receiving unit 21A which receives a current password sent from the cellular phone 30, a password comparing unit 21B which compares the current password received by the current password receiving unit 21 with a password before automatic update stored in the server-side password storing unit 22, a password updating unit 21C which automatically updates a password every time a service is provided to the user of the cellular phone 30 and generates a new password to be used when the next service is provided, and a new password transmitting unit 21D which transmits the new password generated by the automatic update by the password updating unit 21C to the cellular phone 30. In the server-side password storing unit 22, the new password generated by the automatic update by the password updating unit 21C is stored and saved by overwriting as needed.

Further, the processing unit 21 has a registration iris image data receiving unit 21E which receives registration iris image data transmitted by the cellular phone 30, a current iris image data receiving unit 21F which receives current iris image data transmitted by the cellular phone 30, and an iris image data comparing unit 21G which compares the current iris image data received by the current iris image data receiving unit 21F with the registration iris image data stored in the registration iris image data storing unit 23.

In FIG. 1, the cellular phone 30 has the antenna 31, a display portion 32 for screen display formed by a liquid crystal display screen or the like for example, and an operation portion 33 for performing various key-entry operation.

In FIG. 2, the cellular phone 30 has a processing unit 34 which performs various processing when receiving a service, a terminal-side password storing unit 35 which stores a password on the terminal-side, and an imaging unit 36 which captures an iris image of a user. The imaging unit 36 is constituted by including an imaging lens 36A (refer to FIG. 1), a not-shown imaging element, a not-shown drive circuit which operates the imaging element, and a not-shown camera control unit (CCU) which processes an obtained image signal of a subject. The imaging lens may be a single focal lens or a bifocal lens constituted by a standard lens and a close-up lens having a different focal length from each other. Further, the imaging element is, for example, a complementary metal oxide semiconductor (CMOS), a charge coupled device (CCD), or the like.

The processing unit 34 has a current password transmitting unit 34A which transmits a current password stored in the terminal-side password storing unit 35 to the service providing server 20, and a new password receiving unit 34B which receives a new password transmitted from the service providing server 20. In the terminal-side password storing unit 35, the new password generated by the automatic update by the password updating unit 21C of the service providing server 20 is stored and saved by overwriting as needed.

Further, the processing unit 34 has a registration iris image obtaining unit 34C which obtains registration iris image data using the imaging unit 36, a registration iris image data transmitting unit 34D which transmits the registration iris image data obtained by the registration iris image obtaining unit 34C to the service providing server 20, a current iris image obtaining unit 34E which obtains current iris image data using the imaging unit 36, and a current iris image data transmitting unit 34F which transmits the current iris image data obtained by the current iris image obtaining unit 34E to the service providing server 20.

The server-side password storing unit 22 and the registration iris image data storing unit 23 of the service providing server 20 are constituted by, for example, a hard disk or the like. Further, the terminal-side password storing unit 35 of the cellular phone 30 is constituted by, for example, an electrically erasable programmable read-only memory (EEPROM), or the like.

The respective units 21A to 21G constituting the processing unit 21 of the service providing server 20 are realized by a central processing unit (CPU) provided inside the computer constituting the service providing server 20 and by a program product or the like which defines operation procedures of the CPU.

The respective units 34A to 34F constituting the processing unit 34 of the cellular phone 30 are realized by a central processing unit (CPU) provided inside the cellular phone 30 and by a program product or the like which defines operation procedures of the CPU. This program product may be, for example, a program product (for example, a Java program or the like; note that the Java is a registered trademark) adapted to be mounted on a cellular phone downloaded form the service providing server 20, or may be a one mounted inside the cellular phone 30 before shipment. However, the program product is described herein as a downloaded one.

In the first embodiment described above, authentication processing of the user of the cellular phone 30 is performed using the user authentication system 10 as described below.

In FIG. 3, first, the power of the service providing server 20 is turned on to be started up (Step S1), and the power of the cellular phone 30 is turned on to be started up (Step S2).

Next, a request signal for the program product related to provision of a service and adapted to be mounted on a cellular phone is transmitted from the cellular phone 30 to the service providing server 20 (Step S3). Upon reception of the request signal (Step S4), the service providing server 20 transmits the program product to the cellular phone 30 (Step S5).

After downloading the program product from the service providing server 20, the cellular phone 30 stores this program product (Step S6). The program product is stored and saved in the cellular phone 30 when it is downloaded once, so that the download of the program product is not necessary every time a service is received.

Subsequently, the program product is executed in the cellular phone 30, and an iris image for registration is captured and other registration items are inputted (Step S7). At this time, capturing of the iris image for registration is performed by the registration iris image obtaining unit 34C using the imaging unit 36. The timing of capturing may be determined by the user himself/herself operating the operation portion 33, or may be determined automatically by the registration iris image obtaining unit 34C. Further, the input of the other registration items is performed by the user operating the operation portion 33. The other registration items include, for example, an address, name, age, occupation, e-mail address, credit card number, and the like, and an image of the entire face of the user may be captured and registered using the imaging unit 36.

Thereafter, by the registration iris image data transmitting unit 34D, the captured registration iris image data and inputted other registration items are transmitted to the service providing server 20 (Step S8). The service providing server 20 receives the registration iris image data and the other registration items by the registration iris image data receiving unit 21E (Step S9), and stores and registers the registration iris image data in the registration iris image data storing unit 23 (Step S10).

In the service providing server 20, a first time password, which is used when a service is provide for the first time after required items are registered, is determined (Step S11) and stored in the server-side password storing unit 22, and thereafter the first time password is transmitted to the cellular phone 30 (Step S12). In the cellular phone 30, after the first time password is received, it is stored in the terminal-side password storing unit 35 (Step S13).

After the required items including the registration iris image data are registered, the user of the cellular phone 30 can receive a service any time from the service providing server 20. At this time, the user of the cellular phone 30 captures a current iris image (at a time when receiving a service) by the current iris image obtaining unit 34E using the imaging unit 36 (Step S14) every time receiving a service from the service providing server 20.

The current password transmitting unit 34A then transmits a password (a first time password when it is a first time) currently stored in the terminal-side password storing unit 35, and the current iris image data transmitting unit 34F transmits the captured current iris image data to the service providing server 20 (Step S15).

In the service providing server 20, the current password is received by the current password receiving unit 21A and the current iris image data is received by the current iris image data receiving unit 21F (Step S16). Thereafter, by the password comparing unit 21B, the current password received by the current password receiving unit 21A is compared with a password currently stored in the server-side password storing unit 22. Also, by the iris image data comparing unit 21G, the current iris image data received by the current iris image data receiving unit 21F is compared with the registration iris image data stored in the registration iris image data storing unit 23 (Step S17).

After the respective comparison processing by the password comparing unit 21B and the iris image data comparing unit 21G are completed, when the passwords and the iris images coincide, transaction processing regarding provision of a service is performed between the service providing server 20 and the cellular phone 30 (Steps S18 and S19). Incidentally, when either of the passwords or the iris images do not coincide, the identity of the user is not authenticated, so that the transaction cannot be performed.

After the transaction processing is completed, in the service providing server 20, the password is updated by the password updating unit 21C by generating a new password to be used when the next service is provided (Step S20). The updated new password is then transmitted by the new password transmitting unit 21D to the cellular phone 30 and is overwritten and stored in the server-side password storing unit 22 (Step S21).

In the cellular phone 30, after receiving the new password by the new password receiving unit 34B, the new password is overwritten and stored in the terminal-side password storing unit 35 (Step S22).

Thereafter, every time a service is provided, the processing of Step S14 to Step S22 are repeated. Therefore, every time a service is provided, the password is updated. Finally, the power of the service providing server 20 and the cellular phone 30 is turned off, and the series of processing regarding the provision of a service are completed (Steps S23 and S24).

According to the first embodiment described above, the following advantages are provided. Specifically, the service providing server 20 is provided with the password updating unit 21C so that a password can be automatically updated, and the service providing server 20 is provided with the iris image data comparing unit 21G so that the iris authentication of a user of a cellular phone 30 can be performed.

Accordingly, user authentication combining the automatic update of a password and the iris authentication can be realized, so that the user authentication can be assured. Specifically, an unauthorized access to the service providing server 20 by a different person using a different cellular phone 30 can be prevented from occurring by the automatic update of a password, so that the authentication of a registered cellular phone (terminal authentication) can be performed. On the other hand, an unauthorized access to the service providing server 20 by a different person using a cellular phone 30 of a registered user can be prevented from occurring by the iris authentication, so that the authentication of a registered user (identity authentication) can be performed.

### Second Embodiment

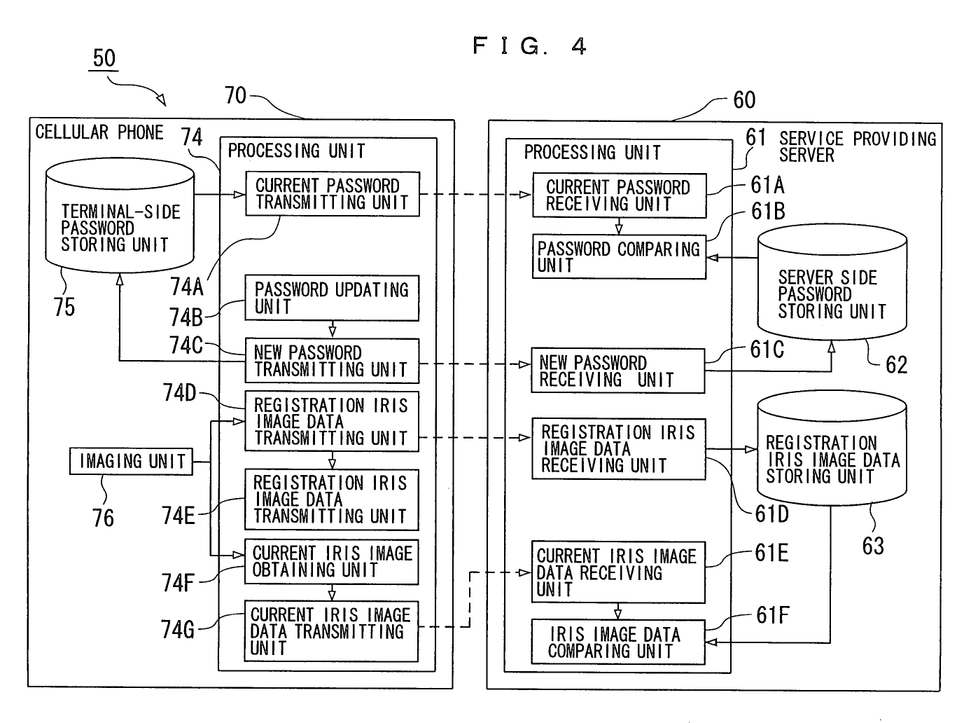

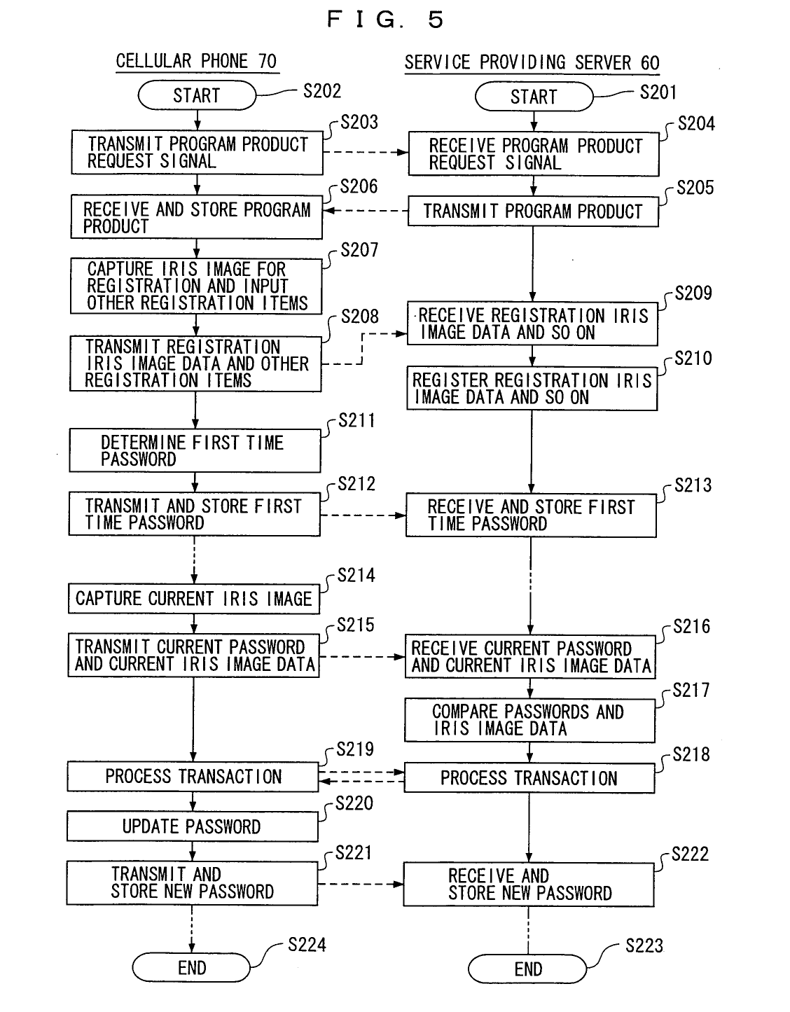

FIG. 4 shows a detailed configuration of a user authentication system 50 of a second embodiment of the present invention, and FIG. 5 shows a flowchart describing a procedure of user authentication processing which is carried out using the user authentication system 50.

Similarly to the user authentication system 10 of the first embodiment, the user authentication system 50 of the second embodiment is a system which performs user authentication when various transaction processing regarding provision of a service are carried out between a service providing server 60 and a cellular phone 70 which is a portable information terminal device. The service providing server 60 and the cellular phone 70 are connected by a network identical to the network 5 in FIG. 1 of the first embodiment.

The detailed configuration of the user authentication system 50 of the second embodiment has many similarities with the detailed configuration of the user authentication system 10 of the first embodiment. As compared to the first embodiment in which the automatic update of a password is performed by the password updating unit 21C provided on the service providing server 20 side (refer to FIG. 2), the second embodiment is different only in that the automatic update of a password is performed by a password updating unit 74B provided on the cellular phone 70 side, so that the detailed descriptions of similarities therebetween are omitted, and only the differences will be described in detail below.

In FIG. 4, the service providing server 60 is constituted by one or plural computers and has, similarly to the service providing server 20 of the first embodiment, a processing unit 61, a server-side password storing unit 62, and a registration iris image data storing unit 63. The processing unit 61 has, similarly to the processing unit 21 of the first embodiment, a current password receiving unit 61A, a password comparing unit 61B, a registration iris image data receiving unit 61D, a current iris image data receiving unit 61E, and an iris image data comparing unit 61F. Each of these units 61A, 61B, 61D, 61E, 61F, 62, and 63 has the same configuration and function as those of each of the corresponding units with the same names in the service providing server 20 of the first embodiment.

On the other hand, as compared to the processing unit 21 of the first embodiment which has the password updating unit 21C and the new password transmitting unit 21D (refer to FIG. 2), the processing unit 61 of the second embodiment is different in that, instead of the aforementioned units, it has a new password receiving unit 61C which receives a new password transmitted from the cellular phone 70.

Further, the cellular phone 70 has, similarly to the cellular phone 30 of the first embodiment, a processing unit 74, a terminal-side password storing unit 75, and an imaging unit 76. The processing unit 74 has, similarly to the processing unit 34 of the first embodiment, a current password transmitting unit 74A, a registration iris image obtaining unit 74D, a registration iris image data transmitting unit 74E, a current iris image obtaining unit 74F, and a current iris image data transmitting unit 74G. Each of these units 74A, 74D, 74E, 74F, 74G, 75, and 76 has the same configuration and function as those of each of the corresponding units with the same names in the cellular phone 30 of the first embodiment.

On the other hand, as compared to the processing unit 34 of the first embodiment which has the new password receiving unit 34B (refer to FIG. 2), the processing unit 74 of the second embodiment is different in that, instead of the aforementioned unit, it has a password updating unit 74B which automatically updates a password every time the user of the cellular phone 70 receives a service and generates a new password to be used when receiving the next service, and a new password transmitting unit 74C which transmits the new password generated by the automatic update by the password updating unit 74B to the service providing server 60.

In the second embodiment described above, authentication processing of the user of the cellular phone 70 is performed using the user authentication system 50 as described below.

In FIG. 5, first, the power of the service providing server 60 is turned on to be started up (Step S201), and the power of the cellular phone 70 is turned on to be started up (Step S202).

Next, a request signal for a program product related to provision of a service and adapted to be mounted on a cellular phone is transmitted from the cellular phone 70 to the service providing server 60 (Step S203). Upon reception of the request signal (Step S204), the service providing server 60 transmits the program product to the cellular phone 70 (Step S205).

After downloading the program product from the service providing server 60, the cellular phone 70 stores this program product (Step S206). The program product is stored and saved in the cellular phone 70 when it is downloaded once, so that the download of the program product is not necessary every time a service is received.

Subsequently, the program product is executed in the cellular phone 70, and an iris image for registration is captured and other registration items are inputted (Step S207). At this time, capturing of the iris image for registration is performed by the registration iris image obtaining unit 74D using the imaging unit 76. The timing of capturing may be determined by the user himself/herself operating the operation portion of the cellular phone 70, or may be determined automatically by the registration iris image obtaining unit 74D. Further, the input of the other registration items is performed by the user operating the operation portion of the cellular phone 70. The other registration items include, for example, an address, name, age, occupation, e-mail address, credit card number, and the like, and an image of the entire face of the user may be captured and registered using the imaging unit 76.

Thereafter, by the registration iris image data transmitting unit 74E, the captured registration iris image data and inputted other registration items are transmitted to the service providing server 60 (Step S208). The service providing server 60 receives the registration iris image data and the other registration items by the registration iris image data receiving unit 61D (Step S209), and stores and registers the registration iris image data in the registration iris image data storing unit 63 (Step S210). The procedure up to this point is the same as that of the first embodiment.

After processing for registering required items is completed, in the cellular phone 70, a first time password, which is used when receiving a service for the first time, is determined (Step S211) and stored in the terminal-side password storing unit 75, and thereafter the first time password is transmitted to the service providing server 60 (Step S212). In the service providing server 60, after the first time password is received, it is stored in the server-side password storing unit 62 (Step S213).

After the required items including the registration iris image data are registered, the user of the cellular phone 70 can receive a service any time from the service providing server 60. At this time, the user of the cellular phone 70 captures a current iris image (at a time when receiving a service) by the current iris image obtaining unit 74F using the imaging unit 76 (Step S214) every time receiving a service from the service providing server 60.

The current password transmitting unit 74A then transmits a password currently stored in the terminal-side password storing unit 75 (a first time password when it is a first time), and the current iris image data transmitting unit 74G transmits the captured current iris image data to the service providing server 60 (Step S215).

In the service providing server 60, the current password is received by the current password receiving unit 61A, and the current iris image data is received by the current iris image data receiving unit 61E (Step S216). Thereafter, by the password comparing unit 61B, the current password received by the current password receiving unit 61A is compared with a password currently stored in the server-side password storing unit 62. Also, by the iris image data comparing unit 61F, the current iris image data received by the current iris image data receiving unit 61E is compared with the registration iris image data stored in the registration iris image data storing unit 63 (Step S217).

After the respective comparison processing by the password comparing unit 61B and the iris image data comparing unit 61F are completed, when the passwords and the iris images coincide, transaction processing regarding provision of a service is performed between the service providing server 60 and the cellular phone 70 (Steps S218 and S219). Incidentally, when either of the passwords or the iris images do not coincide, the identity of the user is not authenticated, so that the transaction cannot be performed.

After the transaction processing is completed, in the cellular phone 70, the password is updated by the password updating unit 74B by generating a new password to be used when receiving the next service (Step S220). The updated new password is then transmitted by the new password transmitting unit 74C to the service providing server 60, and is overwritten and stored in the terminal-side password storing unit 75 (Step S221).

In the service providing server 60, after receiving the new password by the new password receiving unit 61C, the new password is overwritten and stored in the server-side password storing unit 62 (Step S222).

Thereafter, every time a service is provided, the processing of Step S214 to Step S222 are repeated. Therefore, every time a service is provided, the password is updated. Finally, the power of the service providing server 60 and the cellular phone 70 is turned off, and the series of processing regarding the provision of a service are completed (Steps S223 and S224).

According to the second embodiment described above, the following advantages are provided. Specifically, the cellular phone 70 is provided with the password updating unit 74B so that a password can be automatically updated, and the service providing server 60 is provided with the iris image data comparing unit 61F so that the iris authentication of a user of a cellular phone 70 can be performed. Accordingly, similarly to the first embodiment, user authentication combining the automatic update of a password and the iris authentication can be realized to thereby assure the user authentication.

### Third Embodiment

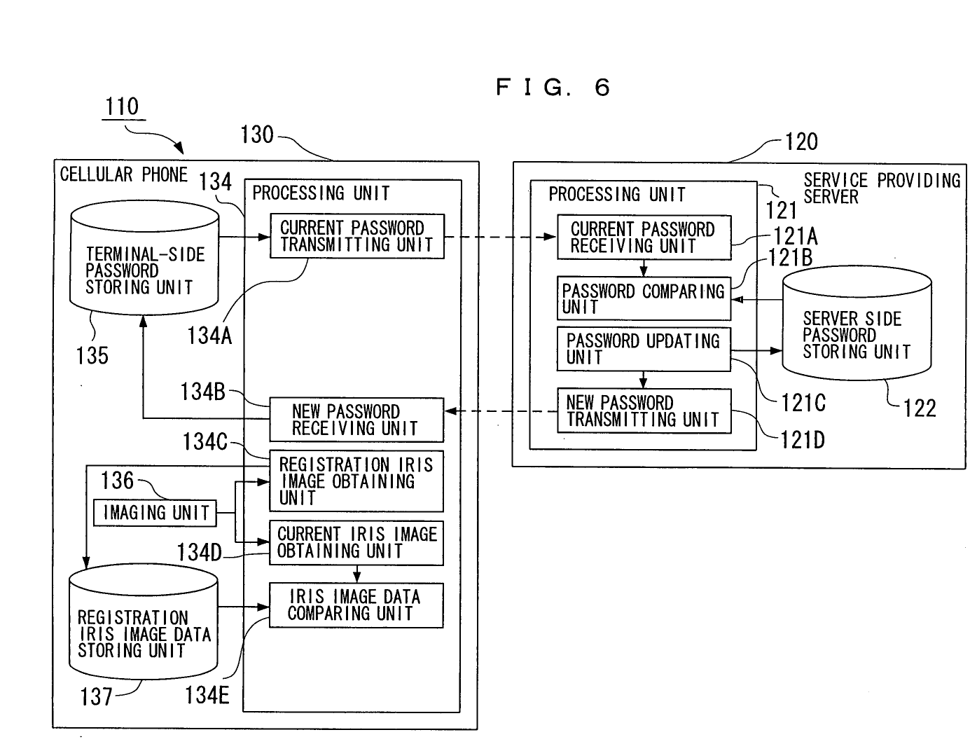

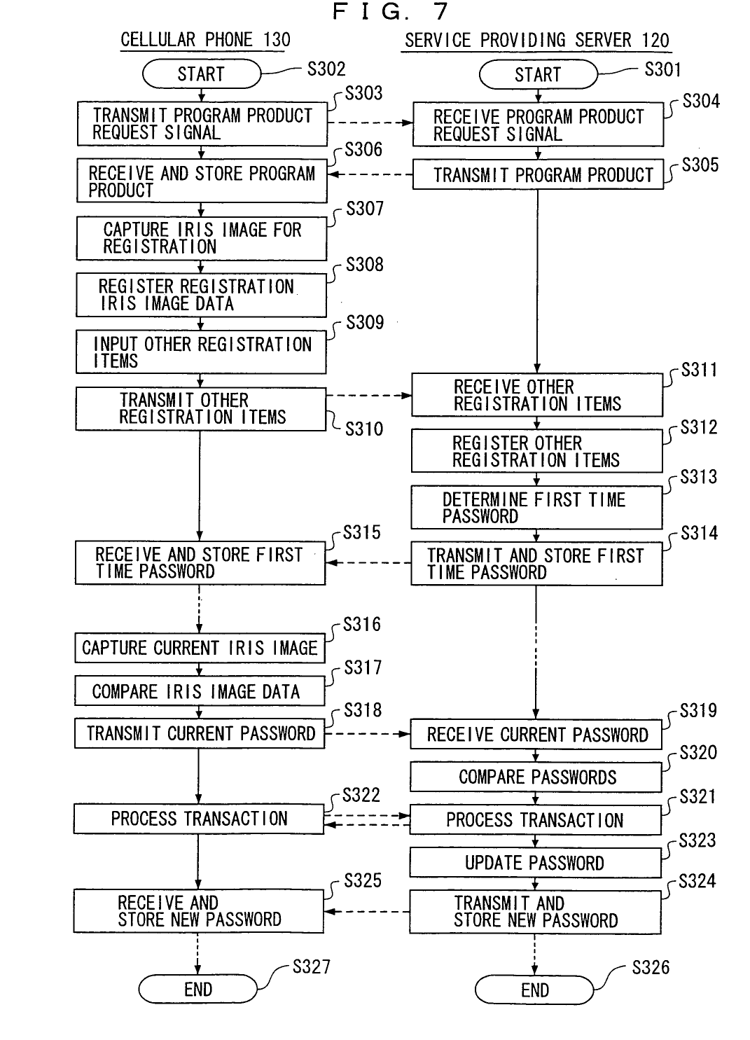

FIG. 6 shows a detailed configuration of a user authentication system 110 of a third embodiment of the present invention, and FIG. 7 shows a flowchart describing a procedure of user authentication processing which is carried out using the user authentication system 110.

Similarly to the user authentication system 10 of the first embodiment, the user authentication system 110 of the third embodiment is a system which performs user authentication when various transaction processing regarding provision of a service are carried out between a service providing server 120 and a cellular phone 130 which is a portable information terminal device. The service providing server 120 and the cellular phone 130 are connected by a network identical to the network 5 in FIG. 1 of the first embodiment.

The detailed configuration of the user authentication system 110 of the third embodiment has many similarities with the detailed configuration of the user authentication system 10 of the first embodiment. As compared to the first embodiment in which the iris authentication is performed by the iris image data comparing unit 21G provided on the service providing server 20 side (refer to FIG. 2), the third embodiment is different only in that the iris authentication is performed by an iris image data comparing unit 134E provided on the cellular phone 130 side, so that the detailed descriptions of similarities therebetween are omitted, and only the differences will be described in detail below.

In FIG. 6, the service providing server 120 is constituted by one or plural computers and has, similarly to the service providing server 20 of the first embodiment, a processing unit 121 and a server-side password storing unit 122. The processing unit 121 has, similarly to the processing unit 21 of the first embodiment, a current password receiving unit 121A, a password comparing unit 121B, a password updating unit 121C, and a new password transmitting unit 121D. Each of these units 121A, 121B, 121C, 121D, and 122 has the same configuration and function as those of each of the corresponding units with the same names in the service providing server 20 of the first embodiment.

On the other hand, as compared to the processing unit 21 of the first embodiment which has the registration iris image data receiving unit 21E, the current iris image data receiving unit 21F, and the iris image data comparing unit 21G (refer to FIG. 2), the processing unit 121 of the third embodiment is different in that it does not have units corresponding to these units.

Further, the cellular phone 130 has, similarly to the cellular phone 30 of the first embodiment, a processing unit 134, a terminal-side password storing unit 135, and an imaging unit 136. The processing unit 134 has, similarly to the processing unit 34 of the first embodiment, a current password transmitting unit 134A, a new password receiving unit 134B, a registration iris image obtaining unit 134C, and a current iris image obtaining unit 134D. Each of these units 134A, 134B, 134C, 134D, 135, and 136 has the same configuration and function as those of each of the corresponding units with the same names in the cellular phone 30 of the first embodiment.

On the other hand, the cellular phone 130 of the third embodiment is different from the cellular phone 30 of the first embodiment in that it is provided with a registration iris image data storing unit 137 which stores registration iris image data obtained by the registration iris image obtaining unit 134C. The registration iris image data stored in the registration iris image data storing unit 137 is preferred to be non-rewritable after it is once written. Further, as compared to the processing unit 34 of the first embodiment which has the registration iris image data transmitting unit 34D and the current iris image data transmitting unit 34F (refer to FIG. 2), the processing unit 134 of the third embodiment is different in that, instead of the aforementioned units, it has an iris image data comparing unit 134E which compares the registration iris image data stored in the registration iris image data storing unit 137 with current iris image data obtained by the current iris image obtaining unit 134D.

In the third embodiment described above, authentication processing of the user of the cellular phone 130 is performed using the user authentication system 110 as described below.

In FIG. 7, first, the power of the service providing server 120 is turned on to be started up (Step S301), and the power of the cellular phone 130 is turned on to be started up (Step S302).

Next, a request signal for a program product related to provision of a service adapted to be mounted on a cellular phone is transmitted from the cellular phone 130 to the service providing server 120 (Step S303). Upon reception of the request signal (Step S304), the service providing server 120 transmits the program product to the cellular phone 130 (Step S305).

After downloading the program product from the service providing server 120, the cellular phone 130 stores this program product (Step S306). The program product is stored and saved in the cellular phone 130 when it is downloaded once, so that the download of the program product is not necessary every time a service is received.

Subsequently, the program product is executed in the cellular phone 130, an iris image for registration is captured using the imaging unit 136 by the registration iris image obtaining unit 134C (Step S307), and thereafter registration iris image data of the iris image is stored in the registration iris image data storing unit 137 (Step S308). The timing of capturing may be determined by the user himself/herself operating the operation portion of the cellular phone 130, or may be determined automatically by the registration iris image obtaining unit 134C.

Furthermore, after the iris image for registration is captured and registered, other registration items are inputted (Step S309). This input is performed by the user operating the operation portion of the cellular phone 130. The other registration items include, for example, an address, name, age, occupation, e-mail address, credit card number, and the like, and an image of the entire face of the user may be captured and registered using the imaging unit 136.

Thereafter, the inputted other registration items are transmitted to the service providing server 120 (Step S310). The service providing server 120 receives the other registration items (Step S311) and stores them in a not-shown registration item storing unit and registers them (Step S312).

After processing for registering required items is completed, in the service providing server 120, a first time password, which is used when providing a service for the first time, is determined (Step S313) and stored in the server-side password storing unit 122, and thereafter the first time password is transmitted to the cellular phone 130 (Step S314). In the cellular phone 130, after the first time password is received, it is stored in the terminal-side password storing unit 135 (Step S315).

After the required items including the registration iris image data are registered, the user of the cellular phone 130 can receive a service any time from the service providing server 120. At this time, the user of the cellular phone 130 captures a current iris image (at a time when receiving a service) by the current iris image obtaining unit 134D using the imaging unit 136 (Step S316) every time receiving a service from the service providing server 120.

The iris image data comparing unit 134E then compares the current iris image data obtained by the current iris image obtaining unit 134D with the registration iris image data stored in the registration iris image data storing unit 137 (Step S317). Here, when the iris image data do not coincide, a result of performing the iris authentication of the user indicates that the user is not the identical person, so that the processing of receiving a service cannot proceed any further thereafter. On the other hand, when the iris image data coincide, the processing proceeds to the next step.

When the iris image data coincide so that the identity of the person operating the cellular phone 130 is confirmed, the current password transmitting unit 134A transmits a password currently stored in the terminal-side password storing unit 135 (a first time password when it is a first time) to the service providing server 120 (Step S318).

In the service providing server 120A, after receiving the current password by the current password receiving unit 121A (Step S319), the password comparing unit 121B compares the current password received by the current password receiving unit 121A with the password currently stored in the server-side password storing unit 122 (Step S320).

After the comparison processing by the password comparing unit 121B is completed, when the passwords coincide, transaction processing regarding provision of a service is performed between the service providing server 120 and the cellular phone 130 (Steps S321 and S322). Incidentally, when the passwords do not coincide, the cellular phone 130 is not a registered cellular phone, so that the transaction cannot be performed.

After the transaction processing is completed, in the service providing server 120, the password is updated by the password updating unit 121C by generating a new password to be used when the next service is provided (Step S323). The updated new password is then transmitted by the new password transmitting unit 121D to the cellular phone 130 and is overwritten and stored in the server-side password storing unit 122 (Step S324).

In the cellular phone 130, after receiving the new password by the new password receiving unit 134B, the new password is overwritten and stored in the terminal-side password storing unit 135 (Step S325).

Thereafter, every time a service is provided, the processing of Step S316 to Step S325 are repeated. Therefore, every time a service is provided, the password is updated. Finally, the power of the service providing server 120 and the cellular phone 130 is turned off, and the series of processing regarding the provision of a service are completed (Steps S326 and S327).

According to the third embodiment described above, the following advantages are provided. Specifically, the service providing server 120 is provided with the password updating unit 121C so that a password can be automatically updated, and also the cellular phone 130 is provided with the iris image data comparing unit 134E so that the iris authentication of a user of a cellular phone 130 can be performed. Accordingly, similarly to the first embodiment, user authentication combining the automatic update of a password and the iris authentication can be realized to thereby assure the user authentication.

### Fourth Embodiment

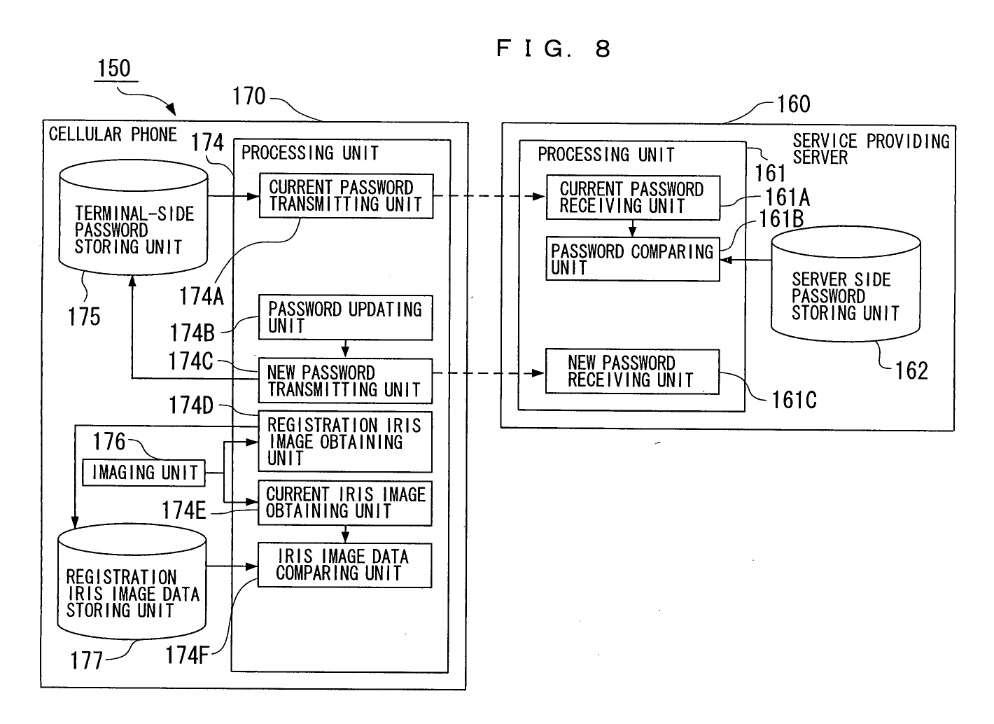

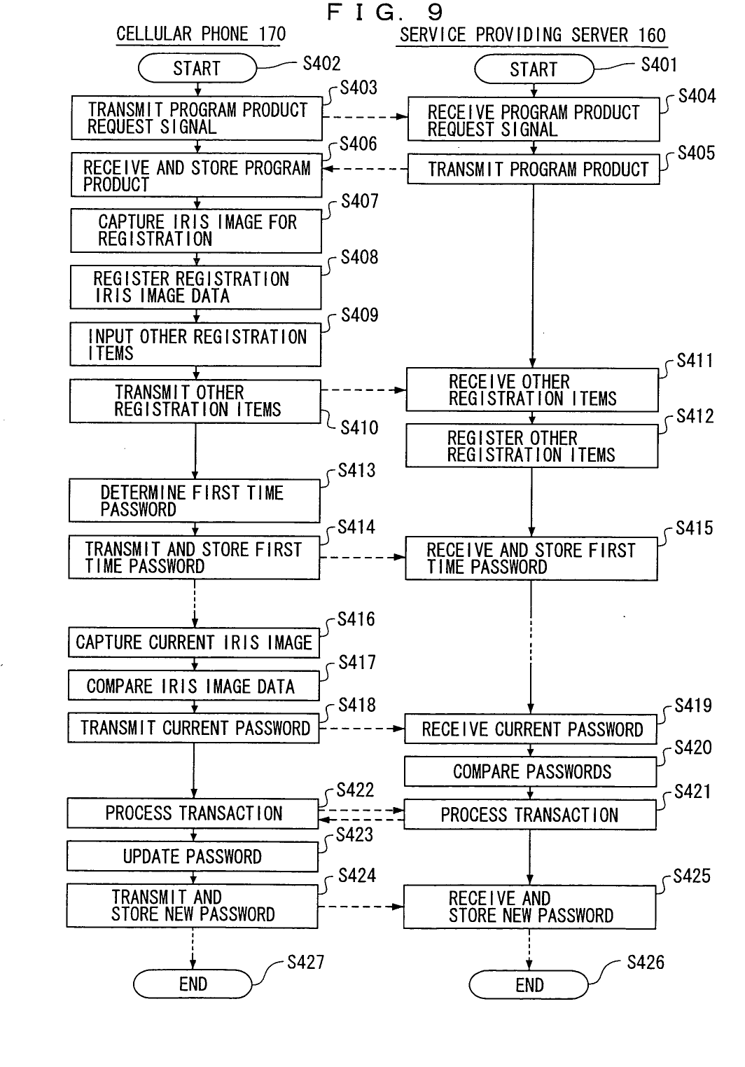

FIG. 8 shows a detailed configuration of a user authentication system 150 of a fourth embodiment of the present invention, and FIG. 9 shows a flowchart describing a procedure of user authentication processing which is carried out using the user authentication system 150.

Similarly to the user authentication system 10 of the first embodiment, the user authentication system 150 of the fourth embodiment is a system which performs user authentication when various transaction processing regarding provision of a service are carried out between a service providing server 160 and a cellular phone 170 which is a portable information terminal device. The service providing server 160 and the cellular phone 170 are connected by a network identical to the network 5 in FIG. 1 of the first embodiment.

The detailed configuration of the user authentication system 150 of the fourth embodiment has many similarities with the detailed configuration of the user authentication system 10 of the first embodiment. As compared to the first embodiment in which the automatic update of a password is performed by the password updating unit 21C provided on the service providing server 20 side and the iris authentication is performed by the iris image data comparing unit 21G provided on the service providing server 20 side (refer to FIG. 2), the fourth embodiment is different only in that the automatic update of a password is performed by a password updating unit 174B provided on the cellular phone 170 side and the iris authentication is performed by an iris image data comparing unit 174F provided on the cellular phone 170 side, so that the detailed descriptions of similarities therebetween are omitted, and only the differences will be described in detail below.

In FIG. 8, the service providing server 160 is constituted by one or plural computers and has, similarly to the service providing server 20 of the first embodiment, a processing unit 161 and a server-side password storing unit 162. The processing unit 161 has, similarly to the processing unit 21 of the first embodiment, a current password receiving unit 161A and a password comparing unit 161B. Each of these units 161A, 161B, and 162 has the same configuration and function as those of each of the corresponding units with the same names in the service providing server 20 of the first embodiment.

On the other hand, as compared to the processing unit 21 of the first embodiment which has the password updating unit 21C, the new password transmitting unit 21D, the registration iris image data receiving unit 21E, the current iris image data receiving unit 21F, and the iris image data comparing unit 21G (refer to FIG. 2), the processing unit 161 of the fourth embodiment is different in that, instead of the aforementioned units, it has a new password receiving unit 161C.

Further, the cellular phone 170 has, similarly to the cellular phone 30 of the first embodiment, a processing unit 174, a terminal-side password storing unit 175, and an imaging unit 176. The processing unit 174 has, similarly to the processing unit 34 of the first embodiment, a current password transmitting unit 174A, a registration iris image obtaining unit 174D, and a current iris image obtaining unit 174E. Each of these units 174A, 174D, 174E, 175, and 176 has the same configuration and function as those of each of the corresponding units with the same names in the cellular phone 30 of the first embodiment.

On the other hand, as compared to the cellular phone 30 of the first embodiment, the cellular phone 170 of the fourth embodiment is different in that it is provided with a registration iris image data storing unit 177 which stores registration iris image data obtained by the registration iris image obtaining unit 174D. The registration iris image data stored in the registration iris image data storing unit 177 is preferred to be non-rewritable after it is written once. Further, as compared to the processing unit 34 of the first embodiment which has the new password receiving unit 34B, the registration iris image data transmitting unit 34D, and the current iris image data transmitting unit 34F (refer to FIG. 2), the processing unit 174 of the fourth embodiment is different in that, instead of the aforementioned units, it has a password updating unit 174B which automatically updates a password every time the user of the cellular phone 170 receives a service and generates a new password to be used when receiving the next service, a new password transmitting unit 174C which transmits the new password generated by the automatic update by the password updating unit 174B to the service providing server 160, and an iris image data comparing unit 174F which compares the registration iris image data stored in the registration iris image data storing unit 177 with current iris image data obtained by the current iris image obtaining unit 174E.

In the fourth embodiment described above, authentication processing of the user of the cellular phone 170 is performed using the user authentication system 150 as described below.

In FIG. 9, first, the power of the service providing server 160 is turned on to be started up (Step S401), and the power of the cellular phone 170 is turned on to be started up (Step S402).

Next, a request signal for the program product related to provision of a service and adapted to be mounted on a cellular phone is transmitted from the cellular phone 170 to the service providing server 160 (Step S403). Upon reception of the request signal (Step S404), the service providing server 160 transmits the program product to the cellular phone 170 (Step S405).

After downloading the program product from the service providing server 160, the cellular phone 170 stores this program product (Step S406). The program product is stored and saved in the cellular phone 170 when it is downloaded once, so that the download of the program product is not necessary every time a service is received.

Subsequently, the program product is executed in the cellular phone 170, an iris image for registration is captured using the imaging unit 176 by the registration iris image obtaining unit 174D (Step S407), and thereafter registration iris image data of the iris image is stored in the registration iris image data storing unit 177 (Step S408). The timing of capturing may be determined by the user himself/herself operating the operation portion of the cellular phone 170, or may be determined automatically by the registration iris image obtaining unit 174D.

Furthermore, after the iris image for registration is captured and registered, other registration items are inputted (Step S409). This input is performed by the user operating the operation portion of the cellular phone 170. The other registration items include, for example, an address, name, age, occupation, e-mail address, credit card number, and the like, and an image of the entire face of the user may be captured and registered using the imaging unit 176.

Thereafter, the inputted other registration items are transmitted to the service providing server 160 (Step S410). The service providing server 160 receives the other registration items (Step S411) and stores and registers them in a not-shown registration item storing unit (Step S412).

After processing for registering required items is completed, in the cellular phone 170, a first time password, which is used when receiving a service for the first time, is determined (Step S413) and stored in the terminal-side password storing unit 175, and thereafter the first time password is transmitted to the service providing server 160 (Step S414). In the service providing server 160, after the first time password is received, it is stored in the server-side password storing unit 162 (Step S415).

After the required items including the registration iris image data are registered, the user of the cellular phone 170 can receive a service any time from the service providing server 160. At this time, the user of the cellular phone 170 captures a current iris image (at a time when receiving a service) by the current iris image obtaining unit 174E using the imaging unit 176 (Step S416) every time receiving a service from the service providing server 160.

The iris image data comparing unit 174F then compares the current iris image data obtained by the current iris image obtaining unit 174E with the registration iris image data stored in the registration iris image data storing unit 177 (Step S417). Here, when the iris image data do not coincide, a result of performing the iris authentication of the user indicates that the user is not the identical person, so that the processing of receiving a service cannot proceed any further. On the other hand, when the iris image data coincide, the processing proceeds to the next step.

When the iris image data coincide so that the identity of the person operating the cellular phone 170 is confirmed, the current password transmitting unit 174A transmits a password currently stored in the terminal-side password storing unit 175 (a first time password when it is a first time) to the service providing server 160 (Step S418).

In the service providing server 160, after receiving the current password by the current password receiving unit 161A (Step S419), the password comparing unit 161B compares the current password received by the current password receiving unit 161A with the password currently stored in the server-side password storing unit 162 (Step S420).

After the comparison processing by the password comparing unit 161B is completed, when the passwords coincide, transaction processing regarding provision of a service is performed between the service providing server 160 and the cellular phone 170 (Steps S421 and S422). Incidentally, when the passwords do not coincide, the cellular phone 170 is not a registered cellular phone, so that the transaction cannot be performed.

After the transaction processing is completed, in the cellular phone 170, the password is updated by the password updating unit 174B by generating a new password to be used when receiving the next service (Step S423). The updated new password is then transmitted by the new password transmitting unit 174C to the service providing server 160, and is overwritten and stored in the terminal-side password storing unit 175 (Step S424).

In the service providing server 160, after receiving the new password by the new password receiving unit 161C, the new password is overwritten and stored in the server-side password storing unit 162 (Step S425).

Thereafter, every time a service is provided, the processing of Step S416 to Step S425 are repeated. Therefore, every time a service is provided, the password is updated. Finally, the power of the service providing server 160 and the cellular phone 170 is turned off, and the series of processing regarding the provision of a service are completed (Steps S426 and S427). According to the fourth embodiment described above, the following advantages are provided. Specifically, the cellular phone 170 is provided with the password updating unit 174B so that a password can be automatically updated, and also the cellular phone 170 is provided with the iris image data comparing unit 174F so that the iris authentication of a user of a cellular phone 170 can be performed. Accordingly, similarly to the first embodiment, user authentication combining the automatic update of a password and the iris authentication can be realized to thereby assure the user authentication.

### Fifth Embodiment

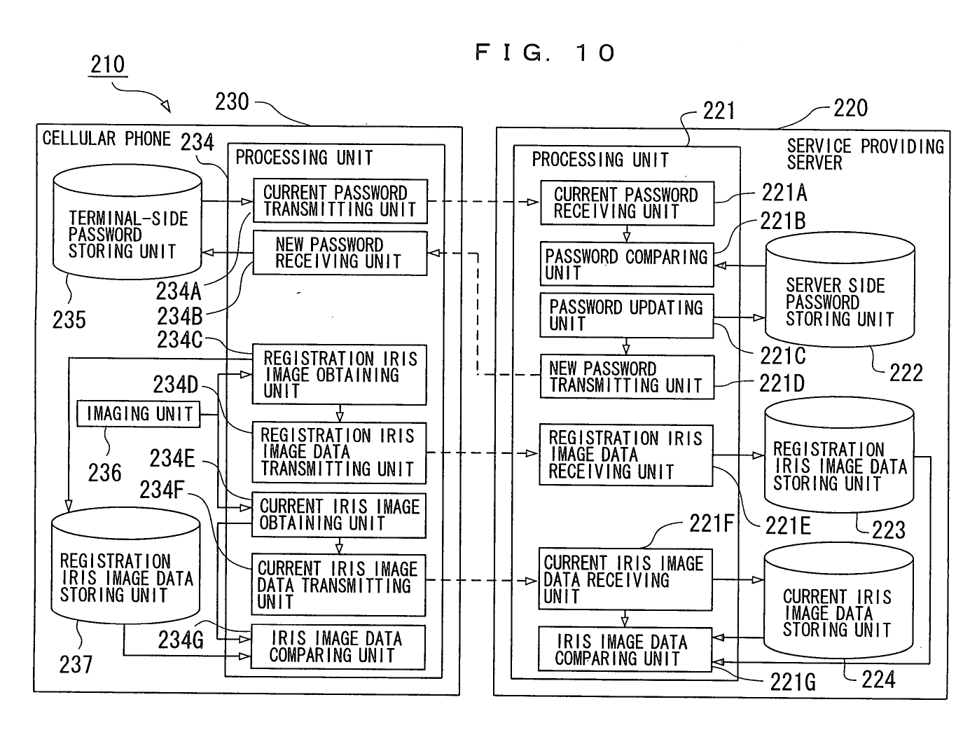

FIG. 10 shows a detailed configuration of a user authentication system 210 of a fifth embodiment of the present invention. Similarly to the user authentication system 10 of the first embodiment, the user authentication system 210 of the fifth embodiment is a system which performs user authentication when various transaction processing regarding provision of a service are carried out between a service providing server 220 and a cellular phone 230 which is a portable information terminal device. The service providing server 220 and the cellular phone 230 are connected by a network identical to the network 5 in FIG. 1 of the first embodiment.

The detailed configuration of the user authentication system 210 of the fifth embodiment has many similarities with the detailed configuration of the user authentication system 110 of the third embodiment. As compared to the third embodiment in which the iris authentication is performed only by the iris image data comparing unit 134E provided on the cellular phone 130 side (refer to FIG. 6), the fifth embodiment is different only in that the iris authentication is performed not only by an iris image data comparing unit 234G provided on the cellular phone 230 side but also by an iris image data comparing unit 221G provided on the service providing server 220 side, so that the detailed descriptions of similarities therebetween are omitted, and only the differences will be described in detail below.

In FIG. 10, the service providing server 220 is constituted by one or plural computers and has, similarly to the service providing server 120 of the third embodiment, a processing unit 221 and a server-side password storing unit 222. The processing unit 221 has, similarly to the processing unit 121 of the third embodiment, a current password receiving unit 221A, a password comparing unit 221B, a password updating unit 221C, and a new password transmitting unit 221D. Each of these units 221A, 221B, 221C, 221D, and 222 has the same configuration and function as those of each of the corresponding units with the same names in the service providing server 120 of the third embodiment.

On the other hand, the service providing server 220 of the fifth embodiment is different from the service providing server 120 of the third embodiment in that it has, in addition to the aforementioned units, a registration iris image data storing unit 223 which stores the same registration iris image data as the registration iris image data stored in a registration iris image data storing unit 237 on the cellular phone 230 side, and a current iris image data storing unit 224 which stores current iris image data received by a current iris image data receiving unit 221F at all time points (which may be a fixed period or a fixed number of times within recent days). Further, the processing unit 221 of the fifth embodiment is different from the processing unit 121 of the third embodiment in that it has a registration iris image data receiving unit 221E which receives registration iris image data transmitted from the cellular phone 230, a current iris image data receiving unit 221F which receives current iris image data transmitted from the cellular phone 230, and an iris image data comparing unit 221G. The iris image data comparing unit 221G is for comparing the registration iris image data stored in the registration iris image data storing unit 223 with one of the current iris image data of respective time points stored in the current iris image data storing unit 224 or the current iris image data received by the current iris image data receiving unit 221F.

Further, the cellular phone 230 has, similarly to the cellular phone 130 of the third embodiment, a processing unit 234, a terminal-side password storing unit 235, an imaging unit 236, and a registration iris image data storing unit 237. The processing unit 234 has, similarly to the processing unit 134 of the third embodiment, a current password transmitting unit 234A, a new password receiving unit 234B, a registration iris image obtaining unit 234C, a current iris image obtaining unit 234E, and an iris image data comparing unit 234G. Each of these units 234A, 234B, 234C, 234E, 234G, 235, 236 and 237 has the same configuration and function as those of each of the corresponding units with the same names in the cellular phone 130 of the third embodiment.

On the other hand, the cellular phone 230 of the fifth embodiment is different from the cellular phone 130 of the third embodiment in that it is provided with a registration iris image data transmitting unit 234D which transmits registration iris image data obtained by the registration iris image obtaining unit 234C to the service providing server 220, and a current iris image data transmitting unit 234F which transmits current iris image data obtained by the current iris image obtaining unit 234E to the service providing server 220.

In the fifth embodiment described above, authentication processing of the user of the cellular phone 230 is performed using the user authentication system 210 as described below.

A flow of user authentication processing in the user authentication system 210 is substantially the same as that of the user authentication system 110 of the third embodiment (refer to FIG. 7), which is different only in that iris authentication processing on the service providing server 220 side is added as needed.

Specifically, the registration iris image data obtained by the registration iris image obtaining unit 234C on the cellular phone 230 side is not only stored in the registration iris image data storing unit 237 on the cellular phone 230 side but also transmitted to the service providing server 220 by the registration iris image data transmitting unit 234D. The service providing server 220 then stores the registration iris image data received by the registration iris image data receiving unit 221E in the registration iris image data storing unit 223.

Further, the current iris image data obtained by the current iris image obtaining unit 234E on the cellular phone 230 side is not only used for iris authentication processing by the iris image data comparing unit 234G on the cellular phone 230 side but also transmitted to the service providing server 220 by the current iris image data transmitting unit 234F. The service providing server 220 then stores the current iris image data of each time point received by the current iris image data receiving unit 220F in the current iris image data storing unit 224 every time it is received. Incidentally, an amount of the current iris image data to be stored and saved in the current iris image data storing unit 224 may be limited time-wise or capacity-wise such as several recent months or a certain number of times within recent days.

The registration iris image data stored in the registration iris image data storing unit 223 may be compared as needed, such as when a need of ex-post reconfirmation by iris authentication arises, with one of the current iris image data stored in the current iris image data storing unit 224 by the iris image data comparing unit 221G on the service providing server 220 side. Alternatively, these data may be compared by human eyes (for example, by a service provider who operates the service providing server 220, or the like) without depending on the iris image data comparing unit 221G.

Further, not as ex-post reconfirmation but when every time a service is provided, the registration iris image data stored in the registration iris image data storing unit 223 may be compared with the current iris image data received by the current iris image data receiving unit 221F by the iris image data comparing unit 221G on the service providing server 220 side, along with the iris authentication processing by the iris image data comparing unit 234G on the cellular phone 230 side.

According to the fifth embodiment described above, the same advantages as those of the third embodiment can be achieved, and in addition, the iris authentication processing can be performed on the service providing server 220 side, which enables ex-post confirmation and, moreover, further assurance of prevention of unauthorized activities from occurring by duplicating the iris authentication processing.

### Sixth Embodiment

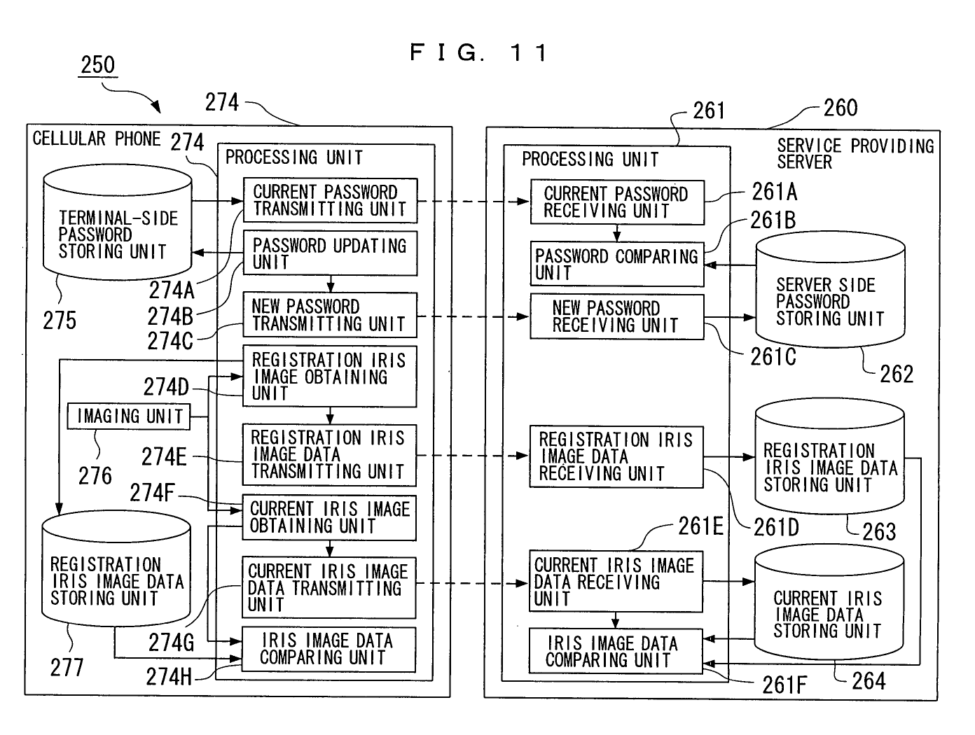

FIG. 11 shows a detailed configuration of a user authentication system 250 of a sixth embodiment of the present invention. Similarly to the user authentication system 10 of the first embodiment, the user authentication system 250 of the sixth embodiment is a system which performs user authentication when various transaction processing regarding provision of a service are carried out between a service providing server 260 and a cellular phone 270 which is a portable information terminal device. The service providing server 260 and the cellular phone 270 are connected by a network identical to the network 5 in FIG. 1 of the first embodiment.

The detailed configuration of the user authentication system 250 of the sixth embodiment has many similarities with the detailed configuration of the user authentication system 150 of the fourth embodiment. As compared to the fourth embodiment in which the iris authentication is performed only by the iris image data comparing unit 174F provided on the cellular phone 170 side (refer to FIG. 8), the sixth embodiment is different only in that the iris authentication can be performed not only by an iris image data comparing unit 274H provided on the cellular phone 270 side but also by an iris image data comparing unit 261F provided on the service providing server 260 side, so that the detailed descriptions of similarities therebetween are omitted, and only the differences will be described in detail below.

In FIG. 11, the service providing server 260 is constituted by one or plural computers and has, similarly to the service providing server 160 of the fourth embodiment, a processing unit 261 and a server-side password storing unit 262. The processing unit 261 has, similarly to the processing unit 161 of the fourth embodiment, a current password receiving unit 261A, a password comparing unit 261B, and a new password receiving unit 261C. Each of these units 261A, 261B, 261C, and 262 has the same configuration and function as those of each of the corresponding units with the same names in the service providing server 160 of the fourth embodiment.

On the other hand, the service providing server 260 of the sixth embodiment is different from the service providing server 160 of the fourth embodiment in that it has, in addition to the aforementioned units, a registration iris image data storing unit 263 which stores the same registration iris image data as the registration image data stored in a registration iris image data storing unit 277 on the cellular phone 270 side, and a current iris image data storing unit 264 which stores current iris image data received by a current iris image data receiving unit 261E at all time points (which may be a fixed period or a fixed number of times within recent days). Further, the processing unit 261 of the sixth embodiment is different from the processing unit 161 of the fourth embodiment in that it has a registration iris image data receiving unit 261D which receives registration iris image data transmitted from the cellular phone 270, a current iris image data receiving unit 261E which receives current iris image data transmitted from the cellular phone 270, and an iris image data comparing unit 261F. The iris image data comparing unit 261F is for comparing the registration iris image data stored in the registration iris image data storing unit 263 with one of the current iris image data of respective time points stored in the current iris image data storing unit 264 or the current iris image data received by the current iris image data receiving unit 261E.

Further, the cellular phone 270 has, similarly to the cellular phone 170 of the fourth embodiment, a processing unit 274, a terminal-side password storing unit 275, an imaging unit 276, and the registration iris image data storing unit 277. The processing unit 274 has, similarly to the processing unit 174 of the fourth embodiment, a current password transmitting unit 274A, a password updating unit 274B, a new password transmitting unit 274C, a registration iris image obtaining unit 274D, a current iris image obtaining unit 274F, and an iris image data comparing unit 274H. Each of these units 274A, 274B, 274C, 274D, 274F, 274H, 275, 276 and 277 has the same configuration and function as those of each of the corresponding units with the same names in the cellular phone 170 of the fourth embodiment.

On the other hand, the cellular phone 270 of the sixth embodiment is different from the cellular phone 170 of the fourth embodiment in that it is provided with a registration iris image data transmitting unit 274E which transmits registration iris image data obtained by the registration iris image obtaining unit 274D to the service providing server 260, and a current iris image data transmitting unit 274G which transmits current iris image data obtained by the current iris image obtaining unit 274F to the service providing server 260.

In the sixth embodiment described above, authentication processing of the user of the cellular phone 270 is performed using the user authentication system 250 as described below.

A flow of user authentication processing in the user authentication system 250 is substantially the same as that of the user authentication system 150 of the fourth embodiment (refer to FIG. 9), which is different only in that iris authentication processing on the service providing server 260 side is added as needed.

Specifically, the registration iris image data obtained by the registration iris image obtaining unit 274D on the cellular phone 270 side is not only stored in the registration iris image data storing unit 277 on the cellular phone 270 side but also transmitted to the service providing server 260 by the registration iris image data transmitting unit 274E. The service providing server 260 then stores the registration iris image data received by the registration iris image data receiving unit 261D in the registration iris image data storing unit 263.

Further, the current iris image data obtained by the current iris image obtaining unit 274F on the cellular phone 270 side is not only used for iris authentication processing by the iris image data comparing unit 274H on the cellular phone 270 side, but also transmitted to the service providing server 260 by the current iris image data transmitting unit 274G. The service providing server 260 stores the current iris image data of each time point received by the current iris image data receiving unit 261E in the current iris image data storing unit 264 every time it is received. Incidentally, an amount of the current iris image data to be stored and saved in the current iris image data storing unit 264 may be limited time-wise or capacity-wise such as several recent months or a certain number of times within recent days. The registration iris image data stored in the registration iris image data storing unit 263 may be compared as needed, such as when a need of ex-post reconfirmation by iris authentication arises, with one of the current iris image data stored in the current iris image data storing unit 264 by the iris image data comparing unit 261F on the service providing server 260 side. Alternatively, these data may be compared by human eyes (for example, by a service provider who operates the service providing server 260, or the like) without depending on the iris image data comparing unit 261F.

Further, not as ex-post reconfirmation but when every time a service is provided, the registration iris image data stored in the registration iris image data storing unit 263 may be compared with the current iris image data received by the current iris image data receiving unit 261E by the iris image data comparing unit 261F on the service providing server 260 side, along with the iris authentication processing by the iris image data comparing unit 274H on the cellular phone 270 side.

According to the sixth embodiment described above, the same advantages as those of the fourth embodiment can be achieved, and in addition, the iris authentication processing can be performed on the service providing server 260 side, which enables ex-post confirmation and, moreover, further assurance of prevention of unauthorized activities from occurring by duplicating the iris authentication processing.

### Seventh Embodiment

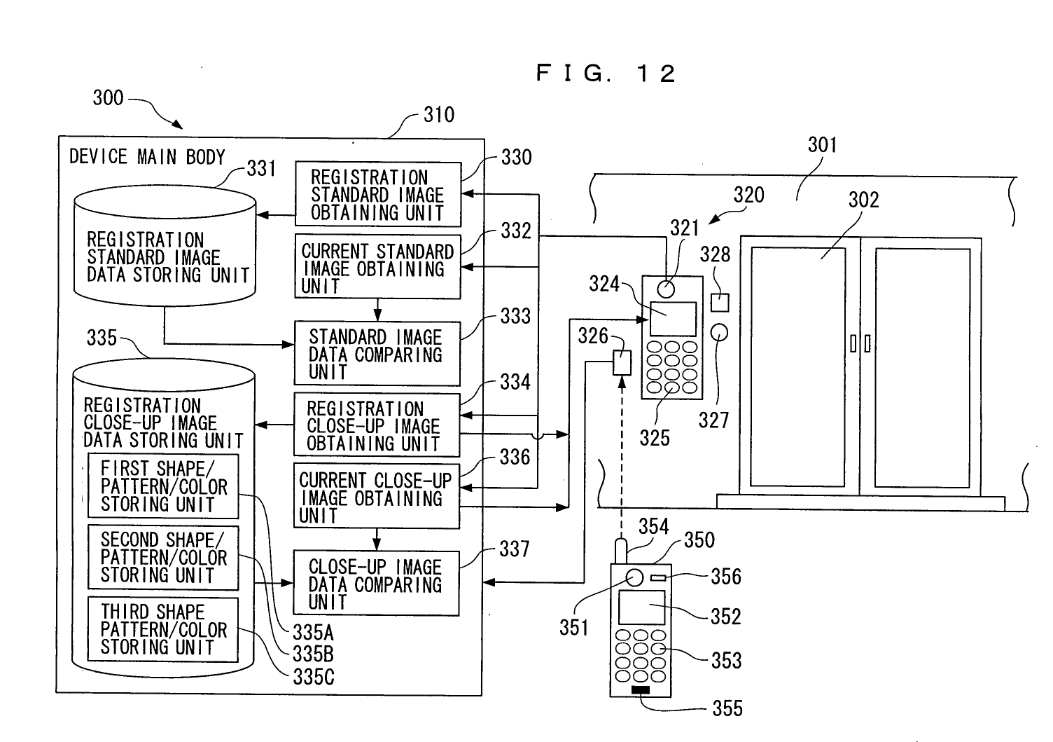

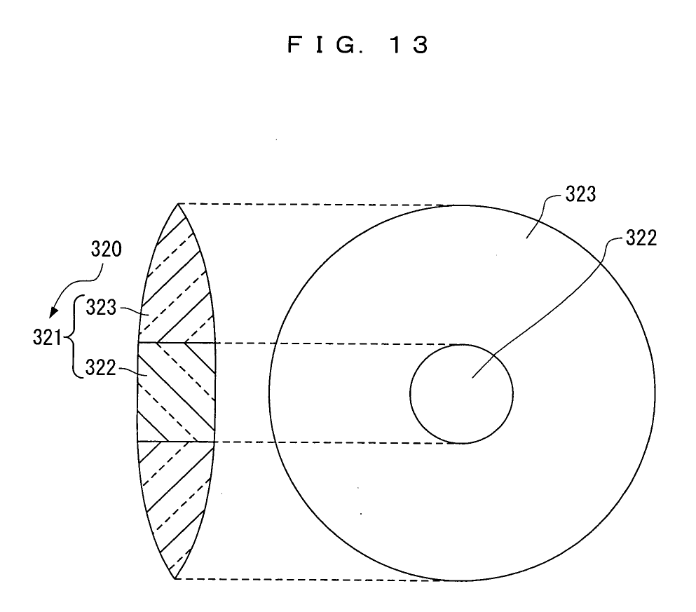

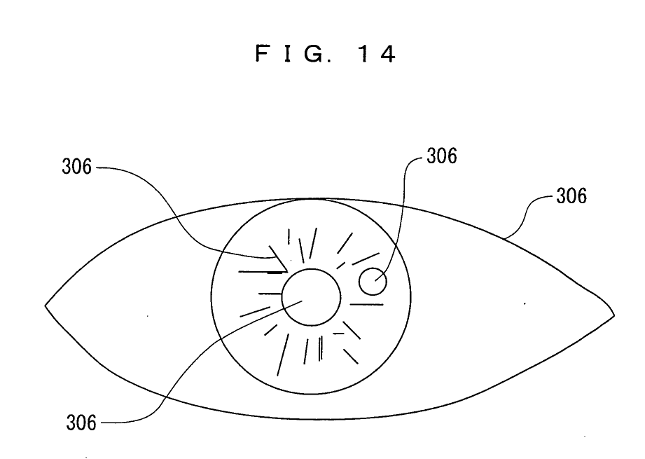

FIG. 12 shows an overall configuration of a subject identification system 300 of a seventh embodiment of the present invention. Further, FIG. 13 shows an enlarged view of a substantial part of the subject identification system 300, and FIG. 14 shows an iris 306 of a human eye 304 which is a subject to be a target of identification.

In FIG. 12, the subject identification system 300 is constituted by including a device main body 310 provided in the vicinity of an entrance/exit 302 of a building 301 and a cellular phone 350 which is a portable information terminal device capable of remotely controlling the device main body 310.

The device main body 310 is constituted by one or plural computers and has an imaging unit 320 which captures a facial image of a person that is a standard image of a subject and an iris image of the person that is a close-up image of the subject, a display portion 324 for screen display which is constituted by a liquid crystal display screen or the like for example, an operation portion 325 for performing various key-entry operation, a receiving unit 326 which receives radio signals from the cellular phone 350, a microphone 327, and a speaker 328.

In FIG. 13, the imaging unit 320 is constituted by including an imaging lens 321, a not-shown imaging element, a not-shown drive circuit which drives the imaging element, and a not-shown camera control unit (CCU) which processes an obtained image signal of a subject. The imaging lens 321 is a bifocal lens constituted by a standard lens 322 and a close-up lens 323 having a different focal length from each other. The focal length of the close-up lens 323 is shorter than the focal length of the standard lens 322. On a right portion of FIG. 13, a state of the imaging lens 321 seen from front is shown, and on a left portion of FIG. 13, a cross-section of the imaging lens 321 is shown. In the seventh embodiment, as shown in FIG. 13, the standard lens 322 is arranged inside and has a circular shape when seen from front, and the close-up lens 323 is arranged outside and has a ring shape when seen from front. However, the lenses are not limited to these arrangement and shapes. Basically, they may be any lenses as long as they are provided in a combination of a standard lens and a close-up lens each having a different focal length. Further, the imaging element is, for example, a complementary metal oxide semiconductor (CMOS), a charge coupled device (CCD), or the like. Furthermore, as a component of the imaging unit 320, an optical shutter for switching the standard lens 322 and the close-up lens 323 and formed using a liquid crystal or the like for example may be provided between the imaging lens 321 and the imaging element. As an example of the imaging unit 320 as described above, one described in Information Terminal Device (Japanese Patent Application No. 2000-348800), which is already proposed by the inventor of the present invention, may be suitably used.

In FIG. 12, the device main body 310 has a registration standard image obtaining unit 330 which captures a facial image to be registered in advance using the standard lens 322 and generates registration standard image data (registration facial image data), a registration standard image data storing unit 331 which stores and registers the facial image for registration obtained by the registration standard image obtaining unit 330 as registration standard image data, a current standard image obtaining unit 332 which captures a current facial image (at a time when performing identification) using the standard lens 322 and generates current standard image data (current facial image data), and a standard image data comparing unit 333 which compares the current standard image data obtained by the current standard image obtaining unit 332 with the registration standard image data stored in the registration standard image data storing unit 331.

Further, the device main body 310 has a registration close-up image obtaining unit 334 which captures an iris image to be registered in advance using the close-up lens 323 to generate registration close-up image data (registration iris image data), a registration close-up image data storing unit 335 which stores and registers the iris image for registration obtained by the registration close-up image obtaining unit 334 as registration close-up image data, a current close-up image obtaining unit 336 which captures a current iris image (at a time when performing identification) using the close-up lens 323 to generate current close-up image data (current iris image data), and a close-up image data comparing unit 337 which compares the current close-up image data obtained by the current close-up image obtaining unit 336 with the registration close-up image data stored in the registration close-up image data storing unit 335.

The registration close-up image data storing unit 335 is constituted by including a first shape/pattern/color storing unit 335A, a second shape/pattern/color storing unit 335B, and a third shape/pattern/color storing unit 335C. Each of these storing units 335A, 335B, and 335C stores different type of registration close-up image data. Incidentally, although three types of registration close-up image data are prepared in the seventh embodiment, they are not limited to three types, which may be one type or plural types other than three types.

Further, in the registration standard image data storing unit 331 and the registration close-up image data storing unit 335, data of a facial image and an iris image (in a case of the iris image, three types per person for example) of one person or of plural persons are prepared according to the number of persons to be permitted to enter the building 301 through the entrance/exit 302.

The cellular phone 350 has an imaging unit 351 which captures a facial image of a person, which is a standard image of a subject, and an iris image of the person, which is a close-up image of the subject, a display portion 352 for screen display which is constituted by a liquid crystal display screen or the like for example, an operation portion 353 for performing various key-entry operation, an antenna 354 which transmits a radio signal to the device main body 310, a microphone 355, and a speaker 356. The imaging unit 351 and the display portion 352 have the same configurations as those of the imaging unit 320 and the display portion 324 of the device main body 310.

Further, the cellular phone 350 has a current standard image obtaining unit having the same function as that of the current standard image obtaining unit 332 of the device main body 310 and a current close-up image obtaining unit having the same function as that of the current close-up image obtaining unit 336 of the device main body 310. Incidentally, the cellular phone 350 may be provided with units which have the same function as that of the registration standard image obtaining unit 330 and the same function as that of the registration close-up image obtaining unit 334 of the device main body 310, respectively.

The display portion 324 of the device main body 310 and the display portion 352 of the cellular phone 350 keep a constant brightness each time capturing a current iris image, and the brightness at each time capturing a current iris image is the same as the brightness at a time capturing the iris image for registration which is stored in the registration close-up image data storing unit 335.

The registration standard image data storing unit 331 and the registration close-up image data storing unit 335 of the device main body 310 are constituted by a hard disk or the like for example.

The respective units 330, 332, 333, 334, 336, and 337 provided in the device main body 310 are realized by a central processing unit (CPU) provided inside a computer constituting the device main body 310, and by a program product or the like which defines operation procedures of the CPU. Further, the current standard image obtaining unit and the current close-up image obtaining unit provided in the cellular phone 350 are realized by a central processing unit (CPU) provided inside the cellular phone 350 and by a program product or the like which defines operation procedures of the CPU.

In the seventh embodiment described above, the identification processing of a person attempting to enter the building 301 (hereinafter, referred to as a person desiring entrance) through the entrance/exit 302 is performed using the subject identification system 300 as described below.

First, a person to be permitted to enter the building 301 through the entrance/exit 302 registers his/her facial image and iris image in advance to the subject identification system 300. After the facial image is captured using the standard lens 322 of the imaging unit 320 by the registration standard image obtaining unit 330 of the device main body 310, the registration of the facial image is performed by storing and saving the obtained facial image data in the registration standard image data storing unit 331. The timing of capturing the facial image may be determined by the person himself/herself operating the operation portion 325, or may be determined automatically by the registration standard image obtaining unit 330.

After an iris image is captured by the registration close-up image obtaining unit 334 of the device main body 310 using the close-up lens 323 of the imaging unit 320, the registration of the iris image is performed by storing and saving the obtained iris image data in the registration close-up image data storing unit 335. The timing of capturing the iris image may be determined by the person himself/herself operating the operation portion 325, or may be determined automatically by the registration close-up image obtaining unit 334. Further, when the standard lens 322 and the close-up lens 323 are switched by the optical shutter to be used, the timing of switching them may be determined by a person himself/herself operating the operating portion 325, or may be automatically controlled by a program product.

Further, when the registration close-up image data is obtained by the registration close-up image obtaining unit 334, in other words, when the iris image for registration is captured, the display portion 324 is used as a light source, and the capturing is performed three times with a shape, pattern, color, or combination thereof of a display drawn on the screen of the display portion 324 being changed. For example, one of three different types of shapes such as ◯, Δ, □ or the like is displayed on the display portion 324 at each time of three capturing.

Then, when there is a person fixing his/her eye 304 to the imaging unit 320, an optical source noise 307 corresponding to the shape such as ◯, Δ, □ or the like of the display drawn on the screen of the display portion 324 is included in the iris 306 located around a pupil 305 of his/her eye 304 as shown in FIG. 14. Therefore, a shape, pattern, color, or combination thereof of the optical source noise 307 becomes one of three different types according to the change in a shape, pattern, color, or combination thereof of the display drawn on the screen of the display portion 324.

Thus, the iris images including the optical source noises 307 of three different types per person are obtained and stored in the respective storing units 335A, 335B, and 335C constituting the registration close-up image data storing unit 335.

Incidentally, obtaining of the registration standard image data and the three types of the registration close-up image data described above, in other words, capturing of the facial image and the iris image for registration may be performed by the cellular phone 350. In such a case, when the iris image is captured, iris images including three types of optical source noises are captured using the imaging unit 351 with a shape, pattern, color, or combination thereof of a display drawn on the screen of the display portion 352 of the cellular phone 350 being changed. The obtained registration standard image data and respective registration close-up image data may be transmitted from the antenna 354 to the receiving unit 326 of the device main body 310.

Next, when there is a person desiring entrance, identification processing for determining whether or not to permit the entrance of the person desiring entrance will be performed as follows.

The person desiring entrance first shows his/her entire face to the imaging unit 320 so that the entire face is reflected thereon. At this time, the display portion 324 may display in real time the image of the person desiring entrance, which is reflected on the imaging unit 320. The facial image is then captured using the standard lens 322 of the imaging unit 320 by the current standard image obtaining unit 332 of the device main body 310. The timing of capturing the facial image may be determined by the person himself/herself operating the operation portion 325, or may be determined automatically by the current standard image obtaining unit 332.

Further, in a case of a person desiring entrance using the cellular phone 350, the person first shows his/her entire face to the imaging unit 351 of the cellular phone 350 so that the entire face is reflected thereon. At this time, the display portion 352 may display in real time the image of the person desiring entrance, which is reflected on the imaging unit 351. The facial image is then captured using the standard lens of the imaging unit 351 by the current standard image obtaining unit of the cellular phone 350. The timing of capturing the facial image may be determined by the person himself/herself operating the operation portion 353, or may be determined automatically by the current standard image obtaining unit. The obtained current standard image data may be transmitted from the antenna 354 to the receiving unit 326 of the device main body 310.

Thereafter, the standard image data comparing unit 333 compares the current standard image data obtained by the current standard image obtaining unit 332 or the current standard image data transmitted from the cellular phone 350 with the registration standard image data stored in the registration standard image data storing unit 331. When these standard image data coincide, the processing proceeds to the next step. On the other hand, when they do not coincide, the person desiring entrance is identified to be a different person from the identical person to be permitted the entrance, so that the person cannot enter the building 301 through the entrance/exit 302.

Incidentally, with the automatic identification by the standard image data comparing unit 333 being omitted, only the automatic identification by the close-up image data comparing unit 337 may be performed normally, and then ex-post comparison of the stored current standard image data of each time point with the registration standard image data stored in the registration standard image data storing unit 331 may be performed as needed by human eyes.

Next, the person desiring entrance shows the iris 306 of his/her eye 304 to the imaging unit 320 so that the iris 306 is reflected thereon. At this time, the display portion 324 may display in real time the image of the person desiring entrance, which is reflected on the imaging unit 320. An iris image is then captured using the close-up lens 323 of the imaging unit 320 by the current close-up image obtaining unit 336 of the device main body 310. This iris image includes an optical source noise 307 having a shape, pattern, or the like corresponding to the shape, pattern, or the like (for example, a shape ◯ or the like) of the current display drawn on the screen of the display portion 324. The shape, pattern, or the like of the display drawn on the screen of the display portion 324 is updated regularly or irregularly by the current close-up image obtaining unit 336. The timing of capturing the iris image may be determined by the person himself/herself operating the operation portion 325, or may be determined automatically by the current close-up image obtaining unit 336. Further, when the standard lens 322 and the close-up lens 323 are switched by the optical shutter to be used, the timing of switching them may be determined by a person himself/herself operating the operating portion 325, or may be automatically controlled by a program product.

Further, in a case of a person desiring entrance using the cellular phone 350, the person shows the iris 306 of his/her eye 304 to the imaging unit 351 of the cellular phone 350 so that the iris is reflected thereon. At this time, the display portion 352 may display in real time the image of the person desiring entrance, which is reflected on the imaging unit 351. An iris image is then captured using the close-up lens of the imaging unit 351 by the current close-up image obtaining unit of the cellular phone 350. This iris image includes an optical source noise 307 having a shape, pattern, or the like corresponding to the shape, pattern, or the like (for example, a shape ◯ or the like) of the current display drawn on the screen of the display portion 352. The shape, pattern, or the like of the display drawn on the screen of the display portion 352 is updated regularly or irregularly by the current close-up image obtaining unit of the cellular phone 350. The timing of capturing the iris image may be determined by the person himself/herself operating the operation portion 353, or may be determined automatically by the current close-up image obtaining unit of the cellular phone 350. Further, when the standard lens and the close-up lens are switched by the optical shutter to be used, the timing of switching them may be determined by a person himself/herself operating the operating portion 353, or may be automatically controlled by a program product. The obtained current close-up image data and information of the shape, pattern, or the like (hereinafter, referred to as light source type information) of the display drawn on the screen of the display portion 352 when the iris image is captured may be transmitted from the antenna 354 to the receiving unit 326 of the device main body 310.

Thereafter, the close-up image data comparing unit 337 compares the current close-up image data obtained by the current close-up image obtaining unit 336 or the current close-up image data transmitted from the cellular phone 350 with the registration close-up image data stored in the registration close-up image data storing unit 335. At this time, the registration close-up image data used for the comparison processing is selected from the respective storing units 335A, 335B, and 335C according to the shape, pattern, or the like of the display drawn on the screen of the display portion 324 by the current close-up image obtaining unit 336 or based on the light source information transmitted from the cellular phone 350.

When these close-up image data coincide as a result of the comparison processing by the close-up image data comparing unit 337, the person desiring entrance is identified to be the identical person to be permitted the entrance and thus permitted the entrance. On the other hand, when the close-up image data do not coincide, the person desiring entrance is identified to be a person different from the identical person to be permitted the entrance, so that the person cannot enter the building 301 through the entrance/exit 302.

According to the seventh embodiment described above, the following advantages are provided. Specifically, the standard image (here, a facial image of a person) of a subject is captured using the standard lens 322, and the close-up image (here, an iris image of a person) of the subject is captured using the close-up lens 323, so that strict identification by double checking can be performed.

Further, the identification is performed by capturing an iris image which includes an optical source noise, so that an unauthorized activity of impersonation using a picture, motion picture, or the like can be prevented from occurring.

Furthermore, a shape, pattern, color, or combination thereof of displays drawn on the screens of the display portions 324 and 352 which are the light sources are updated to be changed, so that an unauthorized activity of impersonation using a picture, motion picture, or the like can be more securely prevented from occurring.

Further, the displays drawn on the screens of the display portions 324 and 352 are changed, so that a change in a shape, pattern, color, or combination thereof of the light sources can be easily realized, and a variation of the change can be freely set.

Further, the display portion 324 of the device main body 310 and the display portion 352 of the cellular phone 350 keep a constant brightness each time capturing a current iris image, and the brightness at each time capturing the current iris image is the same as the brightness at a time capturing an iris image for registration which is stored in the registration close-up image data storing unit 335, so that the iris image can be captured with the size of the pupil 305 being kept constant, thereby improving identification accuracy.

### Eighth Embodiment

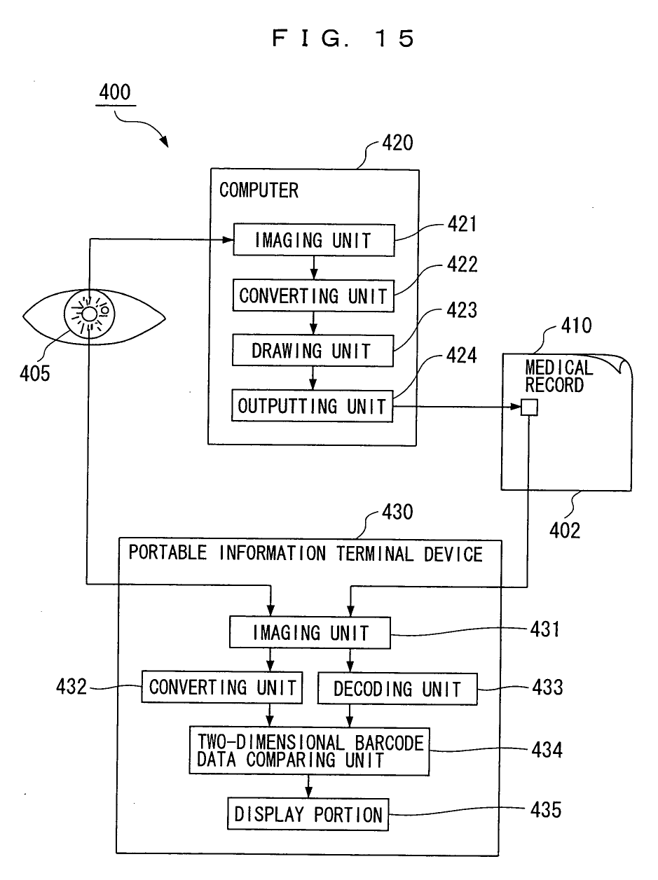

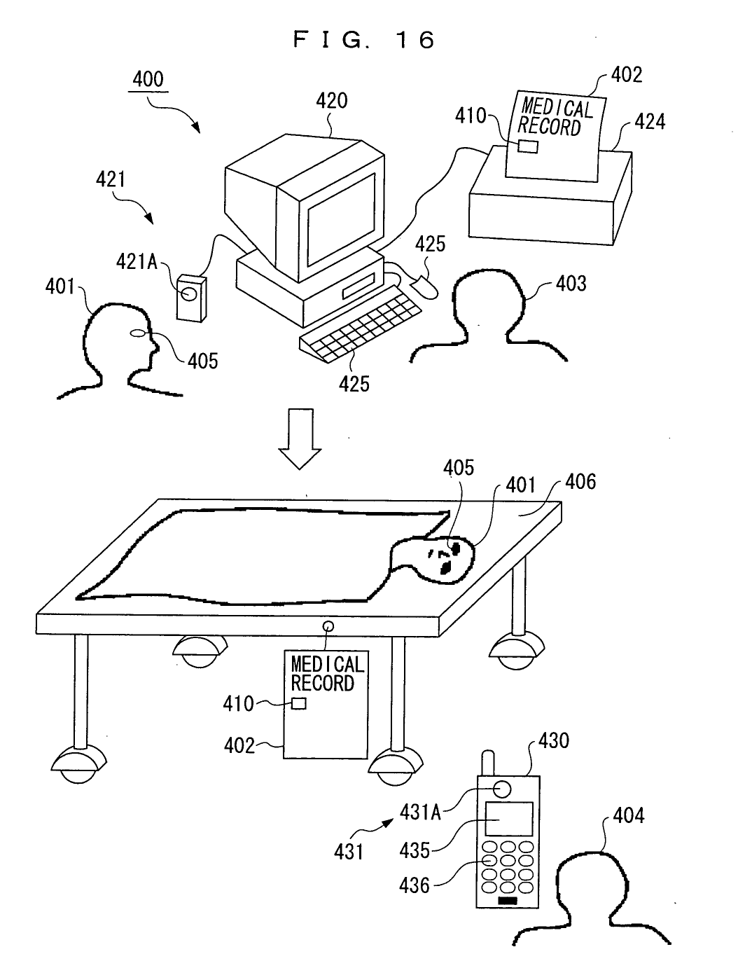

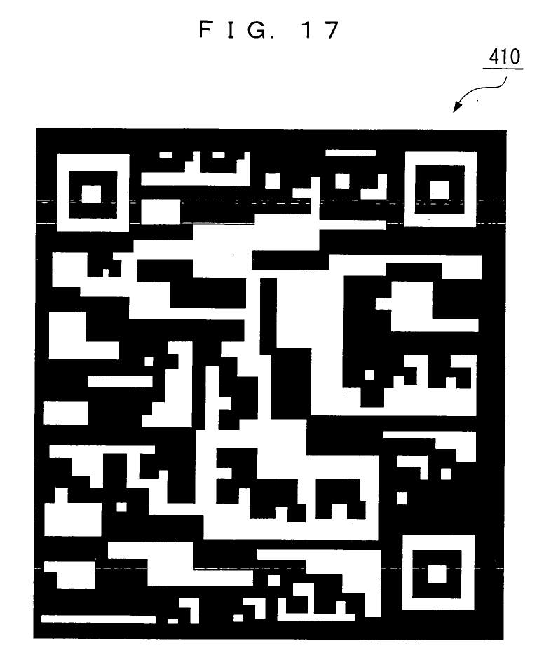

FIG. 15 shows an overall configuration of a correspondence confirmation system 400 of an eighth embodiment of the present invention. Further, FIG. 16 is an explanatory view of a use status of the correspondence confirmation system 400, and FIG. 17 is an example of a two-dimensional barcode 410 used when confirming correspondence by the correspondence confirmation system 400. The correspondence confirmation system 400 is a system used in a hospital for confirming a correspondence between each patient 401 who is a person and a medical record 402 which is an object prepared individually for each patient 401.

In FIG. 15 and FIG. 16, the correspondence confirmation system 400 is constituted by including one or plural computers 420 and one or plural portable information terminal devices 430. The computer 420 is, for example, operated by each doctor 403 in charge of consultation, each nurse assisting the doctor 403, a receptionist of a hospital, or the like. The portable information terminal device 430 is, for example, operated by each doctor 404 in charge of operation and treatment, each nurse assisting the doctor 404, or the like.

The computer 420 has an imaging unit 421 which captures an image of an iris 405 of the patient 401, for example, during consultation or reception, a converting unit 422 which converts iris image data of the patient 401 captured using the imaging unit 421 into two-dimensional barcode data, a drawing unit 423 which performs drawing processing of a two-dimensional barcode 410 based on the two-dimensional barcode data obtained by the converting unit 422, an outputting unit 424 which prints on the medical record 402 the two-dimensional barcode 410 based on drawing information created by the drawing unit 423, and an input unit 425 for performing various input operation.

The portable information terminal device 430 may be realized as a part of various functions of a cellular phone, a PDA, or the like for example, or may be realized as a dedicated device used only in a hospital. The portable information terminal device 430 has an imaging unit 431 which captures an image of the iris 405 of the patient 401 and the two-dimensional barcode 410 printed on the medical record 420 when confirming a correspondence, a converting unit 432 which converts iris image data of the patient 401 captured using the imaging unit 431 into two-dimensional barcode data, a decoding unit 433 which reads two-dimensional barcode data from the two-dimensional barcode 410 captured using the imaging unit 431, a two-dimensional barcode data comparing unit 434 which compares the two-dimensional barcode data obtained by conversion by the converting unit 432 with the two-dimensional barcode data read by the decoding unit 433, a display portion 435 which performs screen display of various information and an operating unit 436 for performing various key-entry operation.

The imaging unit 421 provided in the computer 420 and the imaging unit 431 provided in the portable information terminal device 430 have the same configuration, and these imaging units 421 and 431 are constituted by including imaging lenses 421A and 431A, not-shown imaging elements, not-shown drive circuits which drive the imaging elements, and not-shown camera control units (CCU) which process an obtained image signal of a subject. The imaging lens may be a single focal lens or a bifocal lens constituted by a standard lens and a close-up lens having a different focal length from each other. Further, the imaging element is, for example, a complementary metal oxide semiconductor (CMOS), a charge coupled device (CCD), or the like.

The converting unit 422 provided in the computer 420 and the converting unit 432 provided in the portable information terminal device 430 have the same function, and these converting units 422 and 432 convert iris image data (image data) of the patient 401 captured using the imaging units 421 and 431 into two-dimensional barcode data (digital data). The two-dimensional barcode data is drawn and displayed on an object such as the medical record 402 or the like in a form of the two-dimensional barcode 410 as a picture shown in FIG. 17. The converting processing from the iris image data into the two-dimensional barcode data may be, for example, performed by capturing a status of iris image data on a radiation line whose center is the center position of a pupil, or performed by capturing a status of iris image data on a concentric circle whose center is the center position of a pupil.

The converting unit 422 and the drawing unit 423 provided in the computer 420 are realized by a central processing unit (CPU) provided inside the computer 420 and by a program product or the like which defines operation procedures of the CPU. Further, the outputting unit 424 is, for example, constituted by a printer or the like, and the input unit 425 is, for example, constituted by a keyboard, a mouse, and the like.

The converting unit 432, the decoding unit 433, and the two-dimensional barcode data comparing unit 434 provided in the portable information terminal device 430 are realized by a central processing unit (CPU) provided inside the portable information terminal device 430 and by a program product or the like which defines operation procedures of the CPU. Further, the display portion 435 is constituted by a liquid crystal display screen or the like for example.

In the eighth embodiment described above, the confirmation processing of a correspondence between the patient 401 and the medical record 402 is performed using the correspondence confirmation system 400 as described below.

First, as shown on an upper portion of FIG. 16, the doctor 403 or the like in charge of diagnosis for example operates the computer 420 and captures an image of the iris 405 of the patient 401 by the imaging unit 421. The timing of capturing may be determined by the doctor 403 or the like operating the input unit 425 or may be determined automatically by the program product. The iris image data obtained by capturing by the imaging unit 421 is then converted into two-dimensional barcode data by the converting unit 422, drawing processing of a two-dimensional barcode 410 is performed thereafter based on the two-dimensional barcode data by the drawing unit 423, and the two-dimensional barcode 410 is printed on the medical record 402 using the outputting unit 424. Subsequently, the doctor 403 or the like in charge of diagnosis records necessary items such as a result of diagnosis and the like in the medical record 402.

Thereafter, as shown on a lower portion of FIG. 16, the doctor 404 or the like in charge of operation and treatment performs various treatment such as operation, provision of medication, or the like on the patient 401 based on information described in the medical record 402 placed beside a movable bed 406 on which the patient 401 lies down. At this time, the doctor 404 or the like in charge of operation and treatment uses the portable information terminal device 430 which belongs to himself/herself to confirm whether the correspondence between the patient 401 lying down on the movable bed 406 and the medical record 402 placed beside the movable bed 406 is correct or not.

When the correspondence between the patient 401 and the medical record 402 is confirmed, an image of the iris 405 of the patient 401 is captured first by the imaging unit 431, and the two-dimensional barcode 410 printed on the medical record 402 is captured. The respective timing of capturing them may be determined by the doctor 404 or the like operating the operation portion 436 or may be determined automatically by the program product. Next, the converting unit 432 converts the iris image data of the patient 401 captured using the imaging unit 431 into two-dimensional barcode data, and the decoding unit 433 reads the two-dimensional barcode data from the two-dimensional barcode 410 on the medical record 402 captured by the imaging unit 431.

Thereafter, the two-dimensional barcode data comparing unit 434 compares the two-dimensional barcode data obtained by the conversion by the converting unit 432 with the two-dimensional barcode data read by the decoding unit 433. A comparison result thereof is displayed on the screen of the display portion 435. When the comparison result of two-dimensional barcode data shows coincidence, the medical record 402 is confirmed to be definitely corresponding to the patient 401 lying down on the movable bed 406, so that the doctor 404 or the like in charge of operation and treatment performs various treatment such as operation, provision of medication, or the like on the patient 401 lying down on the movable bed 406 based on the information described in the medical record 402. On the other hand, when these two-dimensional barcode data do not coincide, the doctor 404 or the like in charge of operation and treatment does not start subsequent treatment and reconfirms the correspondence.

According to the eighth embodiment described above, the following advantages are provided. Specifically, in the portable information terminal device 430, the converting unit 432 is provided so that iris image data of the patient 401 captured using the imaging unit 431 can be converted into two-dimensional barcode data, and the decoding unit 433 is provided so that two-dimensional barcode data can be read from the two-dimensional barcode 410 on the medical record 402 captured using the imaging unit 431.

In the portable information terminal device 430, the two-dimensional barcode data comparing unit 434 is provided so that whether or not the correspondence between the patient 401 lying down on the movable bed 406 and the medical record 402 placed beside the movable bed 406 is correct or not can be confirmed with high accuracy by whether the two dimensional barcode data coincide or not.

Accordingly, the doctor 404 or the like in charge of operation and treatment can confirm whether or not the patient 401 is really the identical person to be treated using the portable information terminal device 430 which belongs to himself/herself before starting various treatment such as operation, provision of medication, or the like on the patient 401 who is a subject of operation or treatment. Therefore, malpractice due to misidentification of a patient or the like in a hospital can be prevented from occurring.

### Ninth Embodiment

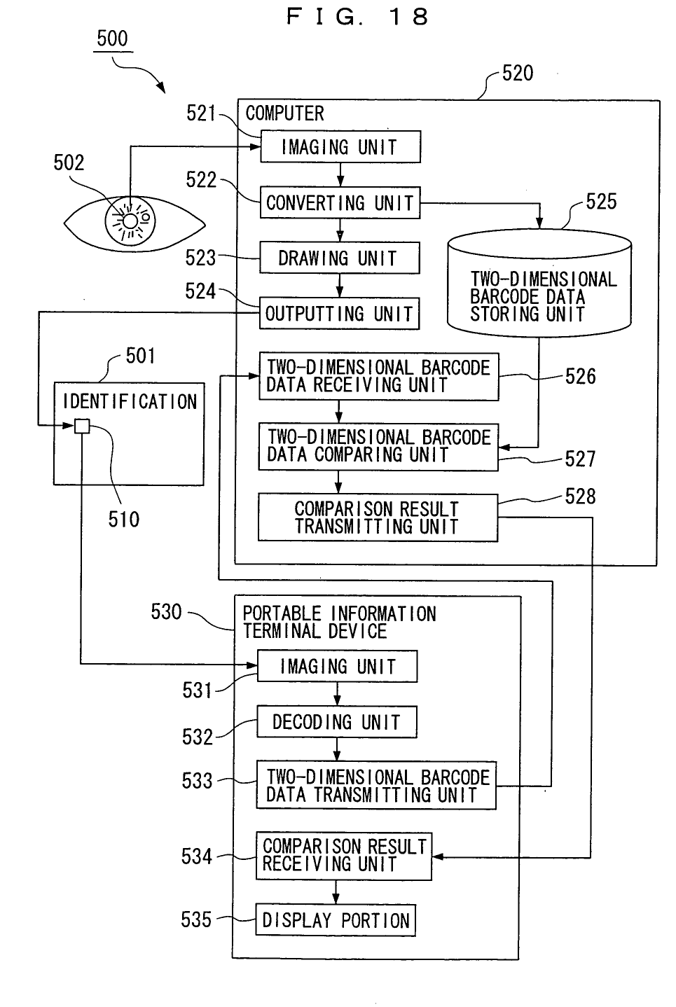

FIG. 18 shows an overall configuration of an identification confirmation system 500 which is an object confirmation system of a ninth embodiment of the present invention. The identification confirmation system 500 is a system for confirming whether an identification 501 presented by a person is genuine or not using a two-dimensional barcode 510 attached on the identification 501. The two-dimensional barcode 510 is identical to the two-dimensional barcode 410 in FIG. 17 of the eighth embodiment.

In FIG. 18, the identification confirmation system 500 is constituted by including a computer 520 installed at a location where the identification 501 is issued and one or plural portable information terminal devices 530 connected to the computer 520 via a wired or wireless network. The portable information terminal device 530 is constituted by a cellular phone or the like for example and operated by a person (for example, a guard or the like of a company in a case that the identification 501 is an employee ID card identifying an employee) who attempts to confirm the identity of a presenter of the identification 501.

The computer 520 has an imaging unit 521 which captures an image of an iris 502 of a person to be identified when issuing the identification 501, a converting unit 522 which converts the iris image data of the person to be identified captured using the imaging unit 521 into two-dimensional barcode data, a drawing unit 523 which performs drawing processing of the two-dimensional barcode 510 based on the two-dimensional barcode data obtained by the converting unit 522, an outputting unit 524 which prints on the identification 501 the two-dimensional barcode 510 based on drawing information created by the drawing unit 523, and a two-dimensional barcode data storing unit 525 which stores two-dimensional barcode data of all persons to be identified obtained by the converting unit 522.

Further, the computer 520 has a two-dimensional barcode data receiving unit 526 which receives two-dimensional data transmitted from the portable information terminal device 530, a two-dimensional barcode data comparing unit 527 which compares the two-dimensional barcode data received by the two-dimensional barcode data receiving unit 526 with respective two-dimensional barcode data stored in the two-dimensional barcode data storing unit 525 and searches whether there is corresponding one or not, and a comparison result transmitting unit 528 which transmits a result of the comparison by the two-dimensional barcode data comparing unit 527 to the portable information terminal device 530.

The portable information terminal device 530 has an imaging unit 531 which captures a two-dimensional barcode 510 printed on an identification 501 when confirming whether the presented identification 501 is genuine or not, a decoding unit 532 which reads two-dimensional barcode data from the two-dimensional barcode 510 captured by the imaging unit 531, a two-dimensional barcode data transmitting unit 533 which transmits the two-dimensional barcode data read by the decoding unit 532 to the computer 520, a comparison result receiving unit 534 which receives a comparison result transmitted from the computer 520, and a display portion 535 which displays the comparison result received by the comparison result receiving unit 534 on a screen.

The imaging unit 521 provided in the computer 520 and the imaging unit 531 provided in the portable information terminal device 530 have the same configuration, and these imaging units 521 and 531 are each constituted by including an imaging lens, an imaging element, a drive circuit which drives the imaging element, and a camera control unit (CCU) which processes an obtained image signal of a subject. The imaging lens may be a single focal lens or a bifocal lens constituted by a standard lens and a close-up lens having a different focal length from each other. Further, the imaging element is, for example, a complementary metal oxide semiconductor (CMOS), a charge coupled device (CCD), or the like.

The converting unit 522 and the drawing unit 523 provided in the computer 520 are identical to the converting unit 422 and the drawing unit 423 of the eighth embodiment. The converting unit 522, the drawing unit 523, the two-dimensional barcode data receiving unit 526, the two-dimensional barcode data comparing unit 527, and the comparison result transmitting unit 528 are realized by a central processing unit (CPU) provided inside the computer 520 and by a program product or the like which defines operation procedures of the CPU. Further, the outputting unit 524 is, for example, constituted by a printer or the like, and the two-dimensional barcode storing unit 525 is, for example, constituted by a hard disk or the like.

The decoding unit 532, two-dimensional barcode data transmitting unit 533, and comparison result receiving unit 534 provided in the portable information terminal device 530 are realized by a central processing unit (CPU) provided inside the portable information terminal device 530 and by a program product or the like which defines operation procedures of the CPU. Further, the display portion 535 is, for example, constituted by a liquid crystal display screen or the like.

In the ninth embodiment described above, the confirmation processing of whether the identification 501 is genuine or not is performed using the identification confirmation system 500 as described below.

First, when issuing the identification 501, the computer 520 is operated and an image of an iris 502 of a person to be identified is captured by the imaging unit 521. After iris image data obtained by capturing by the imaging unit 521 is converted into two-dimensional barcode data by the converting unit 522, drawing processing of the two-dimensional barcode 510 is performed by the drawing unit 523 based on the two-dimensional barcode data, and the two-dimensional barcode 510 is printed on the identification 501 using the outputting unit 524.

Further, along with the printing processing of the two-dimensional barcode 510, the two-dimensional barcode data obtained by converting by the converting unit 522 is stored and registered in the two-dimensional barcode data storing unit 525. This registration processing to the two-dimensional barcode data storing unit 525 is performed for all persons to be registered.

Thereafter, when the identification 501 is presented at a location different from the installation location of the computer 520 which performed the issuing processing of the identification 501, the portable information terminal device 530 is used to confirm whether the presented identification 501 is genuine or not. During this confirmation, first, the two-dimensional barcode 510 printed on the presented identification 501 is captured by the imaging unit 531.

Subsequently, the decoding unit 532 reads two-dimensional barcode data from the two-dimensional barcode 510 on the identification 501 captured using the imaging unit 531, and thereafter the two-dimensional barcode data transmitting unit 533 transmits the two-dimensional barcode data read by the decoding unit 532 to the computer 520.

Next, in the computer 520, after the two-dimensional barcode data receiving unit 526 receives the two-dimensional barcode data transmitted from the portable information terminal device 530, the two-dimensional barcode data comparing unit 527 compares the received two-dimensional barcode data with respective two-dimensional barcode data stored in the two-dimensional barcode data storing unit 525 and searches whether there is corresponding one or not. A comparison result by the two-dimensional barcode data comparing unit 527 is transmitted by the comparison result transmitting unit 528 to the portable information terminal device 530.

Thereafter, in the portable information terminal device 530, the comparison result receiving unit 534 receives the comparison result transmitted from the computer 520 and displays the received comparison result on the screen of the display portion 535. The operator of the portable information terminal device 530 refers to the screen display on the display portion 535, and when the comparison result shows coincidence, the operator takes a responding action for a case that the presented identification 501 is genuine (for example, an action such as permitting passage, or the like) to the presenter of the identification 501. On the other hand, when the comparison result shows no coincident data, the operator takes a responding action for a case that the presented identification 501 is not genuine (for example, an action such as refusing passage, or the like) to the presenter of the identification 501.

According to the ninth embodiment described above, the following advantages are provided. Specifically, by the imaging unit 531 of the portable information terminal device 530, the two-dimensional barcode 510 attached on the identification 501 is captured, and the comparison processing of the data read from the two-dimensional barcode 510 with the two-dimensional barcode data stored in advance in the two-dimensional barcode data storing unit 525 of the computer 520 is performed, so that the confirmation processing of whether the data read from the two-dimensional barcode 510 attached on the identification 501 is regularly registered data or not can be performed.

Accordingly, the confirmation of whether the presented identification 501 is genuine or not can be quickly performed with high accuracy. Further, since the two-dimensional barcode 510 attached on the identification 501 is based on the image of the iris 502 of the person to be identified, it is difficult to perform an unauthorized activity thereof such as counterfeiting or the like, so that unauthorized activities can be prevented from occurring.

### Tenth Embodiment

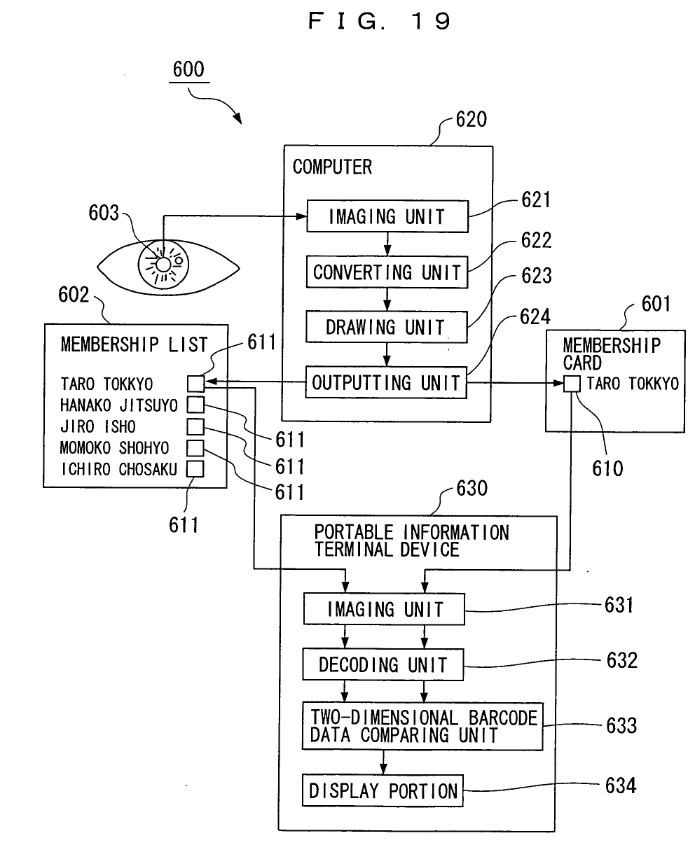

FIG. 19 shows an overall configuration of a membership card confirmation system 600 which is an object confirmation system of a tenth embodiment of the present invention. The membership card confirmation system 600 is a system for confirming whether a membership card 601 presented by a person insisting to be a member is one really issued for a person who is listed on a membership list 602. In other words, it is a system for confirming whether two objects, the membership card 601 and the membership list 602 (respective member description fields provided on the membership list 602), are prepared for the same person. On the membership card 601, a two-dimensional barcode 610 for one member is attached, and on respective member description fields on the membership list 602, two-dimensional barcodes 611 for respective members are attached. The two-dimensional barcodes 610 and 611 are identical to the two-dimensional barcode 410 in FIG. 17 of the eighth embodiment.

In FIG. 19, the membership card confirmation system 600 is constituted by including a computer 620 placed at a location where the membership card 601 is issued and one or plural portable information terminal devices 630. The portable information terminal device 630 is, for example, constituted by a cellular phone, a PDA, or the like and operated by a person who attempts to confirm whether a presenter of the membership card 601 is a member or not (more precisely, whether the presented membership card 601 is genuine or not) using the membership list 602. For example, when a meeting limited to members is held at a remote place from the installation location of the computer 620, the portable information terminal device 630 is operated by a receptionist or the like to confirm a person desiring to participate using the membership list 602.

The computer 620 has an imaging unit 621 which captures an image of an iris 603 of a member when issuing the membership card 601 for the member, a converting unit 622 which converts the iris image data of the member captured using the imaging unit 621 into two-dimensional barcode data, a drawing unit 623 which performs drawing processing of the two-dimensional barcodes 610 and 611 based on the two-dimensional barcode data obtained by the converting unit 622, and an outputting unit 624 which prints the two-dimensional barcodes 610 and 611 on the identification 601 and the respective member description fields on the membership list 602 based on drawing information created by the drawing unit 623. Incidentally, a two-dimensional barcode data storing unit which stores two dimensional barcode data of all members obtained by the converting unit 622 may be provided, and the stored data may be used for reissuing the membership card 601 or for renewal printing, additional printing, or the like of the membership list 602.

The portable information terminal device 630 has an imaging unit 631 which captures the two-dimensional barcode 610 on the membership card 601 by printing and captures the two-dimensional barcode 611 printed on the respective member description fields on the membership list 602 when confirming whether the presented membership card 601 is genuine or not, a decoding unit 632 which reads two-dimensional barcode data from each of the two-dimensional barcodes 610 and 611 captured using the imaging unit 631, and a two-dimensional barcode data comparing unit 633 which compares the respective two-dimensional barcode data read by the decoding unit 632 with each other, and a display portion 634 which displays a comparison result thereof on a screen.

The imaging unit 621 provided in the computer 620 and the imaging unit 631 provided in the portable information terminal device 630 have the same configuration, and these imaging units 621 and 631 are each constituted by including an imaging lens, an imaging element, a drive circuit which drives the imaging element, and a camera control unit (CCU) which processes an obtained image signal of a subject. The imaging lens may be a single focal lens or a bifocal lens constituted by a standard lens and a close-up lens having a different focal length from each other. Further, the imaging element is, for example, a complementary metal oxide semiconductor (CMOS), a charge coupled device (CCD), or the like.

The converting unit 622 and the drawing unit 623 provided in the computer 620 are identical to the converting unit 422 and the drawing unit 423 of the eighth embodiment. The converting unit 622 and the drawing unit 623 are realized by a central processing unit (CPU) provided inside the computer 620 and by a program product or the like which defines operation procedures of the CPU. Further, the outputting unit 624 is, for example, constituted by a printer or the like.

The decoding unit 632 and the two-dimensional barcode data comparing unit 633 provided in the portable information terminal device 630 are realized by a central processing unit (CPU) provided inside the portable information terminal device 630 and by a program product or the like which defines operation procedures of the CPU. Further, the display portion 634 is, for example, constituted by a liquid crystal display screen or the like.

In the tenth embodiment described above, the confirmation processing of whether the membership card 601 is genuine of not is performed using the membership card confirmation system 600 as described below.

First, when the membership card 601 is issued, the computer 620 is operated and an image of an iris 603 of a member is captured by the imaging unit 621. After iris image data obtained by capturing by the imaging unit 621 is converted into two-dimensional barcode data by the converting unit 622, drawing processing of the two-dimensional barcodes 610 and 611 is performed by the drawing unit 623 based on the two-dimensional barcode data, the two-dimensional barcode 610 is printed on the membership card 601 using the outputting unit 624, and the two-dimensional barcode 611 is printed on a respective member description field on the membership list 602 using the outputting unit 624. Incidentally, a two-dimensional barcode 610 printed on a membership card 601 of one member (for example, Taro Tokkyo) and a two-dimensional barcode 611 printed on a description field of the member (for example, Taro Tokkyo) on the membership list 602 are exactly the same, which describe exactly the same information (two-dimensional barcode data).

Thereafter, when the membership card 601 is presented at a location different from the installation location of the computer 620 which performed the issuing processing of the membership card 601, the portable information terminal device 630 and the membership list 602 are used to confirm whether the presented membership card 601 is genuine or not. During this confirmation, by the imaging unit 631, the two-dimensional barcode 610 printed on the presented membership card 601 is captured first, and the two-dimensional barcode 611 printed on the description field of the member on the membership list 602 is captured.

Subsequently, the decoding unit 632 reads two-dimensional barcode data from each of the two-dimensional barcodes 610 and 611 captured using the imaging unit 631, and thereafter the two-dimensional barcode data comparing unit 633 compares the two-dimensional barcode data read by the decoding unit 632 with each other.

Next, the comparison result by the two-dimensional barcode data comparing unit 633 is displayed on the screen of the display portion 634. The operator of the portable information terminal device 630 refers to the screen display on the display portion 634, and when the comparison result shows coincidence, the operator takes a responding action for a case that the presented membership card 601 is genuine (for example, an action such as permitting participation to a meeting limited to members, or the like) to the presenter of the membership card 601. On the other hand, when the comparison result does not show coincidence, the operator takes a responding action for a case that the presented membership card 601 is not genuine (for example, an action such as refusing participation to the meeting limited to members, or the like) to the presenter of the membership card 601.

According to the tenth embodiment described above, the following advantages are provided. Specifically, by the imaging unit 631 of the portable information terminal device 630, the two-dimensional barcode 610 printed on the membership card 601 is captured and the two-dimensional barcode 611 printed on the member description field for the member on the membership list 602 is captured, and the comparison processing of the two-dimensional barcode data read from the two-dimensional barcodes 610 and 611 with each other is performed, so that the confirmation processing of whether or not the two-dimensional barcode 610 attached on the membership card 601 coincides with the two-dimensional barcode 611 attached on the member description field for the member on the membership list 602 can be performed.

Accordingly, the confirmation of whether the presented membership card 601 is genuine or not can be quickly performed with high accuracy. Further, since the two-dimensional barcode 610 attached on the membership card 601 is based on the image of the iris 603 of the member, it is difficult to perform an unauthorized activity thereof such as counterfeiting or the like, so that unauthorized activities can be prevented from occurring.

### Eleventh Embodiment

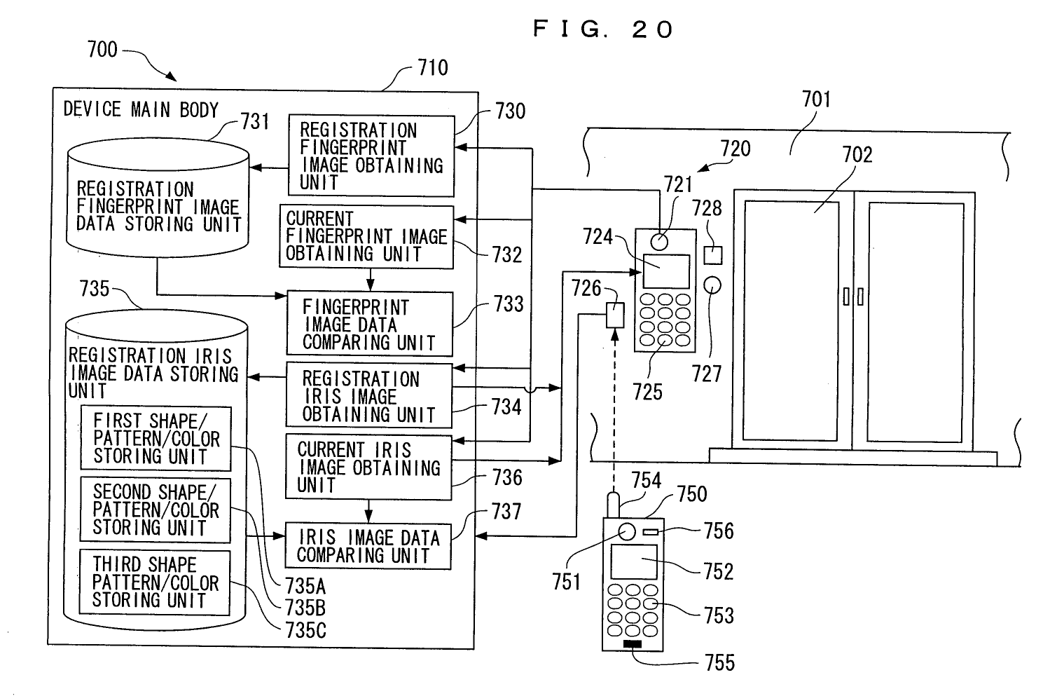

FIG. 20 shows an overall configuration of a subject identification system 700 of an eleventh embodiment of the present invention.

In FIG. 20, the subject identification system 700 is constituted by including a device main body 710 provided in the vicinity of an entrance/exit 702 of a building 701 and a cellular phone 750 which is a portable information terminal device capable of remotely controlling the device main body 710.

The device main body 710 is constituted by one or plural computers and has an imaging unit 720 which captures a fingerprint image and an iris image of a subject, a display portion 724 for screen display which is constituted by a liquid crystal display screen or the like for example, an operation portion 725 for performing various key-entry operation, a receiving unit 726 which receives radio signals from the cellular phone 750, a microphone 727, and a speaker 728.

In FIG. 20, the imaging unit 720 is constituted by including an imaging lens 721, a not-shown imaging element, a not-shown drive circuit which drives the imaging element, and a not-shown camera control unit (CCU) which processes an obtained image signal of a subject. The imaging lens 721 may be a single focal lens or a bifocal lens constituted by a standard lens and a close-up lens having a different focal length from each other. Further, the imaging element is, for example, a complementary metal oxide semiconductor (CMOS), a charge coupled device (CCD), or the like.

In FIG. 20, the device main body 710 has a registration fingerprint image obtaining unit 730 which captures a fingerprint image to be registered in advance using the imaging unit 720 to generate registration fingerprint image data, a registration fingerprint image data storing unit 731 which stores and registers the fingerprint image for registration obtained by the registration fingerprint image obtaining unit 730 as registration fingerprint image data, a current fingerprint image obtaining unit 732 which captures a current fingerprint image (at a time when performing identification) using the imaging unit 720 to generate current fingerprint image data, and a fingerprint image data comparing unit 733 which compares the current fingerprint image data obtained by the current fingerprint image obtaining unit 732 with the registration fingerprint image data stored in the registration fingerprint image data storing unit 731.

Further, the device main body 710 has a registration iris image obtaining unit 734 which captures an iris image to be registered in advance using the imaging unit 720 to generate registration iris image data, a registration iris image data storing unit 735 which stores and registers the iris image for registration obtained by the registration iris image obtaining unit 734 as registration iris image data, a current iris image obtaining unit 736 which captures a current iris image (at a time when performing identification) using the imaging unit 720 to generate current iris image data, and an iris image data comparing unit 737 which compares the current iris image data obtained by the current iris image obtaining unit 736 with the registration iris image data stored in the registration iris image data storing unit 735.

The registration iris image data storing unit 735 is constituted by including a first shape/pattern/color storing unit 735A, a second shape/pattern/color storing unit 735B, and a third shape/pattern/color storing unit 735C. Each of these storing units 735A, 735B, and 735C stores different type of registration iris image data. Incidentally, although three types of registration iris image data are prepared in the eleventh embodiment, they are not limited to the three types, which may be one type or plural types other than three types.

Further, in the registration fingerprint image data storing unit 731 and the registration iris image data storing unit 735, data of a fingerprint image and an iris image (in a case of the iris image, three types per person for example) of one person or of plural persons are prepared according to the number of persons to be permitted to enter the building 701 through the entrance/exit 702.

The cellular phone 750 has an imaging unit 751 which captures an fingerprint image and an iris image of a subject, a display portion 752 for screen display which is constituted by a liquid crystal display screen or the like for example, an operation portion 753 for performing various key-entry operation, an antenna 754 which transmits a radio signal to the device main body 710, a microphone 755, and a speaker 756. The imaging unit 751 and the display portion 752 have the same configurations as those of the imaging unit 720 and the display portion 724 of the device main body 710.

Further, the cellular phone 750 has a current fingerprint image obtaining unit having the same function as that of the current fingerprint image obtaining unit 732 of the device main body 710 and a current iris image obtaining unit having the same function as that of the current iris image obtaining unit 736 of the device main body 710. Incidentally, the cellular phone 750 may be provided with units which have the same function as that of the registration fingerprint image obtaining unit 730 and the same function as that of the registration iris image obtaining unit 734 of the device main body 710, respectively.

The display portion 724 of the device main body 710 and the display portion 752 of the cellular phone 750 keep a constant brightness each time capturing a current iris image, and the brightness at each time capturing a current iris image is the same as the brightness at a time capturing an iris image for registration which is stored in the registration iris image data storing unit 735.

The registration iris image data storing unit 731 and the registration iris image data storing unit 735 of the device main body 710 are constituted by a hard disk or the like for example.

The respective units 730, 732, 733, 734, 736, and 737 provided in the device main body 710 are realized by a central processing unit (CPU) provided inside a computer constituting the device main body 710, and by a program product or the like which defines operation procedures of the CPU. Further, the current fingerprint image obtaining unit and the current iris image obtaining unit provided in the cellular phone 750 are realized by a central processing unit (CPU) provided inside the cellular phone 750 and by a program product or the like which defines operation procedures of the CPU.

In the eleventh embodiment described above, the identification processing of a person attempting to enter the building 701 (hereinafter, referred to as a person desiring entrance) through the entrance/exit 702 is performed using the subject identification system 700 as described below.

First, a person to be permitted to enter the building 701 through the entrance/exit 702 registers his/her fingerprint image and iris image in advance to the subject identification system 700. After the fingerprint image is captured using the imaging unit 720 by the registration fingerprint image obtaining unit 730 of the device main body 710, the registration of the fingerprint image is performed by storing and saving the obtained fingerprint image data in the registration fingerprint image data storing unit 731. The timing of capturing the fingerprint image may be determined by the person himself/herself operating the operation portion 725, or may be determined automatically by the registration fingerprint image obtaining unit 730.

After an iris image is captured by the registration iris image obtaining unit 734 of the device main body 710 using the imaging unit 720, the registration of the iris image is performed by storing and saving the obtained iris image data in the registration iris image data storing unit 735. The timing of capturing the iris image may be determined by the person himself/herself operating the operation portion 725, or may be determined automatically by the registration iris image obtaining unit 734.

Further, when the registration iris image data is obtained by the registration iris image obtaining unit 734, the display portion 724 is used as a light source, and the capturing is performed three times with a shape, pattern, color, or combination thereof of a display drawn on the screen of the display portion 724 being changed. For example, one of three different types of shapes such as ◯, Δ, □ or the like is displayed on the display portion 724 at each time of three capturing.

Then, when there is a person fixing his/her eye to the imaging unit 720, an optical source noise corresponding to the shape such as ◯, Δ, □ or the like of the display drawn on the screen of the display portion 724 is included in the iris located around the pupil of his/her eye (refer to FIG. 14). Therefore, a shape, pattern, color, or combination thereof of the optical source noise becomes one of three different types according to the change in a shape, pattern, color, or combination thereof of the display drawn on the screen of the display portion 724.

Thus, the iris images including the optical source noises of three different types per person are obtained and stored in the respective storing units 735A, 735B, and 735C constituting the registration iris image data storing unit 735.

Incidentally, obtaining of the registration fingerprint image data and the three types of the registration iris image data described above may be performed by the cellular phone 750. In such a case, when the iris image is captured, iris images including three types of optical source noises are captured using the imaging unit 751 with a shape, pattern, color, or combination thereof of a display drawn on the screen of the display portion 752 of the cellular phone 750 being changed. The obtained registration fingerprint image data and respective registration iris image data may be transmitted from the antenna 754 to the receiving unit 726 of the device main body 710.

Next, when there is a person desiring entrance, identification processing for determining whether or not to permit the entrance of the person desiring entrance will be performed as follows.

The person desiring entrance first captures a fingerprint image using the imaging unit 720 by the current fingerprint image obtaining unit 732 of the device main body 710. The timing of capturing the fingerprint image may be determined by the person himself/herself operating the operation portion 725, or may be determined automatically by the current fingerprint image obtaining unit 732.

Further, in a case of a person desiring entrance using the cellular phone 750, the person first captures a fingerprint image using the imaging unit 751 by the current fingerprint image obtaining unit of the cellular phone 750. The timing of capturing the fingerprint image may be determined by the person himself/herself operating the operation portion 753, or may be determined automatically by the current fingerprint image obtaining unit. The obtained current fingerprint image data may be transmitted from the antenna 754 to the receiving unit 726 of the device main body 710.

Thereafter, the fingerprint image data comparing unit 733 compares the current fingerprint image data obtained by the current fingerprint image obtaining unit 732 or the current fingerprint image data transmitted from the cellular phone 750 with the registration fingerprint image data stored in the registration fingerprint image data storing unit 731. When these fingerprint image data coincide, the processing proceeds to the next step. On the other hand, when they do not coincide, the person desiring entrance is identified to be a different person from the identical person to be permitted the entrance, so that the person cannot enter the building 701 through the entrance/exit 702.

Next, the person desiring entrance captures an iris image using the imaging unit 720 by the current iris image obtaining unit 736 of the device main body 710. This iris image includes an optical source noise having a shape, pattern, or the like corresponding to a shape, pattern, or the like (for example, a shape ◯ or the like) of the current display drawn on the screen of the display portion 724. The shape, pattern, or the like of the display drawn on the screen of the display portion 724 is updated regularly or irregularly by the current iris image obtaining unit 736. The timing of capturing the iris, image may be determined by the person himself/herself operating the operation portion 725, or may be determined automatically by the current iris image obtaining unit 736.

Further, in a case of a person desiring entrance using the cellular phone 750, an iris image is captured using the imaging unit 751 by the current iris image obtaining unit of the cellular phone 750. This iris image includes an optical source noise having a shape, pattern, or the like corresponding to a shape, pattern, or the like (for example, a shape ◯ or the like) of the current display drawn on the screen of the display portion 752. The shape, pattern, or the like of the display drawn on the screen of the display portion 752 is updated regularly or irregularly by the current iris image obtaining unit of the cellular phone 750. The timing of capturing the iris image may be determined by the person himself/herself operating the operation portion 753, or may be determined automatically by the current iris image obtaining unit of the cellular phone 750. The obtained current iris image data and information of the shape, pattern, or the like (hereinafter, referred to as light source type information) of the display drawn on the screen of the display portion 752 when the iris image is captured may be transmitted from the antenna 754 to the receiving unit 726 of the device main body 710.

Thereafter, the iris image data comparing unit 737 compares the current iris image data obtained by the current iris image obtaining unit 736 or the current iris image data transmitted from the cellular phone 750 with the registration iris image data stored in the registration iris image data storing unit 735. At this time, the registration iris image data used for the comparison processing is selected from the respective storing units 735A, 735B, and 735C according to the shape, pattern, or the like of the display drawn on the screen of the display portion 724 by the current iris image obtaining unit 736 or based on the light source information transmitted from the cellular phone 750.

When these iris image data coincide as a result of the comparison processing by the iris image data comparing unit 737, the person desiring entrance is identified to be the identical person to be permitted the entrance and thus permitted the entrance. On the other hand, when the iris image data do not coincide, the person desiring entrance is identified to be a person different from the identical person to be permitted the entrance, so that the person cannot enter the building 701 through the entrance/exit 702.

According to the eleventh embodiment described above, the following advantages are provided. Specifically, the fingerprint image and the iris image of a subject are captured using the imaging units 720 and 751, so that strict identification by double checking can be performed. Therefore, a different person acceptance rate of accepting a different person can be decreased to thereby improve identification accuracy.

Further, the identification is performed by capturing an iris image which includes an optical source noise, so that an unauthorized activity of impersonation using a picture, motion picture, or the like can be prevented from occurring.

Furthermore, a shape, pattern, color, or combination thereof of displays drawn on the screens of the display portions 724 and 752 which are the light sources are updated to be changed, so that an unauthorized activity of impersonation using a picture, motion picture, or the like can be more securely prevented from occurring.

Further, the displays drawn on the screens of the display portions 724 and 752 are changed, so that a change in a shape, pattern, color, or combination thereof of the light sources can be easily realized, and a variation of the change can be freely set.

Further, the display portion 724 of the device main body 710 and the display portion 752 of the cellular phone 750 keep a constant brightness each time capturing a current iris image, and the brightness at each time capturing the current iris image is the same as the brightness at a time capturing an iris image for registration which is stored in the registration iris image data storing unit 735, so that the iris image can be captured with the size of the pupil being kept constant, thereby improving identification accuracy.

### Twelfth Embodiment

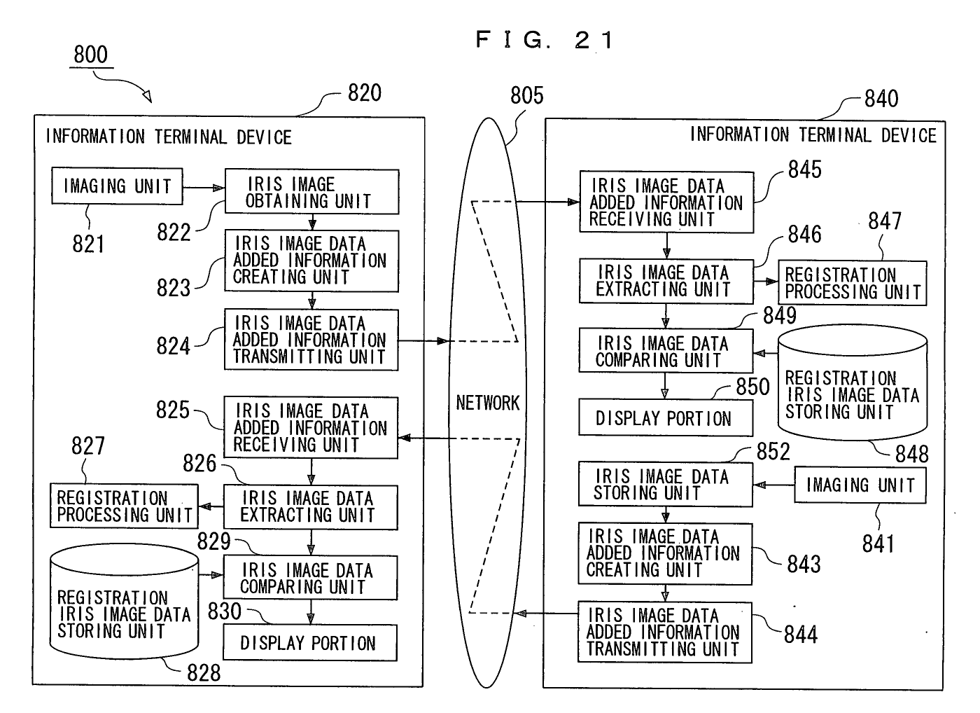

FIG. 21 shows an overall configuration of a user authentication system 800 of a twelfth embodiment of the present invention. The user authentication system 800 is a system for performing authentication of a terminal user when communication is performed via a network 805 between plural information terminal devices with each other (here, two information terminal devices 820 and 840) and for confirming a sender of information or the like exchanged by an e-mail or by chatting for example.

In FIG. 21, the user authentication system 800 is constituted by the information terminal devices 820 and 840 connected via the network 805. Each of the information terminal devices 820 and 840 is a cellular phone, a personal computer, or the like for example and these information terminal devices 820 and 840 may be information terminal devices of the same type or information terminal devices of different type. The network 805 is, for example, constituted by the Internet, a cellular phone network (refer to FIG. 1 of the first embodiment) or the like according to the type of the information terminal devices 820 and 840.

The information terminal device 820 has an imaging unit 821 which captures an iris image of a user of the information terminal device 820, an iris image obtaining unit 822 which captures an iris image of a user using the imaging unit 821 to generate iris image data, an iris image data added information creating unit 823 which adds the iris image data obtained by the iris image obtaining unit 822 to information (for example, text information sent by an e-mail, message information exchanged by chatting, or the like) which is an object of communication, and an iris image data added information transmitting unit 824 which transmits the iris image data added information (information including iris image data) created by the iris image data added information creating unit 823 to the other information terminal device 840 via the network 805.

Further, the information terminal device 820 has an iris image data added information receiving unit 825 which receives iris image data added information transmitted from the other information terminal device 840, an iris image data extracting unit 826 which extracts iris image data of a user of the other information terminal device 840 from the iris image data added information received by the iris image data added information receiving unit 825, a registration processing unit 827 which performs registration processing of the iris image data extracted by the iris image data extracting unit 826, a registration iris image data storing unit 828 which stores and registers iris image data that is judged or instructed to be registered by the registration processing unit 827 as registration iris image data, an iris image data comparing unit 829 which compares the iris image data included in the iris image data added information received by the iris image data added information receiving unit 825 with the registration iris image data stored in the registration iris image data storing unit 828 during the next and subsequent communication (communication carried out after the communication of performing registration processing) with the other communication terminal device 840, and a display portion 830 which displays various information such as a comparison result by the iris image data comparing unit 829, or the like on a screen.

The other information terminal device 840 has the same configuration as that of the information terminal device 820 and has an imaging unit 841, an iris image obtaining unit 842, an iris image data added information creating unit 843, an iris image data added information transmitting unit 844, an iris image data added information receiving unit 845, an iris image data extracting unit 846, a registration processing unit 847, a registration iris image data storing unit 848, an iris image data comparing unit 849, and a display portion 850.

The imaging units 821 and 841 are each constituted by including a not-shown imaging lens, a not-shown imaging element, a not-shown drive circuit which drives the imaging element, and a not-shown camera control unit (CCU) which processes an obtained image signal of a subject. The imaging lens may be a single focal lens or a bifocal lens constituted by a standard lens and a close-up lens having a different focal length from each other. Further, the imaging element is, for example, a complementary metal oxide semiconductor (CMOS), a charge coupled device (CCD), or the like.

The registration iris image data storing units 828 and 848 are constituted by, for example, an EEPROM, a hard disk, or the like according to the types of the respective information terminal devices 820 and 840. Further, the display portions 830 and 850 are constituted by, for example, a CRT screen, a liquid crystal display screen, or the like according to the types of the respective information terminal devices 820 and 840.

The respective units 822, 823, 824, 825, 826, 827, and 829 provided in the information terminal device 820 are realized by a central processing unit (CPU) provided inside the information terminal device 820 and by a program product or the like which defines operation procedures of the CPU. Further, the respective units 842, 843, 844, 845, 846, 847, and 849 provided in the information terminal device 840 are realized by a central processing unit (CPU) provided inside the information terminal device 840 and by a program product or the like which defines operation procedures of the CPU.

In the twelfth embodiment described above, authentication processing of the users of the respective information terminal devices 820 and 840 are performed using the user authentication system 800 as described below.

First, the user of the information terminal device 820 creates information which is an object of communication such as text information of an e-mail, message information of chatting, or the like, captures an iris image of himself/herself by the iris image obtaining unit 822 using the imaging unit 821 to generate iris image data, and adds this iris image data of himself/herself by the iris image data added information creating unit 823 as a signature or in combination with a signature to the information which is the object of the communication.

Subsequently, the user transmits the iris image data added information obtained by adding the iris image data of himself/herself by the iris image data added information transmitting unit 824 to the other information terminal device 840. Incidentally, the information which is the object of the communication and the iris image data added thereto may be transmitted simultaneously, or may be transmitted one before/after another.

The other information terminal device 840 receives by the iris image data added information receiving unit 845 the iris image data added information transmitted from the information terminal device 820, and thereafter extracts by the iris image data extracting unit 846 the iris image data of the user of the information terminal device 820 from the iris image data added information.

Here, when the communication at this time is a first-time communication with the information terminal device 820, the registration processing unit 847 stores and registers the iris image data of the user of the information terminal device 820 as registration iris image data in the iris image data storing unit 848. This processing by the registration processing unit 847 may be performed by automatic judgment processing of searching automatically whether the iris image data extracted from the iris image data added information received this time is registered already in the registration iris image data storing unit 848 and performing registration when it is not registered yet, or may be performed by the user of the information terminal device 840 by giving an instruction of registration.

Thereafter, when the next and subsequent communication is performed between the information terminal devices 820 and 840 and, similarly to the first communication, iris image data added information transmitted from the information terminal device 820 is received by the iris image data added information receiving unit 845 of the information terminal device 840, the iris image data of the user of the information terminal device 820 is extracted from the iris image data added information by the iris image data extracting unit 846 similarly to the first communication.

The iris image data comparing unit 849 then compares the iris image data extracted by the iris image data extracting unit 846 with the registration iris image data stored in the registration iris image data storing unit 848, and displays a comparison result thereof on a screen of the display portion 850. Incidentally, the comparison result may be notified to the user of the information terminal device 840 by sound. At this time, when both the iris image data coincide, it is confirmed that the transmission is from the same person, and when they do not coincide, it is judged that the transmission is not from the same person.

Note that in a case of transmitting information from the information terminal device 840 to the information terminal device 820, the processing is performed by exactly the same procedure.

In the twelfth embodiment described above, the following advantages are provided. Specifically, by transmitting/receiving iris image data with information which is an object of communication, the iris image data can be used as a substitute for a signature (electronic signature) or in combination with a signature, and authentication of an information sender can be performed based on the iris image data, so that the identity of the information sender can be confirmed.

[Modifications]

It should be noted that the present invention is not limited to the above-described respective embodiments, and a modification and the like within a range capable of achieving the object of the present invention are included in the present invention.

Specifically, in the first to sixth embodiments, the information terminal device is a cellular phone 30 or the like (refer to FIG. 1 to FIG. 11), but it is not limited thereto. It may be a PDA, a stationary personal computer, or the like. Basically, it may be any information terminal device which can be connected to a service providing server via a network and is suitable for receiving provision of services.

Further, in the seventh embodiment, the subject is a person, the standard image is a facial image, and the close-up image is an iris image (refer to FIG. 12 to FIG. 14), but they are not limited thereto. The subject may be an animal, a plant, and an object such as a commercial product or a part, and the relationship between the standard image and the close-up image may be, for example, a relationship between a hand/foot image and a fingerprint image, an overall image of a commercial product and a tag of the commercial product, an overall image of a part or manufactured product and details of the part or manufactured product, or the like.

Furthermore, in the seventh embodiment, the display portion 324 of the device main body 310 and the display portion 352 of the cellular phone 350 are the light source for capturing an image (FIG. 12), but the light source is not limited thereto. For example, it may be a light-emitting diode (LED) or a group thereof, or may be a flashlight.

Further, the correspondence confirmation system 400 in the eighth embodiment is a system for confirming a correspondence between a patient 401 and a medical record 402 in a hospital (refer to FIG. 15 to FIG. 17), but the correspondence confirmation system of the present invention is not limited thereto. The correspondence confirmation system of the present invention may be one for confirming, for example, a correspondence between a dog or horse and a pedigree certificate thereof, a correspondence between a voter and a ballot paper for him/her or a postcard for claiming the ballot paper, a correspondence between an examinee and an examination admission card, a correspondence between a presenter of an identification and the identification, or the like. Basically, it may be any system for confirming whether a person or an animal and an object respectively prepared for each of the person or the animal are in a correct correspondence or not.

Further, in the eighth embodiment, the converting unit 432, the decoding unit 433, and the two-dimensional barcode data comparing unit 434 are provided in the portable information terminal device 430, and when confirming the correspondence between the patient 401 and the medical record 402, the comparison processing of two-dimensional barcode data is performed in the portable information terminal device 430 (refer to FIG. 15), but it is not limited to this manner. It may be processed in such a manner that, for example, only capturing of an image of the iris 405 of the patient 401 and capturing of the two-dimensional barcode 410 on the medical record 402 are performed by the imaging unit 431 on the portable information terminal device 430 side, respective data obtained by capturing are transmitted via a wired or wireless network to the computer 420 side, respective processing performed by the converting unit 432, the decoding unit 433, and the two-dimensional barcode data comparing unit 434 are performed on the computer 420 side, and thereafter a comparison result thereof is transmitted via the network from the computer 420 to the portable information terminal device 430 to be displayed on the display portion 435.

Furthermore, in the ninth embodiment, the target object of the confirmation is the identification 501 (refer to FIG. 18), but it is not limited thereto. For example, it may be a driver's license, a passport, a membership card, a pass permit, a deposit book or a cash card of a bank, a credit card, a travelers check, a seal, an identification label, a badge, or the like. Basically, it may be any object which is prepared individually for each person or animal.

Further, the identification confirmation system 500 in the ninth embodiment is for confirming whether the identification 501 is genuine or not (refer to FIG. 18), but the object confirmation system of the present invention may be one for confirming for which person or animal an object is prepared using two-dimensional barcodes. For example, it may be a system for confirming for whom a pass permit found as a lost property is issued, or the like.

Then, in the tenth embodiment, the two target objects of the confirmation are the membership card 601 and the membership list 602 (refer to FIG. 19), but they are not limited thereto. For example, they may be an entrance ticket and a participant list, a ballot paper or a postcard for claiming a ballot paper and a voter list, or the like.

Further, in the tenth embodiment, the decoding unit 632 and the two-dimensional barcode data comparing unit 633 are provided in the portable information terminal device 630, and when the presented membership card 601 is confirmed whether it is genuine or not, the comparison processing of the two-dimensional barcodes is performed in the portable information terminal device 630 (refer to FIG. 19), but it is not limited to this manner. It may be processed in such a manner that, for example, only capturing of the respective two-dimensional barcodes 610 and 611 are performed by the imaging unit 631 on the portable information terminal device 630 side, respective data obtained by capturing are transmitted via a wired or wireless network to the computer 620 side, respective processing performed by the decoding unit 632 and the two-dimensional barcode data comparing unit 633 are performed on the computer 620 side, and thereafter a comparison result thereof is transmitted via the network from the computer 620 to the portable information terminal device 630 to be displayed on the display portion 634.

Further, in the eighth to tenth embodiments, an iris image is converted into a two-dimensional barcode (refer to FIG. 15 to FIG. 19), but a fingerprint image may be converted into a two-dimensional barcode.

Furthermore, in the eleventh embodiment, the fingerprint image is captured first and the comparison processing by the fingerprint image data comparing unit 733 is performed, and then the iris image is captured and the comparison processing by the iris image data comparing unit 737 is performed (refer to FIG. 20), but the order thereof may be reversed.

In the eleventh embodiment, the subject is a person (refer to FIG. 20), but it is not limited thereto. The subject may be an animal.

Further, in the first to sixth embodiments, there is no description about a light source for illumination at the time of capturing an iris image, but in the first to sixth embodiments, similarly to the seventh and eleventh embodiments, the brightness of the light source for illumination is preferred to be kept constant when capturing an iris image. Further, an iris image including an optical source noise is preferred to be captured to perform the authentication processing, and furthermore, a shape, pattern, color, or combination thereof of a light source is preferred to be updated and changed. When a shape, pattern, color, or combination thereof of the light source is updated and changed, a shape, pattern, color, or combination thereof of a display drawn on a screen of the display portion 32 or the like is preferred to be changed.

Furthermore, in the twelfth embodiment, when authentication of a terminal user is performed, only iris mage data is added to the information which is an object of the communication (refer to FIG. 21), but in addition, authentication processing by a password may be performed. At this time, the automatic update of a password in the first to sixth embodiments may be performed.

In the twelfth embodiment, the iris image data (refer to FIG. 21) is added to the information which is an object of communication, but fingerprint image data may be added thereto, or both the iris image data and the fingerprint image data may be added thereto.

[Advantage of the Invention]

As has been described above, according to the present invention, the iris authentication and the automatic update of a password are combined to perform user authentication. Alternatively, a standard image captured by the standard lens and a close-up image captured by the close-up lens are combined to perform identification of a subject. Alternatively, an iris image or a fingerprint image is converted into a two-dimensional barcode to use this two-dimensional barcode to confirm a correspondence or an object. Alternatively, an iris image and a fingerprint image are combined to perform identification of a subject. Alternatively, iris image data and/or fingerprint image data are added to the information which is an object of communication. Therefore, there is an advantage that sureness and accuracy of authentication and confirmation regarding a person, an animal, a plant, or an object can be improved.

1. A user authentication method for performing authentication of an identity of a user of an information terminal device when the user receives a service from a service providing server via a network, the user authentication method comprising the steps of:
capturing an iris image of the user himself/herself in advance and storing and registering the iris image as registration iris image data in at least one of the information terminal device and the service providing server;
transmitting a current password defined individually for the user from the information terminal device to the service providing server, capturing a current iris image of the user by an imaging means provided in the information terminal device, and generating current iris image data in the information terminal device when the user receives a service from the service providing server by the information terminal device;
comparing thereafter by the service providing server the current password transmitted from the information terminal device with a password stored in the service providing server, and comparing the current iris image data with the registration iris image data by at least one of the information terminal device and the service providing server to thereby authenticate the identity of the user based on comparison results thereof; and
updating automatically thereafter by one of the information terminal device and the service providing server the password to generate a new password to be used when a next service is provided, transmitting the new password to the other of the information terminal device and the service providing server, and storing the same new password in both the information terminal device and the service providing server.

2. A user authentication system for performing authentication of an identity of a user of an information terminal device between the information terminal device and a service providing server connected via a network when the user receives a service from the service providing server,
wherein said service providing server comprises:
a password updating means for performing automatic update of a password every time a service is provided to the user to thereby generate a new password to be used when a next service is provided;
a server-side password storing means for storing the new password generated by the automatic update performed by said password updating means;
a new password transmitting means for transmitting the new password generated by the automatic update performed by said password updating means to said information terminal device;
a current password receiving means for receiving a current password transmitted from said information terminal device;
a password comparing means for comparing the current password received by said current password receiving means with a password before the automatic update stored in said server-side password storing means;
a registration iris image data storing means for storing and registering an iris image of the user himself/herself which is captured in advance as registration iris image data;
a current iris image data receiving means for receiving current iris image data transmitted from said information terminal device; and
an iris image data comparing means for comparing the current iris image data received by said current iris image data receiving means with the registration iris image data stored in said registration iris image data storing means, and
wherein said information terminal device comprises:
a current password transmitting means for transmitting the current password to said service providing server;
a new password receiving means for receiving the new password transmitted from said service providing server;
a terminal-side password storing means for storing the new password received by said new password receiving means;
an imaging means for capturing a current iris image of the user; and
a current iris image data transmitting means for transmitting the current iris image data obtained by capturing by said imaging means to said service providing server.

3. A user authentication system for performing authentication of an identity of a user of an information terminal device between the information terminal device and a service providing server connected via a network when the user receives a service from the service providing server,
wherein said service providing server comprises:
a new password receiving means for receiving a new password transmitted from said information terminal device;
a server-side password storing means for storing the new password received by said new password receiving means;
a current password receiving means for receiving a current password transmitted from said information terminal device;
a password comparing means for comparing the current password received by said current password receiving means with a password before automatic update stored in said server-side password storing means;
a registration iris image data storing means for storing and registering an iris image of the user himself/herself which is captured in advance as registration iris image data;
a current iris image data receiving means for receiving current iris image data transmitted from said information terminal device; and
an iris image data comparing means for comparing the current iris image data received by said current iris image data receiving means with the registration iris image data stored in said registration iris image data storing means, and
wherein said information terminal device comprises:
a current password transmitting means for transmitting the current password to said service providing server;
a password updating means for performing automatic update of a password every time the user receives a service to thereby generate a new password to be used when the user receives a next service;
a terminal-side password storing means for storing the new password generated by the automatic update performed by said password updating means;
a new password transmitting means for transmitting the new password generated by the automatic update performed by said password updating means to said service providing server;
an imaging means for capturing a current iris image of the user; and
a current iris image data transmitting means for transmitting the current iris image data obtained by capturing by said imaging means to said service providing server.

4. A user authentication system for performing authentication of an identity of a user of an information terminal device between the information terminal device and a service providing server connected via a network when the user receives a service from the service providing server,
wherein said service providing server comprises:
a password updating means for performing automatic update of a password every time a service is provided to the user to thereby generate a new password to be used when a next service is provided;
a server-side password storing means for storing the new password generated by the automatic update performed by said password updating means;
a new password transmitting means for transmitting the new password generated by the automatic update performed by said password updating means to said information terminal device;
a current password receiving means for receiving a current password transmitted from said information terminal device; and
a password comparing means for comparing the current password received by said current password receiving means with a password before the automatic update stored in said server-side password storing means, and
wherein said information terminal device comprises:
a current password transmitting means for transmitting the current password to said service providing server;
a new password receiving means for receiving the new password transmitted from said service providing server;
a terminal-side password storing means for storing the new password received by said new password receiving means;
a registration iris image data storing means for storing and registering an iris image of the user himself/herself which is captured in advance as registration iris image data;
an imaging means for capturing a current iris image of the user; and
an iris image data comparing means for comparing current iris image data obtained by capturing by said imaging means with the registration iris image data stored in said registration iris image data storing means.

5. A user authentication system for performing authentication of an identity of a user of an information terminal device between the information terminal device and a service providing server connected via a network when the user receives a service from the service providing server,
wherein said service providing server comprises:
a new password receiving means for receiving a new password after automatic update transmitted from said information terminal device;
a server-side password storing means for storing the new password received by said new password receiving means;
a current password receiving means for receiving a current password transmitted from said information terminal device; and
a password comparing means for comparing the current password received by said current password receiving means with a password before the automatic update stored in said server-side password storing means, and
wherein said information terminal device comprises:
a current password transmitting means for transmitting the current password to said service providing server;
a password updating means for performing automatic update of a password every time the user receives a service to thereby generate a new password to be used when the user receives a next service;
a terminal-side password storing means for storing the new password generated by the automatic update performed by said password updating means;
a new password transmitting means for transmitting the new password generated by the automatic update performed by said password updating means to said service providing server;
a registration iris image data storing means for storing and registering an iris image of the user himself/herself which is captured in advance as registration iris image data;
an imaging means for capturing a current iris image of the user; and
an iris image data comparing means for comparing current iris image data obtained by capturing by said imaging means with the registration iris image data stored in said registration iris image data storing means.

6. An information terminal device connected to a service providing server via a network, comprising:
a current password transmitting means for transmitting a current password to the service providing server;
a password updating means for performing automatic update of a password every time a user receives a service from the service providing server to thereby generate a new password to be used when the user receives a next service;
a terminal-side password storing means for storing the new password generated by the automatic update performed by said password updating means;
a new password transmitting means for transmitting the new password generated by the automatic update performed by said password updating means to the service providing server;
a registration iris image data storing means for storing and registering an iris image of the user himself/herself which is captured in advance as registration iris image data;
an imaging means for capturing a current iris image of the user; and
an iris image data comparing means for comparing current iris image data obtained by capturing by said imaging means with the registration iris image data stored in said registration iris image data storing means.

7. A service providing server connected to an information terminal device via a network, comprising:
a password updating means for performing automatic update of a password every time a service is provided to a user of the information terminal device to thereby generate a new password to be used when a next service is provided;
a server-side password storing means for storing the new password generated by the automatic update performed by said password updating means;
a new password transmitting means for transmitting the new password generated by the automatic update performed by said password updating means to the information terminal device;
a current password receiving means for receiving a current password transmitted from the information terminal device;
a password comparing means for comparing the current password received by said current password receiving means with a password before the automatic update stored in said server-side password storing means;
a registration iris image data storing means for storing and registering an iris image of the user himself/herself which is captured in advance as registration iris image data;
a current iris image data receiving means for receiving current iris image data obtained by capturing a current iris image of the user by an imaging means provided in the information terminal device; and
an iris image data comparing means for comparing the current iris image data received by said current iris image data receiving means with the registration iris image data stored in said registration iris image data storing means.

8. A program product for a computer to function as an information terminal device connected to a service providing server via a network, the program product comprising:
a current password transmitting means for transmitting a current password to the service providing server;
a password updating means for performing automatic update of a password every time a user receives a service from the service providing server to thereby generate a new password to be used when the user receives a next service;
a terminal-side password storing means for storing the new password generated by the automatic update performed by said password updating means;
a new password transmitting means for transmitting the new password generated by the automatic update performed by said password updating means to the service providing server;
a registration iris image data storing means for storing and registering an iris image of the user himself/herself which is captured in advance as registration iris image data;
an imaging means for capturing a current iris image of the user; and
an iris image data comparing means for comparing current iris image data obtained by capturing by said imaging means with the registration iris image data stored in said registration iris image data storing means.

9. A program product for a computer to function as a service providing server connected to an information terminal device via a network, the program product comprising:
a password updating means for performing automatic update of a password every time a service is provided to a user of the information terminal device to thereby generate a new password to be used when a next service is provided;
a server-side password storing means for storing the new password generated by the automatic update performed by said password updating means;
a new password transmitting means for transmitting the new password generated by the automatic update performed by said password updating means to the information terminal device;
a current password receiving means for receiving a current password transmitted from the information terminal device;
a password comparing means for comparing the current password received by said current password receiving means with a password before the automatic update stored in said server-side password storing means;
a registration iris image data storing means for storing and registering an iris image of the user himself/herself which is captured in advance as registration iris image data;
a current iris image data receiving means for receiving current iris image data obtained by capturing a current iris image of the user by an imaging means provided in the information terminal device; and
an iris image data comparing means for comparing the current iris image data received by said current iris image data receiving means with the registration iris image data stored in said registration iris image data storing means.

10. A subject identification method for identifying a subject using an imaging means constituted by including a standard lens and a close-up lens having a focal length shorter than a focal length of the standard lens, the subject identification method comprising the steps of:
capturing a standard image of the subject in advance to store the standard image as registration standard image data in a registration standard image data storing means, and capturing a close-up image of the subject in advance to store the close-up image as registration close-up image data in a registration close-up image data storing means;
capturing a current standard image of the subject using the standard lens to generate current standard image data, and capturing a current close-up image of the subject using the close-up lens to generate current close-up image data when performing identification of the subject; and
comparing thereafter by a close-up image data comparing means the current close-up image data with the registration close-up image data stored in the registration close-up image data storing means to thereby perform identification of the subject.

11. The subject identification method according to claim 10, further comprising the step of comparing by a standard image data comparing means the current standard image data with the registration standard image data stored in the registration standard image data storing means, along with said comparing step by the close-up image data comparing means, to thereby perform identification of the subject.

12. The subject identification method according to claim 10,
wherein the subject is a person or an animal;
wherein the standard image is a facial image capturing a substantially entire face of the subject; and
wherein the close-up image is an iris image capturing an iris of the subject.

13. The subject identification method according to claim 10,
wherein the subject is a person or an animal;
wherein the standard image is a hand/foot image capturing a substantially entire hand or foot of the subject; and
wherein the close-up image is a fingerprint image capturing a fingerprint of the subject.

14. The subject identification method according to claim 12,
wherein an optical source noise, which is formed by reflecting a light source for illumination used when capturing an image, is combined into the registration close-up image data to be stored in the registration close-up image data storing means;
wherein, when a current close-up image of the subject is captured using the close-up lens, a same light source as the light source for illumination is used so that an optical source noise is combined into the current close-up image data; and
wherein, when the comparing step is performed by the close-up image data comparing means, the current close-up image data including the optical source noise is compared with the registration close-up image data including the optical source noise.

15. The subject identification method according to claim 14,
wherein, when the current close-up image of the subject is captured using the close-up lens, a shape, pattern, color, or combination thereof of the light source is updated to be changed; and
wherein, when the comparing step is performed by the close-up image data comparing means, a shape, pattern, color, or combination thereof of the optical source noise of the registration close-up image data used in the comparing step is changed according to the change in a shape, pattern, color, or combination thereof of the light source.

16. The subject identification method according to claim 15,
wherein the light source is a display portion which performs displaying on a screen; and
wherein, when the shape, pattern, color, or combination thereof of the light source is updated to be changed, a shape, pattern, color, or combination thereof of a display drawn on the screen of the display portion is changed.

17. A subject identification system for identifying a subject using an imaging means constituted by including a standard lens and a close-up lens having a focal length shorter than a focal length of the standard lens, the subject identification system comprising:
a registration standard image data storing means for storing and registering a standard image of the subject captured in advance as registration standard image data;
a registration close-up image data storing means for storing and registering a close-up image of the subject captured in advance as registration close-up image data;
a current standard image obtaining means for capturing a current standard image of the subject using the standard lens to thereby generate current standard image data;
a current close-up image obtaining means for capturing a current close-up image of the subject using the close-up lens to thereby generate current close-up image data; and
a close-up image data comparing means for comparing the current close-up image data obtained by said current close-up image obtaining means with the registration close-up image data stored in said registration close-up image data storing means.

18. The subject identification system according to claim 17, further comprising a standard image data comparing means for comparing the current standard image data obtained by said current standard image obtaining means with the registration standard image data stored in said registration standard image data storing means.

19. The subject identification system according to claim 17,
wherein the subject is a person or an animal;
wherein the close-up image is an iris image capturing an iris of the subject;
wherein a light source for illumination emitting light toward the subject when the current close-up image of the subject is captured using the close-up lens is provided; and
wherein the light source is configured to have a shape, pattern, color, or combination thereof which is updated to be changed.

20. The subject identification system according to claim 17,
wherein the subject is a person or an animal;
wherein the close-up image is an iris image capturing an iris of the subject;
wherein a light source for illumination emitting light toward the subject when the current close-up image of the subject is captured using the close-up lens is provided; and
wherein the illumination by the light source has a same brightness as a brightness for capturing the close-up image of the subject for obtaining the registration close-up image data to be stored in said registration close-up image data storing means, and the illumination by the light source keeps a constant brightness every time the current close-up image of the subject is captured.

21. A program product for a computer to function as a subject identification system for identifying a subject using an imaging means constituted by including a standard lens and a close-up lens having a focal length shorter than a focal length of the standard lens, the program product comprising:
a registration standard image data storing means for storing and registering a standard image of the subject captured in advance as registration standard image data;
a registration close-up image data storing means for storing and registering a close-up image of the subject captured in advance as registration close-up image data;
a current standard image obtaining means for capturing a current standard image of the subject using the standard lens to thereby generate current standard image data;
a current close-up image obtaining means for capturing a current close-up image of the subject using the close-up lens to thereby generate current close-up image data; and
a close-up image data comparing means for comparing the current close-up image data obtained by said current close-up image obtaining means with the registration close-up image data stored in said registration close-up image data storing means.

22. A correspondence confirmation method for confirming whether a correspondence between a person or animal and an object prepared individually for the person or animal is correct or not, the correspondence confirmation method comprising the steps of:
capturing an image of an iris or fingerprint of the person or animal in advance, converting by a converting means image data obtained by capturing into two-dimensional barcode data expressed by a two-dimensional barcode, and attaching a two-dimensional barcode on the object based on the two-dimensional barcode data;
capturing an image of an iris or fingerprint of the person or animal at a time of confirmation using an imaging means when confirming the correspondence, converting by a converting means image data at the time of confirmation obtained by capturing into two-dimensional barcode data, and reading using the imaging means two-dimensional barcode data by capturing the two-dimensional barcode attached on the object; and
comparing thereafter by a two-dimensional barcode data comparing means the two-dimensional barcode data obtained by converting the image data at the time of confirmation with the two-dimensional barcode data read from the two-dimensional barcode attached on the object to thereby confirm whether the both two-dimensional barcode data coincide with each other or not.

23. A correspondence confirmation system for confirming whether a correspondence between a person or animal and an object prepared individually for the person or animal is correct or not, the correspondence confirmation system comprising:
an imaging means for capturing an image of an iris or fingerprint of the person or animal and capturing a two-dimensional barcode attached on the object when confirming the correspondence;
a converting means for converting image data of the iris or fingerprint of the person or animal captured using said imaging means into two-dimensional barcode data;
a decoding means for reading two-dimensional barcode data form the two-dimensional barcode captured using said imaging means; and
a two-dimensional barcode data comparing means for comparing the two-dimensional barcode data obtained by converting by said converting means with the two-dimensional barcode data read by said decoding means.

24. A program product for a computer to function as a correspondence confirmation system for confirming whether a correspondence between a person or animal and an object prepared individually for the person or animal is correct or not, the program product comprising:
an imaging means for capturing an image of an iris or fingerprint of the person or animal and capturing a two-dimensional barcode attached on the object when confirming the correspondence;
a converting means for converting image data of the iris or fingerprint of the person or animal captured using said imaging means into two-dimensional barcode data;
a decoding means for reading two-dimensional barcode data form the two-dimensional barcode captured using said imaging means; and
a two-dimensional barcode data comparing means for comparing the two-dimensional barcode data obtained by converting by said converting means with the two-dimensional barcode data read by said decoding means.

25. An object confirmation method for confirming whether or not an object prepared individually for a person or animal is genuine or which person or animal the object is prepared for, the object confirmation method comprising the steps of:
capturing an image of an iris or fingerprint of the person or animal in advance, converting by a converting means image data obtained by capturing into two-dimensional barcode data expressed by a two-dimensional barcode, storing the two-dimensional barcode data in a two-dimensional barcode data storing means, and attaching a two-dimensional barcode on the object based on the two-dimensional barcode data;
reading using an imaging means two-dimensional barcode data by capturing the two-dimensional barcode attached on the object when confirming whether or not the object is genuine or which person or animal the object is prepared for; and
comparing thereafter by a two-dimensional barcode data comparing means the two-dimensional barcode data read from the two-dimensional barcode attached on the object with the two-dimensional barcode data stored in the two-dimensional barcode data storing means to thereby confirm whether the both two-dimensional barcode data coincide with each other or not.

26. An object confirmation system for confirming whether or not an object prepared individually for a person or animal is genuine or which person or animal the object is prepared for, the object confirmation system comprising:
a converting means for converting image data of an iris or fingerprint of the person or animal captured in advance into two-dimensional barcode data;
a two-dimensional barcode data storing means for storing the two-dimensional barcode data obtained by said converting means;
an imaging means for capturing a two-dimensional barcode attached on the object at a time of the confirmation;
a decoding means for reading two-dimensional barcode data from the two-dimensional barcode captured using said imaging means; and
a two-dimensional barcode data comparing means for comparing the two-dimensional barcode data read by said decoding means with the two-dimensional barcode data stored in said two-dimensional barcode data storing means.

27. A program product for a computer to function as an object confirmation system for confirming whether or not an object prepared individually for a person or animal is genuine or which person or animal the object is prepared for, the program product comprising:
a converting means for converting image data of an iris or fingerprint of the person or animal captured in advance into two-dimensional barcode data;
a two-dimensional barcode data storing means for storing the two-dimensional barcode data obtained by said converting means;
an imaging means for capturing a two-dimensional barcode attached on the object at a time of the confirmation;
a decoding means for reading two-dimensional barcode data from the two-dimensional barcode captured using said imaging means; and
a two-dimensional barcode data comparing means for comparing the two-dimensional barcode data read by said decoding means with the two-dimensional barcode data stored in said two-dimensional barcode data storing means.

28. An object confirmation method for confirming whether or not two types of objects prepared individually for a person or animal are objects prepared for the same person or animal, the object confirmation method comprising the steps of:
capturing an image of an iris or fingerprint of the person or animal in advance, converting by a converting means image data obtained by capturing into two-dimensional barcode data expressed by a two-dimensional barcode, and attaching a same two-dimensional barcode on both the two types of objects based on the two-dimensional barcode data;
reading using an imaging means respective two-dimensional barcode data by capturing the respective two-dimensional barcodes attached on the two types of objects when confirming whether or not the two types of objects are the objects prepared for the same person or animal; and
comparing thereafter by a two-dimensional barcode data comparing means the two-dimensional barcode data read from the respective two-dimensional barcodes attached on the two types of objects with each other to thereby confirm whether the both two-dimensional barcode data coincide with each other or not.

29. An object confirmation system for confirming whether or not two types of objects prepared individually for a person or animal are objects prepared for the same person or animal, the object confirmation system comprising:
an imaging means for capturing respective two-dimensional barcodes attached on the two types of objects at a time of the confirmation;
a decoding means for reading respective two-dimensional barcode data from the respective two-dimensional barcodes captured using said imaging means; and
a two-dimensional barcode data comparing means for comparing the two-dimensional barcode data read by said decoding means with each other.

30. A program product for a computer to function as an object confirmation system for confirming whether or not two types of objects prepared individually for a person or animal are objects prepared for the same person or animal, the program product comprising:
an imaging means for capturing respective two-dimensional barcodes attached on the two types of objects at a time of the confirmation;
a decoding means for reading respective two-dimensional barcode data from the respective two-dimensional barcodes captured using said imaging means; and
a two-dimensional barcode data comparing means for comparing the two-dimensional barcode data read by said decoding means with each other.

31. A subject identification method for identifying a subject using an imaging means, the subject identification method comprising the steps of:
capturing an iris image of the subject in advance and storing the iris image as registration iris image data in a registration iris image data storing means, and capturing a fingerprint image of the subject and storing the fingerprint image as registration fingerprint image data in a registration fingerprint image data storing means;
capturing a current iris image of the subject using the imaging means to generate current iris image data, and capturing a current fingerprint image of the subject using the imaging means to generate current fingerprint image data when identifying the subject; and
comparing thereafter by an iris image data comparing means the current iris image data with the registration iris image data stored in said registration iris image data storing means, and comparing by a fingerprint image data comparing means the current fingerprint image data with the registration fingerprint image data stored in said registration fingerprint image data storing means to thereby identify the subject.

32. The subject identification method according to claim 31,
wherein an optical source noise, which is formed by reflecting a light source for illumination used when capturing an image, is combined into the registration iris image data to be stored in the registration iris image data storing means;
wherein, when a current iris image of the subject is captured using the imaging means, a same light source as the light source for illumination is used so that an optical source noise is combined into the current iris image data; and
wherein, when the comparing step is performed by the iris image data comparing means, the current iris image data including the optical source noise is compared with the registration iris image data including the optical source noise.

33. The subject identification method according to claim 32,
wherein, when the current iris image of the subject is captured using the imaging means, a shape, pattern, color, or combination thereof of the light source is updated to be changed; and
wherein, when the comparing step is performed by the iris image data comparing means, a shape, pattern, color, or combination thereof of the optical source noise of the registration iris image data used in the comparing step is changed according to the change in a shape, pattern, color, or combination thereof of the light source.

34. The subject identification method according to claim 33,
wherein the light source is a display portion which performs displaying on a screen; and
wherein, when the shape, pattern, color, or combination thereof of the light source is updated to be changed, a shape, pattern, color, or combination thereof of a display drawn on the screen of the display portion is changed.

35. A subject identification system for identifying a subject using an imaging means, the subject identification system comprising:
a registration iris image data storing means for storing and registering an iris image of the subject captured in advance as registration iris image data;
a registration fingerprint image data storing means for storing and registering a fingerprint image of the subject captured in advance as registration fingerprint image data;
a current iris image obtaining means for capturing a current iris image of the subject using said imaging means to thereby generate current iris image data;
a current fingerprint image obtaining means for capturing a current fingerprint image of the subject using said imaging means to thereby generate current fingerprint image data;
an iris image data comparing means for comparing the current iris image data obtained by said current iris image obtaining means with the registration iris image data stored in said registration iris image data storing means; and
a fingerprint image data comparing means for comparing the current fingerprint image data obtained by said current fingerprint image obtaining means with the registration fingerprint image data stored in said registration fingerprint image data storing means.

36. A program product for a computer to function as a subject identification system for identifying a subject using an imaging means, the subject identification system comprising:
a registration iris image data storing means for storing and registering an iris image of the subject captured in advance as registration iris image data;
a registration fingerprint image data storing means for storing and registering a fingerprint image of the subject captured in advance as registration fingerprint image data;
a current iris image obtaining means for capturing a current iris image of the subject using said imaging means to thereby generate current iris image data;
a current fingerprint image obtaining means for capturing a current fingerprint image of the subject using said imaging means to thereby generate current fingerprint image data;
an iris image data comparing means for comparing the current iris image data obtained by said current iris image obtaining means with the registration iris image data stored in said registration iris image data storing means; and
a fingerprint image data comparing means for comparing the current fingerprint image data obtained by said current fingerprint image obtaining means with the registration fingerprint image data stored in said registration fingerprint image data storing means.

37. A user authentication method for authenticating an identify of a user of one information terminal device when the user communicates via a network with a user of another information terminal device, the user authentication method comprising the steps of:
transmitting iris image data and/or fingerprint image data obtained by capturing by the one information terminal device an iris image and/or a fingerprint image of the user himself/herself of the one information terminal device with information which is an object of communication to the another information terminal device;
receiving by the another information terminal device the iris image data and/or the fingerprint image data transmitted with the information which is the object of communication from the one information terminal device and storing and registering the iris image data and/or the fingerprint image data as registration iris image data and/or registration fingerprint image data; and
comparing the received iris image data and/or the received fingerprint image data with the registration iris image data and/or the registration fingerprint image data to thereby authenticate an identity of the user of the one information terminal device based on a comparison result thereof when the iris image data and/or the fingerprint image data transmitted with the information which is the object of communication from the one information terminal device is received by the another information terminal device at a time a next and subsequent communication is performed.

38. A user authentication system for authenticating an identity of a user of one information terminal device when the user communicates via a network with a user of another information terminal device,
wherein said one information terminal device comprises:
an imaging means for capturing an iris image and/or a fingerprint image of the user;
an iris image data and/or fingerprint image data added information creating means for adding the iris image data and/or the fingerprint image data obtained by capturing by said imaging means to information which is an object of communication; and
an iris image data and/or fingerprint image data added information transmitting means for transmitting iris image data and/or fingerprint image data added information created by said iris image data and/or fingerprint image data added information creating means to said another information terminal device, and
wherein said another information terminal device comprises:
an iris image data and/or fingerprint image data added information receiving means for receiving the iris image data and/or fingerprint image data added information transmitted from said one information terminal device;
a registration iris image data storing means and/or a registration fingerprint image data storing means for storing and registering as registration iris image data and/or registration fingerprint image data the iris image data and/or the fingerprint image data of the user himself/herself included in the iris image data and/or fingerprint image data added information received by said iris image data and/or fingerprint image data added information receiving means; and
an iris image data comparing means and/or a fingerprint image data comparing means for comparing iris image data and/or fingerprint image data included in the iris image data and/or fingerprint image data added information received by said iris image data and/or fingerprint image data added information receiving means with the registration iris image data stored in said registration iris image data storing means and/or the registration fingerprint image data stored in said registration fingerprint image data storing means at a time a next and subsequent communication is performed.

39. An information terminal device having a user authentication function for authenticating an identity of a user when the user communicates with another user via a network, the information terminal device comprising:
an imaging means for capturing an iris image and/or a fingerprint image of the user;
an iris image data and/or fingerprint image data added information creating means for adding the iris image data and/or the fingerprint image data obtained by capturing by said imaging means to information which is an object of communication;
an iris image data and/or fingerprint image data added information transmitting means for transmitting iris image data and/or fingerprint image data added information created by said iris image data and/or fingerprint image data added information creating means to another information terminal device;
an iris image data and/or fingerprint image data added information receiving means for receiving iris image data and/or fingerprint image data added information transmitting from the another information terminal device;
a registration iris image data storing means and/or a registration fingerprint image data storing means for storing and registering as registration iris image data and/or registration fingerprint image data iris image data and/or fingerprint image data of a user himself/herself of the another information terminal device included in the iris image data and/or fingerprint image data added information received by said iris image data and/or fingerprint image data added information receiving means; and
an iris image data comparing means and/or a fingerprint image data comparing means for comparing iris image data and/or fingerprint image data included in the iris image data and/or fingerprint image data added information received by said iris image data and/or fingerprint image data added information receiving means with the registration iris image data stored in said registration iris image data storing means and/or the registration fingerprint image data stored in said registration fingerprint image data storing means at a time a next and subsequent communication is performed with the another information terminal device.

40. A program product for a computer to function as an information terminal device having a user authentication function for authenticating an identity of a user when the user communicates with another user via a network, the information terminal device comprising:
an imaging means for capturing an iris image and/or a fingerprint image of the user;
an iris image data and/or fingerprint image data added information creating means for adding the iris image data and/or the fingerprint image data obtained by capturing by said imaging means to information which is an object of communication;
an iris image data and/or fingerprint image data added information transmitting means for transmitting iris image data and/or fingerprint image data added information created by said iris image data and/or fingerprint image data added information creating means to another information terminal device;
an iris image data and/or fingerprint image data added information receiving means for receiving iris image data and/or fingerprint image data added information transmitted from the another information terminal device;
a registration iris image data storing means and/or a registration fingerprint image data storing means for storing and registering as registration iris image data and/or registration fingerprint image data iris image data and/or fingerprint image data of a user himself/herself of the another information terminal device included in the iris image data and/or fingerprint image data added information received by said iris image data and/or fingerprint image data added information receiving means; and
an iris image data comparing means and/or a fingerprint image data comparing means for comparing iris image data and/or fingerprint image data included in the iris image data and/or fingerprint image data added information received by said iris image data and/or fingerprint image data added information receiving means with the registration iris image data stored in said registration iris image data storing means and/or the registration fingerprint image data stored in said registration fingerprint image data storing means at a time a next and subsequent communication is performed with the another information terminal device.
